(19) United States
(12) Patent Application Publication
(10) Pub. No.: US 2003/0107585 A1
(43) Pub. Date: Jun. 12, 2003

(54) Means for applying images to other images

(76) Inventor: Neville Anthony Wylie Samuelson, London (GB)

Correspondence Address: REINHART BOERNER VAN DEUREN S.C., ATTN: LINDA GABRIEL, DOCKET COORDINATOR, 1000 NORTH WATER STREET, SUITE 2100, MILWAUKEE, WI, 53202, US

(21) Appl. No.: 10/335,706

(22) Filed: Jan. 2, 2003

(30) Foreign Application Priority Data
Jul. 3, 2000 (GB) 0016335.2
Aug. 31, 2000 (GB) 0021422.1

(51) Int. Cl. G09G 5/00

(52) U.S. Cl. 345/629

(57) ABSTRACT

The application of images comprising self-adhesive stickers to other images depicting a human head is facilitated by a novel calibration device. The device is placed over, for example, a photograph appearing in a magazine and categorizes a depicted head in terms of size and attitude (i.e. the extent to which the head may be turned to left or right). The applied images are adapted to co-operate with those parts of the target image not obscured so as to form a dimensionally appropriate composite image. A selection of images identical in shape but differing in size and attributable attitude may be provided from which a user may choose. Other embodiments comprise images dedicated to a specific target image produced and disseminated independently of the applied image, a system of cross-referencing and a device applying coordinates being provided. Means are disclosed whereby an image may overlay a target image without adhering to it.

### CROSS-REFERENCE TO RELATED APPLICATIONS

This application claims priority of International Application Number PCT/GB01/02951, which was filed on Jul. 3, 2001, and published as International Publication Number WO 02/03022 A1 on Jan. 10, 2002 (the “'951 Application”), and which in turn claims priority from Great Britain Patent Application 0016335.2, filed on Jul. 3, 2000 (the “'335 Application”) and from Great Britain Patent Application 0021422.1, filed on Aug. 31, 2000 (the “'422 Application”). The '951 Application, the '335 Application, and the '422 Application are all hereby incorporated herein by reference.

### BACKGROUND OF THE INVENTION

1. Field of the Invention

The present invention relates generally to the application of images, and more particularly to the application of images such as self-adhesive stickers to other images depicting a head, and the facilitating of the same by a novel calibration device.

The design and production of small size illustrations, originally known as “scraps,” that the end user sticks on to something else dates back at least to Victorian times. In the earlier part of the Nineteenth Century the scraps would be cut-out by hand and glue applied separately, as with the early postage stamps. With advances in the manufacture of paper and the development of color printing, embossing and die-cutting, sticking scraps into scrapbooks and on to folding screens and other objects became a popular pastime, particularly among children. Many examples of their efforts have survived.

In the present day what were called scraps by our Victorian ancestors are now called stickers. The word “scrapbook” is still current, however, and in the United States and Canada the word “scrap”—variously rendered—continues to form part of the vocabulary of those who are engaged in what remains a very popular activity. Regular conventions and shows are held that have such colorful names as “Scrappin' Safari,” “Scrapa-Palooza,” “Scrapaway” and “Scrapper's Dream Vacations.”

In recent times computer technology has begun to impact on the sticker business. In the closely related field of paper dolls images are now available for downloading from the Internet. Paper dolls are often comprised of cut-outs of human figures, adults and children of both sexes, that can be dressed in separately provided outfits tailored to conceal whatever clothing is incorporated into the illustration-usually simple underwear. In another related field digital cameras have been developed that are loaded with the software necessary to combine a snapshot of a live subject with a scene featuring a branded product.

Mattel, manufacturers of the famous Barbie Doll proprietary brand, have such a product.

In addition to the prior art thus described, the conventional art forms known as collage, decoupage, frottage and montage, ought not be allowed to pass without mention. The terms are not mutually exclusive. All require the sticking of something other than paint on to a supporting material. The thing stuck might be a newspaper cutting, a photograph, a rubbing or a paper cut-out such as (for example) a Victorian scrap.

In the United States and elsewhere stickers, transfers and decals are a popular form of adornment for motorcars and motorcycles and motorcyclists' helmets.

The term “decal” is often used in relation to decorative motifs that are made from die-cut vinyl.

The production and dissemination of stickers has also now become a major publishing activity. Stickers are available in the form of books in which some pages are represented by sheets of self-adhesive stickers and other pages are adapted to the application of the same stickers by the provision of background art or captioned boxes or the like. The stickers are often accompanied by a children's story or an educational text. In many cases the word “activity” appears in the title or in the accompanying blurb.

Stickers may also be distributed in packaged form for sticking in to a separately supplied album. Such stickers follow a theme, such as football, and are calculated to engage the collecting instincts of young people in an age group rather older than those for whom sticker books of the activity type appeal.

Stickers are usually die-cut but on occasion may take the form of images that the user is required to cut-out by hand prior to sticking on to another surface.

When provided in this way such images may be termed “cut-outs.”

### SUMMARY OF THE INVENTION

The present invention provides the means whereby a form of sticker or cut-out not previously known in the art can be applied to photographs published in magazines by unconnected parties. A sticker or cut-out in accordance with the invention now disclosed is described in this application as an applied image.

The expression is used to describe both those stickers that are available for application and those that are actually applied to the photograph in question.

The expression “target image” is used with reference to such a photograph and in its narrowest construction refers to that part of the photograph to which the applied image is appropriated.

Forms of illustration other than photographs and publications other than magazines are also within the scope of the present invention and in certain circumstances applied images in accordance with the invention may come to rest not in a third party publication but in an album or other form of publication adapted to receive them.

For the object of the present invention to be realized the applied image must be configured in such a way as regards shape and perspective that it is able to realistically merge with the content of a photograph or other illustration portraying a person, over which photograph or illustration the publisher of the applied image has no control. This feature, of itself, sets applied images in accordance with invention apart from the general run of stickers whether produced by a traditional or digital process.

Applied images in accordance with the present invention fall into two categories. Those described as “dedicated” are designed and disseminated with a view to being applied to a specific target image already appearing in a third party publication. Other kinds of applied image in accordance with the invention are referred to in this application as “non-dedicated.” Non-dedicated applied images are designed with no specific target image in mind and their production and dissemination may anti-date the publication of the eventual target image. It will generally be for the user to choose which non-dedicated applied image is applied to which target image.

Target images in accordance with the present invention in its first two aspects will always incorporate a representation of a head. It may be human head, humanoid head, animal head, or an animal-like head-but a head nevertheless.

Taking the non-dedicated category of applied image first, the matching of such an applied image to the eventual target image is achieved by providing not a single applied image but a plurality of applied images of similar design that differ from each other only in scale and the attitude of the head. To facilitate selection by the user a means must be provided whereby the relevant dimensions of the target image appertaining to the depicted head can be ascertained with a reasonable degree of accuracy and related to the applied images in the user's possession. In this behalf the present invention provides a calibration device which, when laid over the head portrayed by the target image, identifies whichever of the available applied images is likely to be most suited to the case. The notations on the calibration device will be such as to cross reference its findings to non-dedicated applied images falling within the scope of the invention in its second aspect.

As used in this application, the term “applied image” will refer to the precise image available to be applied and the term “target image” will refer to areas to be overlaid by the applied image or proximate thereto. In the nature of things the photograph in which the head is depicted may incorporate much else besides and the expression “target image” lends itself to a construction that refers to the contents of the photograph or illustration generally. It should also be born in mind that a single applied image may relate to more than one head and a single photograph may offer more than one target image within the most limited construction of that term.

According to a first aspect of the present invention there is provided a device for calibration of an image of a human or other animal, humanoid or animal-like head (“target image”), wherein the device does not wholly obscure the target image when placed on the target image, and wherein the device bears markings or other means of calibration, which markings or other means of calibration describe a set of shapes, which are either approximately ovoid so as to generally correspond to the outline shape of an image of a head in varying degrees of rotation; or approximately rectangular, the longer sides of the rectangle generally corresponding to an elongate portion of the said outline shape extending from one side to the other at the widest point at or above the level of the eyes; wherein the shapes differ from each other in size and/or outline as attributable to the degree of rotation of a head, and wherein one size and/or attributed degree of rotation of the shape is distinguished from another size and/or attributed degree of rotation of the shape by a label.

A device in accordance with this first aspect of the invention may take one of several forms. The key requirements are that the device should be able to accommodate both a number of different head sizes within a specific range and different attitudes of head. Some of the forms of calibration device now disclosed are more compact than others. Convenience of use has to be traded off against the size of the device. Those calibration devices that most clearly distinguish and calibrate the features of the underlying target image (which could be a colorful photograph of an individual sporting a complex and voluminous hair style and, perhaps, a hat to match-both of which may need to be largely disregarded for the purpose in hand) may comprise as many as three pieces of A4 size material. The number of pieces and/or the space that the shapes occupy can be reduced by superimposing the shapes one on another or by reducing the number and/or range of head sizes covered by the device.

As an alternative to superimposition calibration devices in accordance with the present invention may lay out the shapes corresponding to head sizes in a line, with a separate line of shapes for each center, left, and right facing heads.

Another kind of configuration employs rectangular shapes (which may be likened to bars) corresponding to the widest part of the head at a point above the eyes.

It is envisaged that the application of applied images in accordance with the invention may, become a favorite pastime of commuters and so the availability of pocket size calibration devices, whatever their limitations, may usefully contribute to the commercial success of the invention. It is also the case that certain kinds of calibration device lend themselves more readily to promotional advertising. Variety in calibration devices will be as valuable as it is in life. It will assist in maintaining a high level of public interest in the invention.

In a preferred embodiment of the first aspect of the invention the calibration device comprises an A4 size piece of transparent material adapted to overlay the target image. Utilizing superimposed shapes the one device will encompass target images comprising seven sizes of head as reproduced on the page of a magazine or other publication. The seven sizes of head, as measured from side to side horizontally across the eyes and disregarding hair or headwear will range between approximately 21 mm and 75 mm in the case of heads facing directly to the front. Heads depicted in such an attitude are referred to in this application as center facing heads. The calibration device in question will also have the capacity to measure heads facing to the left or the right (left and right from the view point of the camera lens) by an angle in either case of approximately 22.5 degrees from center. Heads which are not center facing are respectively referred to as “left facing” and “right facing.” When heads are turned they have a greater width when viewed by a camera than when they face directly to the front and the corresponding range of sizes is approximates between 23 mm and 80 mm.

Between the seven sizes lie six steps of 120 percent, the increase compounding from step to step.

It needs to be emphasized that the parameters described in the preceding paragraph seem to represent a reasonable compromise between accuracy on the one hand and, on the other, a device so cluttered with lines of graduation and so great a variety of sticker shapes and sizes as to be almost unusable. The respective upper and lower limits to the range of head sizes would seem to embrace the majority of likely target images appearing in the so called “glossy” magazines. The range of sizes is not set in stone and may need to be revised as regards the upper and lower limits, the number of steps and the degrees of turn, in the light of experience.

In this first to be described preferred embodiment the device comprises a single piece of A4 size material the different head sizes divided into three groups, left facing, center facing and right facing, the outlines comprising a group superimposed one above the other and numbered 4 to 10. Each outline is accompanied by two ovals representing eyes. Different colors are employed to enable outlines to be distinguished one from another and the same color scheme is followed irrespective of whether the outline is left facing, center facing or right facing.

The elements of which this preferred embodiment are comprised will be found, with variations, in other embodiments made from a transparent material that are no less preferred. The number of head sizes accommodated may be ten rather than seven. In such a case the range of sizes for center facing heads will approximate between 12 mm and 75 mm and for left and right facing heads between 13 mm and 80 mm. The numbers will start at 1 and the progressive increase from step to step will again be at a rate of 120 percent compound.

With ten sizes instead of 7 it is desirable for the outlines to be spaced apart and not superimposed. This will require at least one additional A4 piece of material, two additional A4 pieces if the left and right facing outlines are not to be reproduced on the opposite sides of the same piece. An advantage of a configuration in which the individual shapes are spaced apart is that the ovals representing the eyes are much more clearly visible and can be used to roughly aim the calibrator at the target head. To a new user the eyes provide a certain amount of re-assurance that all is going as it should—albeit with one proviso.

The new user should be aware that eyes move upwards and downwards according to whether the head is inclined downwardly or upwardly and in a sideways direction according to how much the head is turned. It is also the case that with some individuals the eyes are spaced further apart than those of others.

The qualification implied by the word “roughly” is therefor justified in the circumstances.

In another no less preferred embodiment the outlines representing the different head sizes are replaced by bands rather than single lines. Such bands will be of different colors and numbered 1 to 4, 1 to 5, 4 to 9, 4 to 10, 1 to 10, or as required by the circumstance of the case. Bands cope better than single lines with the vagaries of target image heads brought about by different shapes and hair styles.

Another no less preferred embodiment comprises a calibration device in which the material is opaque or semi-opaque plastic or paper board and the outlines representing the different head sizes are provided in the form of apertures. The principal disadvantage of such a configuration is that it is not practicable to provide representations of eyes.

In the case where non-dedicated applied images in accordance with the invention are distributed in small packets it may be that an appropriate calibration device is included in each packet. Alternatively a calibration device may be sold separately in a packet of the same size as the applied images and from the same rack. In a preferred embodiment sets of applied images in bands 1 to 4 and a calibration device adapted to accommodate center, left and right facing heads in the same range of sizes can be provided in a pack which is 70 mm in width and 150 mm in height, not including a header. The calibrator in this instance is made from transparent material and employs spaced apart shapes with ovals representing eyes. Along with appropriately designed applied images it constitutes what may be considered an excellent starter pack for young people.

It is anticipated that there will be a place for particularly compact forms of calibration device in which the one-to-ten scale of bands is more fully represented. The possibility of effecting a reduction in the size of the device without lessening the range of head sizes covered, by substituting bars for bands or outlines, has already been touched upon. The bars will correspond with the respective widths of the target image head. Individually the bars will be wide enough to incorporate the ovals representing eyes. Advanced users will become so used to looking at photographs and assessing their suitability as target images that they will require little more than confirmation of the correctness of their initial assessment in terms of size and (if present) degrees of turn. For such users a calibration device utilizing bars rather than outlines may be adequate.

Commuters on trains are avid readers of newspapers and magazines and the present invention will provide them with an entertaining and personally fulfilling activity with which to while away the journey. A more compact form of calibration device for such users is likely to prove a boon-particularly where, as is the case with certain preferred embodiments, the left, right and center facing measurement are set out on three separate segmental shaped pieces of material secured together by a eyelet in the manner of a swatch.

In the case of calibration devices comprising more than one piece of material the pieces may be provided together or distributed in a piecemeal fashion, staggered in time.

Whatever form the preferred embodiments described above take the calibration devices are likely to have in common the inclusion of thumbnail drawings showing heads adorned by simple items of headwear in the respective left, right and center facing attitudes. It is thought that these small drawings will demonstrate more clearly than volumes of explanatory text the different kinds of target image that the devices measure.

A calibration device in accordance with the invention can be used to define the ratio between the dimensions of a head (height or width) depicted in a target image and the dimensions of another feature present in the same photograph or illustration. In this way the size of a hat or a hair arrangement relative to the physique of the wearer can be assessed. The calibration device is first applied to the target image head in the normal way so that the outline or aperture most nearly corresponding to the head may be identified. This done, the selected outline or aperture is transferred to the feature. If the feature is bigger than the head in whichever of the height or width is being measured the calibration device is moved step by step upwards, downwards or sideways as the case may be. Where the height or width of the feature as determined in this way is found to comprise less than a whole step or in aggregate more than a whole step, it will be necessary for the user to make a judgement by eye in order to arrive at a final figure, Thus a hat may be determined to have a height equal to one and a half times the height of the wearer's face. In this case result might be expressed as a ratio of 1.5. Such a hat would represent a very large hat.

It is not submitted that, used in the manner described in the preceding paragraph, calibration devices will provide mathematical exactitude. What is anticipated is that there will emerge a reliable indication of extremes in dress styles. A hat worn at a wedding, for example, which has a width of twice that of the wearer's head would be considered to be a large hat and one with a width that is three times that of the wearer's head would be a very large hat. There is evidence that suggests that the higher the social standing of the participants in a wedding the larger the hats of the ladies attending. Over a period of time it will be possible to arrive at an average hat size for weddings pictured in the popular press and to establish the effective upper and lower limits in the size of the hats.

It may be possible, using this data, not only to place weddings in order of social status but to identify long term fashion trends as well.

If the invention in its several aspects finds a significant measure of acceptance with the general public calibration devices will be widely distributed. It will be possible therefor for a substantial number of users to assist with a project of the kind described above by monitoring newspapers and magazines and reporting their finding by email. The greater the number of sightings reported and the greater the number of those reporting them the more easy it will be to make adjustment for differences in individual appraisals of hat sizes (in the examples taken). It is difficult to believe that such a project could be undertaken with a greater prospect of success since the alternative of measuring the hats in situ, would almost certainly extend the data base beyond those weddings reported in the national press and thereby dilute the sample by including the lower social categories the nuptials of whom rarely excite significant media interest.

In its second aspect the present invention embraces both non-dedicated and dedicated applied images, the common element being their appropriateness to a head featured in the target image and their ability to merge with the surrounding content. The applied image is such that it co-operates with the target image to form an aesthetically satisfying composite image having convincing dimensional qualities. Non-dedicated images are selected from a plurality of their kind varying in scale and in the attitude of the head and dedicated images are adapted for use with a specific known target image disseminated by a third party.

As regards non-dedicated applied images, the selection may well be determined with the assistance of a calibration device in accordance with the first aspect.

Alternatively the attributes of the target image as regards size and attitude of the head may be assessed by eye or with the help of a conventional ruler graduated in the metric or imperial scale of measurement. In the case of dedicated applied images the bringing together of the applied image and the target image requires a system of cross-reference that is easy to apply. Such systems are disclosed by the present invention.

According to a second aspect of the present invention there is provided an item of material bearing a representation of an image (“applied image”) adapted to be applied to and overlie an image depicting at least in part a human or other animal, humanoid or animal-like head (“target image”), which target image is reproduced upon another, separate item of material; wherein the applied image is a modification, embellishment or replacement for the head in the target image, and is adapted to be secured in position on or over the target image, and is cut-round or otherwise delimited, so that when applied to the target image, the applied image co-operates with those parts of the target image not thereby obscured to form a composite image in a manner that is dimensionally appropriate; wherein the applied image is: a. one of a plurality of the same image differing in shape, as attributable to the degree of rotation of a head, and/or size; or b. dedicated and appropriate to a specific target image, wherein the target image is found on an item that is produced and/or disseminated independently and without reference to the applied image.

The novelty of both non-dedicated and dedicated applied images centers upon the means employed to ensure that they blend in with the surrounding content of the target image. They must be both correct in size and cut-round or otherwise delimited in such a way that those elements of the subject of the applied image (not the actual applied image per se) which in life would be concealed by elements of the target image appear so to be following the application of the applied image to the target image.

It is one thing to apply artwork in the form of ink, paint or crayon to a photograph, etc. published by a third party so as to produce a realistic effect and another thing altogether to put into the hands of users, regardless of whether they are possessed of any talent for artistic draughtsmanship, the opportunity to achieve an equally compelling result. There are no stickers known in the Art that can be applied across a range of illustrative matter generated by an unconnected third party in a way that modifies such matter in a graphically realistic manner.

With respect to non-dedicated applied images the present invention is able to provide an adequate choice of sizes that has regard for the scale of reproduction of the great majority of photographs portraying people that appear in popular magazines. The choice of applied images also accommodates to a greater or lesser extent the substantial proportion of photographs that portray people with their head turned to the left or the right. If embodiments of the invention could only successfully cope with portrayals of center facing heads its versatility would be hugely circumscribed.

The present invention further discloses a means whereby applied images in both non-dedicated and dedicated categories can be cross-referenced to a third party publication without reproducing any of the content of that publication. In the case of non-dedicated applied images the necessary information might be conveyed via the Internet, thereby providing an alternative to the employment of a calibration device or some other system of measuring prospective target images. Where a calibration device is employed the invention provides a system of notation that cross-references markings on the device to the available choice of applied images using, in certain preferred embodiments, the color coded bands. The present invention also discloses, in it fourth aspect described below, a novel device for generating co-ordinates for proposed location of an applied image. The same device is used in reverse, so to speak, to ascertain a location for a given set of co-ordinates.

Preferred embodiments of the second aspect of the present invention will provide users with several sets of applied images each set comprising a plurality of images differing only in scale and attitude of head. Each set of applied images may comprise up to three sheets of A4 material, each sheet of material comprising a backing sheet and a top sheet. The top sheet bears the image on the obverse surface and a self-adhesive substance on the reverse surface. The form of self-adhesive employed may stick the applied image permanently to the target image but the balance of advantage would seem to lay with applied images being re-usable in other locations since in this way the user will in addition be allowed latitude by trial and error.

An applied image representing a hairstyle will inevitably be more bulky than one representing a pair of lips.

In preferred embodiments the top sheet of the material on which the applied images are reproduced may be opaque or transparent. The image may be die-cut by a system known as kiss cutting that leaves the backing material intact. When the top sheet is opaque the line of the die-cutting will follow the outline of the image fairly closely-how closely will determine for better or worse the degree of realism achieved when the applied image is applied to the target image.

Where the material on which the applied images are reproduced is transparent die-cutting may take one of two forms. The cutting line may closely follow the outline of the image or it may take the form of a grid in which the applied images are positioned within squares and rectangles. A grid system will save money and time since it will allow standard grids to be used for a variety of images. It does not, however, make use of the available space economically and this has adverse implications for costs.

There appears to be a significant difference in age groups to whom stickers, scraps, cut-outs, or by whatever other name known, appeal as between North America and Europe. In Europe stickers are marketed to children (and, in the case of those perceived to have an educational value, their parents) whereas in North America people of all ages delight in the creative stimulus afforded by such items. Not only are the stickers themselves sold widely through craft shops and at fairs, but also the necessary equipment for home die-cutting. Images per se are available for downloading from web sites and these require to be hand-cut by the end user. It is thus possible to envisage embodiments of the present invention in which applied images are provided in a form that is not die-cut.

There are important functional advantages to be gained by going down such a road because it is possible to contemplate the provision of applied images of a particular design being made available in a form in which the steps between the bands are less than 120 percent and left and right facing attitudes of more and less than 22.5 percent—and even upward and downward inclinations of the head—are accommodated.

An applied image may depict either a head, an item of headwear or other item able to be appropriated to a head. Typical subjects of applied images will be entire heads or part heads, ears, hair, eyes, lips, teeth, noses, beards, tongues, cigarettes, pipes, cigars, hats, helmets, horns, etc. Items considered able to be appropriated to a head will include halos, light bulbs, hearts, and wings.

Embodiments of the invention may lean heavily on iconic images that strike an immediate chord of response on the part of users. A number of such images will be seen in the drawings accompanying this application.

When the head that is the subject of an applied image is not facing directly to the front but is turned to the left or to the right, allowance must be made for the effect, firstly, of perspective; and, secondly, of the possibility of the target image head obscuring from view a part of whatever it is that the applied image is setting out to depict.

Where an applied image is dedicated to a target image no problems can arise on account of perspective and masking by the head of the target image. The applied image is fashioned in such away that it fits in realistically with the target image showing only what ought to be shown appropriately adjusted for perspective. Where a problem does arise is in the delivery of an applied image to the target image to which it is dedicated and the present invention discloses the means whereby this is achieved.

In the case of non-dedicated applied images, as regards perspective there is a problem in that its effect varies according to the distance of the subject from the viewer. In the present context the viewer is most probably the lens of a photographer's camera of medium focal length. For the purposes of perspective preferred embodiments of the present invention assume a mean distance of between three and five meters. At such a distance, where the subject of a picture is an individual or two individuals or a group of individuals, the effect of perspective is not as dramatic as it would be in a close-up. The fixing of a notional mean distance will always be necessary as regards non-dedicated applied images but some variation in the mean distance may be found desirable in the light of experience.

Non-dedicated applied images also encounter a problem with the effect of masking by the head depicted in the target image. If a non-dedicated applied image is provided on an opaque substrate the outline must be cut round so that when it overlays the target image those parts of the target image that ought to remain in view do so. Where the non-dedicated applied image is provided on a transparent substrate it is not the outline that has to be cut round, rather the printed impression of the applied image on the substrate has to be appropriately delimited. The cutting round or delimiting of the applied image does not of itself give rise to difficulty, it is the precise locus of the line marking the boundary of the applied image. In theory the locus of the line should correspond with the outline of the side of the head of the subject of the target image.

However, head shapes vary and the degrees by which heads are turned vary and it is not possible to lay down hard and fast rules as to how high up a head an applied image will be positioned. Preferred embodiments of the present invention accommodate these variables by defining the boundary of a non-dedicated applied image with a simple curved line that takes no account of the indentation caused by the underlying eye socket.

Although the constructions now disclosed involve a degree of approximation both as regards perspective and masking by the head a satisfactory result is usually achieved.

Certain preferred embodiments of the present invention in its second aspect comprise non-dedicated applied images featuring a known item of novelty headwear in which a pair of oval or other shaped ears is joined together by a split headband. When such an item of headwear is placed on the head of a wearer one part of the headband appears at the front of the head and the other part is out of sight behind the head. From the point of view of graphic art there is a difference between depicting a person augmenting his or her own ears by a pair of larger oval or other shaped ears placed at the sides of the head, and a person wearing an item of headwear incorporating such ears at the distal extremities of an elongate headband, albeit that the item of headwear is two dimensional in character. In accordance with the present invention an applied image of the latter kind for use with a target image in which the subject is turning the head has one of the oval or other shaped ears cut-round or otherwise delimited so as to leave the side of the head of the target image in view, one ear is shown larger than the other, the headband is wider at one end than at the other and the headband is depicted in such away that one end of it appears to disappear out of view as it curves round the wearer's forehead. Where the applied image is in comic art style verisimilitude can be further enhanced by discontinuing a bounding black line at any point where the applied image purports to disappear behind the target image.

In another preferred embodiment of the present invention in its second aspect a non-dedicated applied image is provided that depicts a known item of novelty headwear comprising a crown in the form of a pyramid that is mounted on a visor type headband. The representation is essentially three dimensional in character and works best in a view that shows two of the four sides of the pyramid. Where the alignment of the pyramid does not closely correspond to that of the head of the subject in the target image (for example: pyramid turned by 15 degrees, head turned by 22.5 degrees, or vice versa) it is usually possible to produce a credible result by tilting the pyramid and visor headband at a jaunty angle.

Other preferred embodiments of the invention comprise non-dedicated applied images of items such as tea cosies and colanders that, when appropriated to a head in the manner of headwear, are directionally more versatile than the pyramid.

The novelty headwear featuring the oval or other shaped ears and the visor mounted pyramid described above, and similar items, also have a useful role to play as dedicated applied images.

Whether non-dedicated or dedicated, an applied image may be in a form that does not overlay any part of the head proper as depicted in the target image but it can nevertheless be said to modify or embellish it. It would be possible to add a pair of horns or rabbit ears, for example, without disturbing the outline of the head as reproduced on the target image. Similarly with a halo or pop-up hearts symbolizing love. The representation of such items must take account of scale and perspective in the same way as images that overlay or replace a head.

The provision of dedicated applied images in accordance with the second aspect of the present invention will always be accompanied by means whereby the user is able to identify the target image. In preferred embodiments such means may take the form of a page plan of a publication unconnected in any editorial or publishing sense with the production of the applied image. Numbers or another system of notation applied both to the applied image and to the page plan marry the applied image to the target image.

In another preferred embodiment the means for identifying a target image may take the form of a system of notation that merely identifies the number of the page where the target image is reproduced—leaving it to the user to work out for himself or herself the exact location intended.

Where applied images are provided on a transparent substrate that is die-cut in the form of a grid in the manner already described, a special form of notation is disclosed. This takes the form of detachable triangular shaped portions located at one corner of each of the square or oblong rectangular shapes comprising the grid.

In its third aspect the invention embraces those photographs and other kinds of target image in which there is little or no content of an animate nature.

According to a third aspect of the present invention there is provided an item of material bearing a representation of an image (“applied image”) adapted to be applied to and overlie a target image, which target image is reproduced upon another separate item of material which wholly or mainly depicts a landscape or other outdoor vista, interior or external architecture, furnishings, decor or inanimate objects; wherein the applied image is adapted to be secured in position on or over the target image, and is cut-round or otherwise delimited, so that when applied to the target image, the applied image co-operates with those parts of the target image not thereby obscured to form a composite image in a manner that is dimensionally appropriate; wherein the target image is found on an item which is produced and/or disseminated independently and without reference to the applied image.

Preferred embodiments of the third aspect of the present invention will substitute new landscapes for pre-existing landscapes, new interior decor for pre-existing decor, much in the style, of the present day pre-occupation of applying a “makeover” to domestic gardens and interiors. Such applied images must necessarily be dedicated and as with dedicated applied images in accordance with the second aspect of the invention convenient means must be provided whereby users are able to identify the appropriate target image.

A non-dedicated or dedicated applied image can also be provided in the form of a flap. In its most simple form the flap will comprise a piece of material adapted to be positioned over a target image. A part of the material is provided with adhesive on its reverse surface. A line of fold acting as a hinge enables the remaining portion to act as a flap that can be raised or lowered at will. Such a flap will preferably be printed on both sides to avoid a blank side coming into view when the flap is in the raised position.

In a preferred embodiment the flap is constructed in such a way that printing on obverse surface only of the material is required. Adhesive is provided on the entire reverse surface. Such a flap can be incorporated into a sheet of material on which applied images of the kind previously described are provided. The flap is assembled by folding a portion of the material so that two similarly shaped parts of the reverse surfaces come into face-to-face contact and can be stuck together. The remaining part projects from the folded portion with its adhesive surface still exposed and available to provide a fixing. Between the portion providing a fixing and the portion acting as a flap a line of fold is provided which is adapted to function as a hinge. In a first position, when the flap is in what may considered to be its closed state, the artwork on its exposed surface replaces the underlying target image in a graphically credible manner without necessarily replicating it. Additionally or alternatively it may display a textual message or symbol. In a second position the flap is “opened” by being raised and folded backwardly along the line of fold acting as a hinge so as to lay flat against the surface of the material on which the target image is provided. A part of the underlying target image is thereby brought into view. The reverse side of the flap can either replace the underlying artwork proximate to the target image or display a textual message or symbol, or both, in the manner previously described. It is likely that, wherever possible, a flap will operate about a horizontal hinge and be folded upwardly but horizontal hinges operating in the opposite sense and vertical hinges are also possible. If preferred, flaps can be positioned not directly upon a target image but on an intervening transparent overlay of the kind that are the subject of aspects of the invention later to be described.

Reference has already been made to the benefits that may be obtained by reproducing an applied image on a transparent substrate. A further advantage is the facility to provide users with means whereby the destination of a dedicated applied image can be ascertained with a greater degree of precision than that provided by any of the systems of notation already described. A user may know on which picture a dedicated applied image is to be positioned, and the page of the magazine where it is to be found, yet still be uncertain as to where on the picture it is to be placed. For example, it may be obvious that a dedicated applied image is an embellishment for a head but there may be a number of heads depicted in the photograph. A fortiori, if the embellishment takes the form of a small addition to a head such as an extended tongue or protruding eyes. In preferred embodiments the positioning of such an item may be assisted by adding to the reproduction of the applied image a semi-transparent outline corresponding to a line feature forming part of or proximate to the target image.

It has been found that a non-opaque outline comprised of a thirty percent tint of black (i.e. a light gray) with a width of the order of two points represents a satisfactory compromise between an outline that is clearly visible to the user and one that will be likely to merge with the underlying image when positioned on the page of (typically) a magazine. In certain instances it may be desirable to use a different color tint for the outline marked on the applied image.

A difficulty that arises with the use of semi-transparent gray (or other color) outlines of the kind described in the preceding paragraph is that there is sometimes no suitable line feature near to the target image. The lack of a nearby line feature can be met by extending the die-cut outline of the transparent material upon which the applied image is reproduced to the extent necessary to capture a more distant underlying line feature. This solution may, however, make for an ungainly applied image and will certainly take up more space on the sheet than would otherwise be the case. A second-but again by no means satisfactory-solution is to incorporate into the notation accompanying the applied image a descriptive phrase such as: “to go on head second from left.”

Even this form of assistance is something that would seem better to avoid wherever possible. Much of the pleasure to be provided to users by embodiments of the invention will result from the sense of heightened anticipation experienced at the point where the applied image is removed from the backing material and the pages of a popular magazine are being turned in order to see where it will go. It is possible therefor to contend that the less detailed the information provided in advance, the better.

While the great majority of non-dedicated and dedicated applied images are likely to be reproduced on a paper substrate, other materials may be employed.

Fridge magnets made from plastic and incorporating a magnetic strip can be constructed in accordance with the second and third aspects of the present invention. Such magnets could be used with pictures cut out from magazines and newspapers, family snaps, etc. The magnetic element can be replaced by a pin enabling the item to be used with pin boards. Novelties of this kind would seem to have distinct promotional possibilities.

In a next to be described aspect the present invention avoids the pitfalls outlined above by providing a semi-transparent device in the form of a graduated grid.

When placed upon a page or an individual photograph or illustration depicting a target images, the grid pinpoints the exact spot over which a mark placed upon the applied image is to be positioned. In preferred embodiments the device is able to accommodate a page or photograph or illustration substantially greater in size than itself. Having decided where to place the mark on the dedicated applied image the publisher uses the grid to ascertain the co-ordinates for the underlying spot on the target image and these co-ordinates form part of the notation appearing along side the applied image on the die-cut sheet.

According to a fourth aspect of the present invention there is provided a device for generating a set of co-ordinates for a point on a plane comprised of a flat substrate, the device being generally rectangular in shape and at least partially transparent, the device incorporating at least one pair of intersecting lines forming axes having an origin at or proximate to a corner of the device, no two pairs of axes having an origin at or proximate to the same corner, each corner of the device distinguished by a discrete identifier.

In preferred embodiments of this aspect of the invention a device that is less than A4 in size is marked out with a grid comprised of horizontal and vertical lines that are spaced apart by 7 mm. An alphabetic notation is provided along both the uppermost and lowermost horizontal edges and a numeric notation is provided along both the left hand and right hand vertical edges. The upper edge and lower edge alphabetic notations are identical and likewise the left hand and right hand numeric notations. In the preferred embodiments now described the notations may refer to bands between the lines and not to the lines themselves.

The bands may be colored with light contrasting tints to assist the travel of the user's eye across and down the device. Such a device may be said to have four pairs of axes, each pair of axes having an origin at or proximate to a corner of the device, no two pairs of axes having the same origin. It will be noted that in this embodiment all the horizontal axes use the same alphabetic notation and all the vertical axes use the same numeric notation regardless of which corner provides their origin. In some cases the letters and figures will be read in a conventional ascending scale and in others they will be read in a descending scale.

The four corners of the device are readily distinguishable from each other by the use of different symbols. Thus in the preferred embodiment now described in the upper left hand corner of the device there is a circle comprised of a black outline white at the center (known as the “circle”). In the upper left hand corner there is a solid black circle (the “black spot”). In the lower left hand corner there is a solid black five pointed star (the “black star”) and in the lower right hand corner there is a similar star comprised of a black outline white at the center (the “white star”). These symbols are easily distinguished one from another and can be easily reproduced as part of the notation accompanying the applied image. One or other of the corners identified by the symbols may be offered up to the corresponding corner of a page, photograph or illustration. In a bleed layout the corner of a page will commonly coincide with that of a photograph. In other cases the corner of a photograph will generally provide a more suitable point of alignment rather than the corner of a page.

Using the facility of aligning one or other of the four corners of the device with the corner of a page or the corner of a photograph on a page or the corner of a rectangular portion of a page as the case may be (any of which will come within the scope of the expression “flat substrate”) a device no larger than 170 mm by 220 mm can be used to identify by means of co-ordinates a 7 mm by 7 mm box anywhere on a page with dimensions up to 296 by 406 mm. These dimensions are greater than the page sizes of popular magazines. The 170 mm by 220 mm size of the device in the preferred embodiment now described is larger than is strictly necessary for the page sizes of popular magazines (generally of the order of 240 mm by 330 mm) but the additional area enables a large proportion of the photographs appearing in their pages to be accessed from the lower left hand corner of the device. The 170 mm by 220 mm size can also be used to generate co-ordinates on the page of a tabloid newspaper with dimensions of 300 mm by 390 mm.

Another preferred embodiment of the present aspect of the invention comprises a grid device that is smaller than that described above. Its dimensions (150 mm by 190 mm) are just large enough to accommodate a magazine page that is 240 mm by 330 mm. In the preferred embodiment now described the width of the bands of the grid are slightly less than 7 mm.

In preferred embodiments grid devices, whatever their size, may be provided with apertures at the point of intersection of the lines or bands of which the grid is comprised. Such apertures enable the point identified by the co-ordinates to be unobtrusively marked with a pen, pencil, pin or like article. Apertures placed at the point of intersection of lines or bands which are no larger than pinholes will lend a degree of transparency to an otherwise opaque device upon the surface of which grid lines and graduations are marked.

In preferred embodiments of the present aspect the applied image is provided with a code that directs a user to the magazine (or newspaper) page, photograph and point on the photograph where, the applied image is to be located. A typical code will consist of a number of parts. The destination publication will be identified by one or two upper case letters. The page number and number of the photograph (starting in the top left hand corner of the page and reading from left to right and then down) will follow, the two items divided by a solidus. Where two target images are present in a single photograph they will be distinguished from each other by the addition of lower case letters of the alphabet. Thence will follow the corner symbol, say a black star, and the co-ordinates comprising a letter followed by a number. The point on the target image identified by the co-ordinates will correspond with a mark on the applied image that in the preferred embodiments now described may be a small triangle printed in gray.

The user reads off the co-ordinates along with the rest of the code and, using the grid device, identifies the point on the target image to which the co-ordinates refer. Positioning the mark on the applied image over this point will, in the preferred embodiments now described, generally place the applied image within a maximum of three millimeters of the exact position intended. Final adjustment is left to the eye of the user.

As already stated, in preferred embodiments the nominated corner of the respective grid device and photograph is, wherever possible, the lower left hand corner (indicated by a black star). The upper and lower left hand corners of the device appear to be marginally more convenient for both left and right hand pages. The lower left hand corner is preferred over the upper left hand corner only because one or other needs to be a preferred corner in order to standardize the procedure to the greatest extent possible. A triangle is the preferred symbol for marking the applied image because it is able to indicate direction as well as position. Some applied images are likely to be placed on the backing material at an angle from the horizontal and an indication of the required alignment is not, therefor without value.

It will be apparent that the publisher of an applied image is able to chose within a limited extent the precise location of the mark on the applied image. A small gray semi-transparent triangle will merge better with a part of an underlying image that is dark than one that is light in color. As with an outline corresponding to a line feature it is possible to vary the color of a positioning mark placed upon a dedicated applied image the better to merge with the underlying target image at the point of superimposition. Standardization in the shape and color of such marks to the greatest extent possible may, however, have advantages.

The desirability of keeping the die-cutting outline of the applied image as small as possible is another factor to be taken into account by the publisher when positioning marks.

Whatever the size of the grid device, its edges will usually be taken up by the alphabetic and numeric notations. In practice this does not detract from the efficacy of the device. Applied non-dedicated and dedicated images are rarely positioned on the very edge of a photograph. In the case of a dedicated image intended to be positioned on the edge of a page or photograph the publisher may be able to utilize another corner of the device along with another corner of the photograph or page as the origin for the axes whereby the co-ordinates are generated. Alternatively the publisher can position the mark on the applied image in such a way that it falls within the area encompassed by the grid.

In embodiments in which a light gray outline is incorporated into an applied image that corresponds to a line feature on the target image (along the lines described above) it will also be possible to provide a mark to be aligned with a point the co-ordinates of which are identified by a grid device in accordance with the present aspect.

Grid devices may be distributed separately from applied images, perhaps in the form of free inserts in newspapers and magazines. Such forms of promotion might be used to attract attention to applied images made available for downloading from a web site.

Embodiments of this aspect of the invention are possible in which the mark with which the applied image is provided is positioned adjacent to the applied image and not within its die-cut outline. Alternatively the portion on which the mark is reproduced may be detachable from the applied image prior to it being positioned on the target image. Either of these configurations might be suitable for accurately positioning an applied image which is reproduced on a nontransparent substrate.

Embodiments of the fourth aspect of the invention may relate to target images of all kinds. In most instances the subject of the target image will be a head, human, humanoid, animal or animal like, but it is not necessarily so.

In its next two aspects the invention addresses the particular needs of “scrapbookers.” The safe preservation of photographs for the benefit of succeeding generations is a major concern of followers of the scrapbooking craft to which the element of fun provided by embodiments of the present invention must be assumed to take a second place. However, means are disclosed whereby an applied image can be positioned over a target image on, typically, a family photograph in such a way as to not come into contact with the actual photograph.

In its fifth aspect, the present invention provides a device for superimposing a representation of an image (“applied image”) adapted to be applied to and overlie an image depicting at least in part a human or other animal, humanoid or animal-like head (“target image”), which target image is reproduced upon another, separate item of material; wherein the applied image is a modification, embellishment or replacement for the head in the target image, and is adapted to be secured in position over the target image, and is cut-round or otherwise delimited, so that when applied to the target image, the applied image cooperates with those parts of the target image not thereby obscured to form a composite image in a manner that is dimensionally appropriate, the device comprising: a. one or more pieces of at least partially transparent material upon which one or more applied images are reproduced (the “transparent overlay”); and b. a means for fastening the transparent overlay so that it is able to overlie the target image without adhering thereto.

The means for fastening may be permanent or non-permanent.

Embodiments of the fifth aspect may take one of several forms but all have in common the provision of an applied image on a piece of transparent material. A user is able to locate the applied image over the target image and remove it at will, while at the same time avoiding the possibility excessive displacement.

The means whereby the applied image is secured in position over the target image are in part mechanical and there is no requirement for an adhesive substance to come into contact with the photograph itself.

In certain preferred embodiments of this aspect of the invention the applied image may be provided on a sheet of transparent material that is bound into an album next to and in advance of a page on which a photograph is mounted, the photograph providing the target image. The form of binding employed may be a ring binder in which case the means for fastening the transparent overlay would be considered to be non-permanent. It is also possible for albums to be provided in which transparent sheets are interleaved with opaque sheets on which photographs are mounted, the form of binding employed being of a permanent kind such as sewn or perfect binding.

A more simple embodiment of this aspect of the invention makes use photographic corner mounts that may be used for mounting photographs in scrapbooks. The transparent material on which the applied image is provided is cut to the same size as the photograph and slotted into the corner mounts along with and over the photograph.

In a sixth aspect, the present invention provides a device for superimposing one image (“applied image”) on to another image (“target image”) to form a composite image, the device comprising a first piece of material and a second piece of material, wherein the first piece (“transparent overlay”) is at least partially transparent and bears one or more applied images and the second piece (“fixed portion”) is adapted to be fixed in position relative to the target image, the transparent overlay being fixed to and capable of movement with respect to the fixed portion, so that a selected applied image can, by movement of the transparent overlay with respect to the fixed portion, be aligned with the target image to form the composite image, the transparent overlay not adhering to the target image.

A preferred embodiment takes the form of device in which four applied images appropriate to a head are arranged on a circular shaped disk of transparent material. A facility for rotating the disk is incorporated into the means whereby it is mounted on to, for example, a transparent sheet interleaved with an opaque sheet along the lines described above. The means for mounting and rotation may comprise a second piece of transparent material of a similar kind to that of disk itself. This second piece incorporates tabs adapted to slot into a circular aperture at the center of the disk. It is provided with an adhesive reverse surface that enables it to be secured in a desired position along with the disc.

In such an embodiment the disk may be provided with a selection of applied images ready printed on to its surface or in a blank state. In the latter case a user will position separately provided applied images on to the surface of the disk according to choice, assistance being provided by unobtrusive markings on the surface of the disk.

Another type of preferred embodiment employs a similar kind of rotation device but with the applied images being individually placed on radial arms. Up to four such arms can without difficulty be simultaneously interlocked with a tabbed rotational device of the kind previously referred to. Here again applied images may either be ready printed on the surface of the arms at their respective further ends or left for the user to position according to choice.

In a typical embodiment utilizing four radial arms one arm is likely to be operational at any given moment leaving three arms idle. These latter need to be safely parked so that they will not flap about as the sheet of transparent material or mounting sheet is turned. Devices whereby radial arms are secured to a sheet that comprise either a pocket, or a slot, or a tab, are disclosed.

Embodiments of the present aspect can utilize applied images that are reversible so that left facing images are able to serve as right facing images, and vice versa, wherever necessary.

Certain preferred embodiments of the present invention are directed to providing a use for dedicated and non-dedicated applied images that for one reason or another become redundant. Such a situation can arise in a number of ways. A user who acquires an edition of applied images dedicated to target images in a magazine may not be able to obtain a copy of the publication in question and will be left with the unused dedicated applied images on his or her hands. A retailer may return to the publisher its unsold stocks of dedicated applied images. In the case of non-dedicated applied images sold in sets, users may be left with the odd applied image for which no satisfactory target image appears. In either case a solution can be provided by making available customized target images on cards, writing materials and other kinds of stationery or in the form of albums that are suitable for “using up” those applied images that fail to fulfil their original purpose. Such customized target images can usefully be cross-referenced to an appropriate applied image in terms of size (for example a band number) and attitude (left, center or right facing) of the head. It is also possible for the identification details of the sheet of material on which the applied image is to be found to be provided.

If, as may be hoped, applied images in accordance with the present invention come to be seen as a generic art form it will be possible by such means convert unsold inventory into, inter alia, a valuable archive.

With the increasing popularity of the World Wide Web it is possible to envisage a situation in which such customized target images are provided in digital form available for downloading from a web site.

Applied images generally can similarly be made available in digital form for downloading from a web site. In such a case it is likely that the user will print out the applied image and hand-cut the outline. Hand-cutting by the user is always an available alternative to die-cutting during manufacture.

It is also possible to envisage the provision of applied images by means of a die-cutting form. Die-cutting machines, known as roller cutters, are sold in the United States of America for home use.

Calibration Devices, likewise, can be provided in digital form for downloading from a web site. There would seem to be little to be gained in providing a calibration device by means of a die-cutting form since one calibration device is all that any user should ever need.

The present invention also provides kits comprised of the various devices and items of material that are the subject of the invention in the several aspects described above.

The present invention also provides methods for carrying out procedures envisaged by the invention in the several aspects described above.

The present invention provides a method for calibrating an image of a human or other animal, humanoid or animal-like head (“target image”), which target image is reproduced by printing or other means on a flat substrate which may be paper; the method comprising the steps of: 1. placing a device for calibration of an image as disclosed in this application on the target image; and 2. selecting a shape on the device that matches the outline of the target image and/or the width of the target image most closely.

The present invention provides a method for calibrating an image of a human or other animal, humanoid or animal-like head (“target image”), which target image is reproduced by printing or other means on a flat substrate which may be paper; the method comprising the steps of: 1. providing a conversion table as disclosed in this application that sets out the correlation between a predetermined unit of measurement and the label for the shapes on a device for calibration of an image as disclosed in this application; 2. measuring a dimension of the target image using the pre-determined unit of measurement; and 3. converting the measurement obtained in step 2, by means of the conversion table of step 1, into the corresponding label on the device.

The present invention provides a method for defining a dimension of a feature in an image of a human or other animal, humanoid or animal-like head (“target image”), which target image is reproduced by printing or other means on a flat substrate that may be paper; the method comprising the steps of: 1. placing a device for calibration of an image as disclosed in this application on the target image; and 2. measuring a dimension of the feature in the target image by reference to the size of the head per se.

The present invention provides a method for determining the co-ordinates of a point on a flat rectangular substrate, comprising the steps of: 1. placing a device on the substrate, the device being generally rectangular in shape and at least partially transparent, the device incorporating at least one pair of intersecting lines forming graduated axes having an origin at or proximate to a corner of the device, no two pairs of axes having an origin at or proximate to the same corner, each corner of the device distinguished by a discrete identifier, such that at least one corner of the device is aligned with one corner of the substrate; and 2. reading the co-ordinates of the point by reference to: a. the graduations on the axes represented by lines intersecting at or proximate to the said corner of the device, and b. the discrete identifier appertaining to the said corner of the device, to provide a set of coordinates comprising at least three reference points.

The present invention provides a method for applying an image (“applied image”) to another image (“target image”), which target image is reproduced on a flat rectangular substrate the method comprising the steps of: 1. determining a set of co-ordinates for a target image comprising at least three reference points, the co-ordinates being determined by placing a device on the substrate, the device being generally rectangular in shape and at least partially transparent, the device incorporating at least one pair of intersecting lines forming graduated axes having an origin at or proximate to a corner of the device, no two pairs of axes having an origin at or proximate to the same corner, each corner of the device distinguished by a discrete identifier, such that at least one corner of the device is aligned with one corner of the substrate, and reading the co-ordinates of the target image by reference to: a. the graduations on the axes represented by lines intersecting at or proximate to the said corner of the device; and b. the discrete identifier appertaining to the said corner of the device; 2. identifying the target image by reference to its co-ordinates as defined above, using the device in the manner described in step 1; and 3. placing the applied image on the identified target image.

The references in the methods described in the preceding two paragraphs to a corner of the substrate may refer either to a corner of a page from a magazine, book or newspaper or to a rectangular portion of such a page such as, for example, a photograph.

The present invention provides a method for applying an image (“applied image”) to an image of a human or other animal, humanoid or animal-like head (“target image”), wherein the applied image is a modification, embellishment or replacement for the head in the target image, the method comprising the steps of: 1. providing the applied image in varying size and/or shape as attributable to the degree of rotation of the head; 2. calibrating the head in the target image in accordance with either of the two methods first above described; and 3. placing the selected applied image on or over the target image; wherein the scale of the size and/or attributed degree of rotation of the shapes on the device corresponds wholly or partly to the scale of size and/or attributed degree of rotation of the applied image.

The present invention provides a method for applying an image (“applied image”) to an image of a human or other animal, humanoid or animal-like head (“target image”), wherein the applied image is a modification, embellishment or replacement for the head in the applied image; the method comprising the steps of: 1. providing or receiving directions for placing the applied image to the target image; and 2. placing the applied image on or over the target image in accordance with the directions; wherein the target image is produced and/or disseminated independently of, and with no reference to, the applied image.

In this method, the directions may be conveyed at least in part by a web site or E-mail or other Internet medium.

The devices disclosed by the present invention may be made from a material that is free of acid, PVC or lignin or any other substance not considered compatible with archival quality.

Preferred features of each of the aspects apply to all other aspects, mutatis mutandis.

### DESCRIPTION OF THE DRAWINGS

These and other advantages of the present invention are best understood with reference to the drawings. Figures may comprise a single drawing or a group of drawings.

Where a plan view of an embodiment of the present invention or of an item bearing upon the invention is illustrated the scale of the illustration, expressed as a percentage and relative to the size envisaged for such an item in use, will generally be given. Embodiments of the present invention may, however, vary in size. The primary purpose of many of the embodiments now disclosed is to provide or facilitate the provision of applied images suitable for use with target images of a similar size. The most likely source of target images is photographs appearing in popular magazines that tend to vary in size within a relatively narrow compass. It is reasonable, therefor, to direct the main thrust of the invention to a restricted range of sizes, both as regards calibrating devices and applied images. In this way the cost of production, distribution and inventory can be kept to a lower level than would otherwise be possible without an equivalent lessening in potential demand. Even within the restricted range of sizes referred to there are countless other variables. These can only be dealt with effectively by adopting a novel approach that departs from anything previously seen in the sticker publishing field. Some variation in the range of sizes of target images needing to be accommodated is, however, likely in the light of practical experience.

In the drawings that follow folds may be classified as being either “valley” folds or “mountain” folds. A valley fold is one in which the material on either side of the line of fold is brought towards the folder. A mountain fold is one in which the material on either side of the line of fold is moved away from the folder.

Valley folds are shown by a line of round dots and mountain folds are shown by dashes with rounded ends.

In the figures:

FIGS. 1 to 7 show a shop display head in attitudes in which it is facing directly ahead, inclined upwardly and downwardly and facing to left and right;

FIGS. 8 to 15 show items of novelty headwear known in the art in plan and perspective views and as seen when in position on the display head, such headwear being considered to make a suitable subject for applied images in accordance with the present invention and demonstrates the differences in appearance of items of headwear that are essentially two dimensional when compared their three dimensional equivalent;

FIGS. 16 to 18 show how the outline of a head, as exemplified by the display head, can be incorporated into a calibration device in accordance with the present invention in its first aspect;

FIGS. 19 to 31 show various kinds of calibration device in accordance with the invention, wherein when the material from which the calibration device is made is required to be transparent, transparency is indicated by the use of a light gray to white gradient;

FIG. 32 shows a conversion table that converts the widths of the bands formulated for the purposes of the invention and utilized by many of its embodiments for the benefit, inter alia, of users who are in possession of applied images but do not have access to a calibration device of the kind provided by the invention;

FIG. 33 demonstrates the means whereby a calibration device can be used to access the relative size of another feature of a target image such as a hat;

FIGS. 34 to 82 show the manner in which applied images in accordance with the invention falling within the non-dedicated category are made available to users and the means whereby they are applied to target images;

FIGS. 83 to 92 show applied images that might be non-dedicated or dedicated to a specific target image that are suitable for use as “fridge” magnets or for pinning pictures to notice boards;

FIGS. 93 to 108 demonstrate the manner in which applied images dedicated to a specific target image are utilized;

FIGS. 109 and 110 show two notional two-page spreads something in the style of a popular magazine;

FIGS. 112 and 113 show the same two two-page spreads illustrated in FIGS. 109 and 110 as they might appear following the attachment of a number of dedicated or (possibly) non-dedicated applied images;

FIGS. 114 to 121 demonstrate the manner in which the applied images seen in FIGS. 112 and 113 are cross-referenced to the respective target images and laid out on self-adhesive material;

FIGS. 122 and 123 demonstrate the means whereby a role may be found for applied images originally dedicated to target images found on items produced and/or disseminated independently and without reference to the applied images, but in the event not so used;

FIGS. 124 to 133 show devices in which an applied image is provided in the form of a flap that may be raised and lowered as required;

FIGS. 134 to 136 show the means whereby the accurate placement of a dedicated applied image is assisted by the addition to the applied image of an outline that corresponds to a line feature at or proximate to the target image;

FIGS. 137 to 147 show a grid device that will assist in the accurate placement of a dedicated applied image by providing the applied image with a mark that corresponds to a point on the target image identified by the device; and

FIGS. 148 to 174 demonstrate the means whereby transparent overlays may be used to position applied images on target images without adhering thereto.

### DETAILED DESCRIPTION OF THE PREFERRED EMBODIMENT

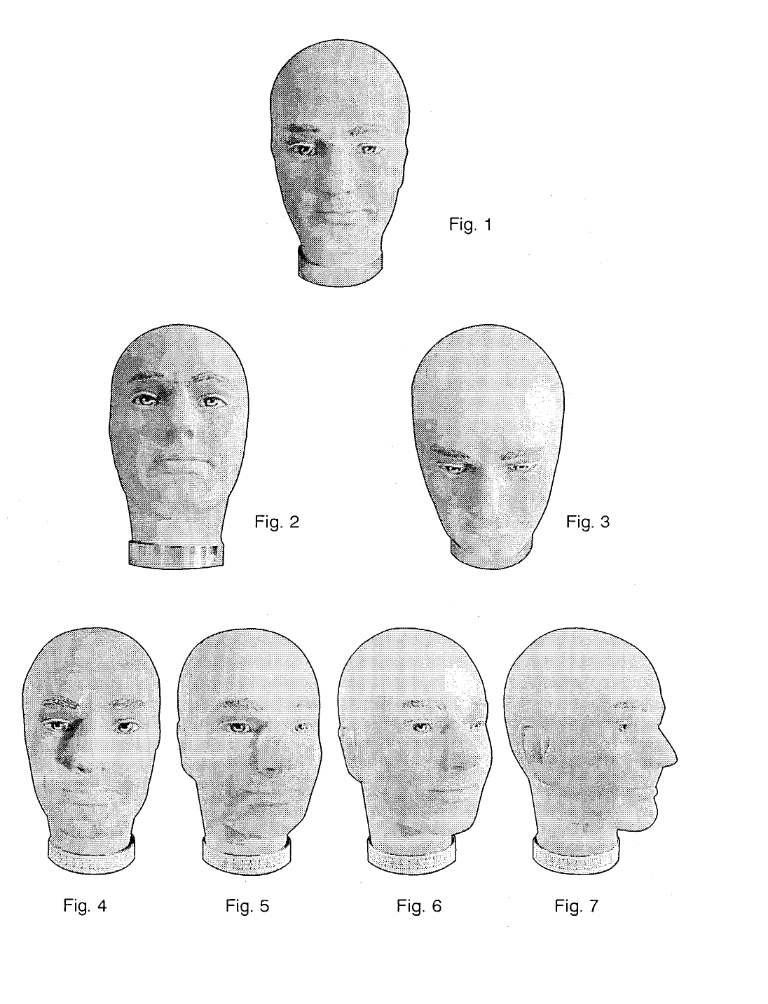

FIG. 1 shows the head of a man in an attitude in which the head is neither tilted upwardly or downwardly nor turned to the right or to the left. This head, which appears in a number of the illustrations that follow, is a life-size shop display head.

FIGS. 2 and 3 show the same head inclined upwardly and downwardly respectively.

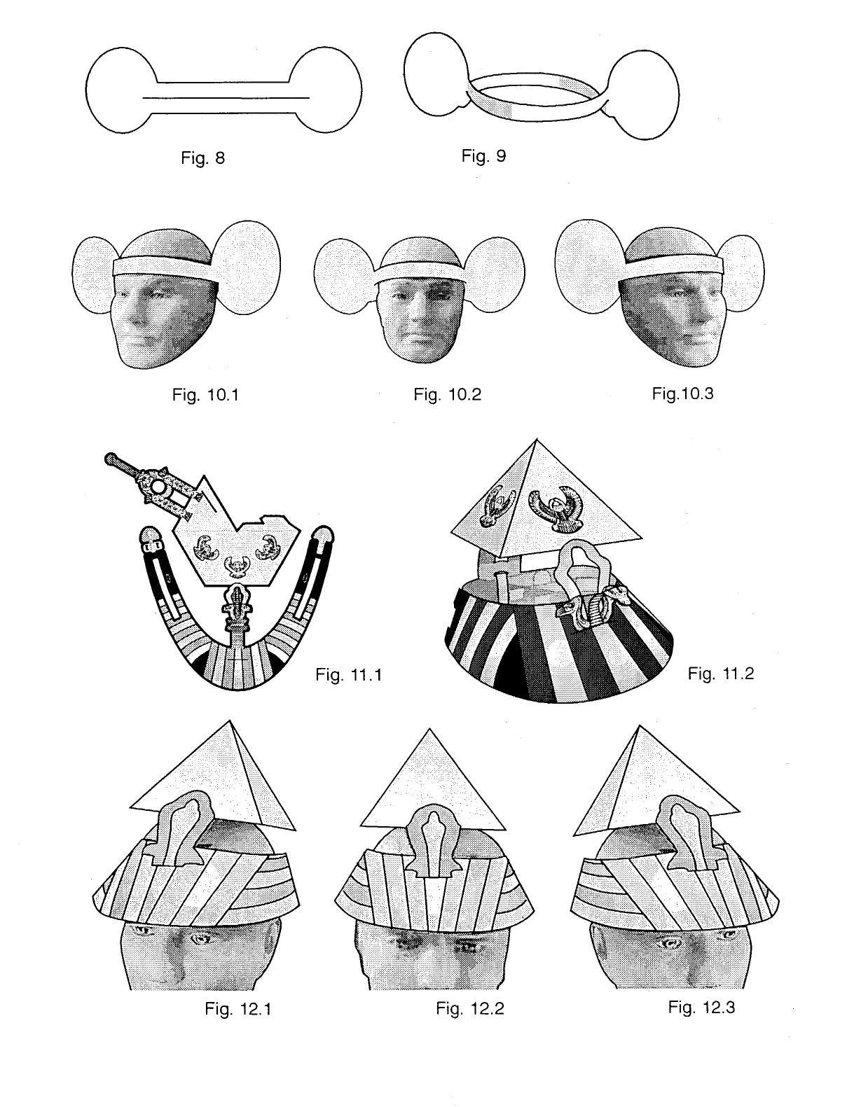

FIGS. 5 to 7 shows the same head turned to the right (“right” as from the view point of an onlooker and not from that of the subject of the head) the extent of the rotation being 15 degrees, 22.5 degrees and 45 degrees taking a directly to the front attitude (shown in FIG. 4) as zero degrees. In each case the head is in a level attitude being neither inclined upwardly or downwardly. If the head were to be turned to the left in a similar manner the resulting views would be a mirror image of those depicted.

As already noted, for the purposes of the present invention, it is the turning of the head that is relevant, not the direction in which the subject is looking-it being possible to look to the left or to the right without turning the head.

FIG. 8 shows an item of split headband headwear of unitary construction in a plan view.

FIG. 9 shows a similar item of headwear in a perspective view as it might appear when about to be placed upon the head.

FIGS. 10.1, 10.2, and 10.3 show a similar item of headwear as worn by a person whose head is respectively turned 22.5 degrees to the left, facing directly ahead (which may be categorized as “to the center”) and turned 22.5 degrees to the right. It will be noted that the design of the headwear is two-dimensional in character.

FIGS. 11.1 and 11.2 show another item of headwear of unitary construction, in this case comprising a pyramid mounted above a visor type headband. The styling incorporates a cobra motif that is bent forward above the brim.

FIGS. 12.1 to 12.3 show a similarly configured item (but with the cobra motif lying flat) as worn on a head. The views are similar to those depicted in FIG. 10 above although the extent of rotation is slightly less where the head is turned.

The evidence for the different degree of turn lies, inter alia, in the presence of a narrow gap between left hand eye and the edge of the face (and similarly with the right hand eye in FIG. 12.3). The design of this item is three dimensional in character with one of the sides of the pyramid coming into view as the head is turned.

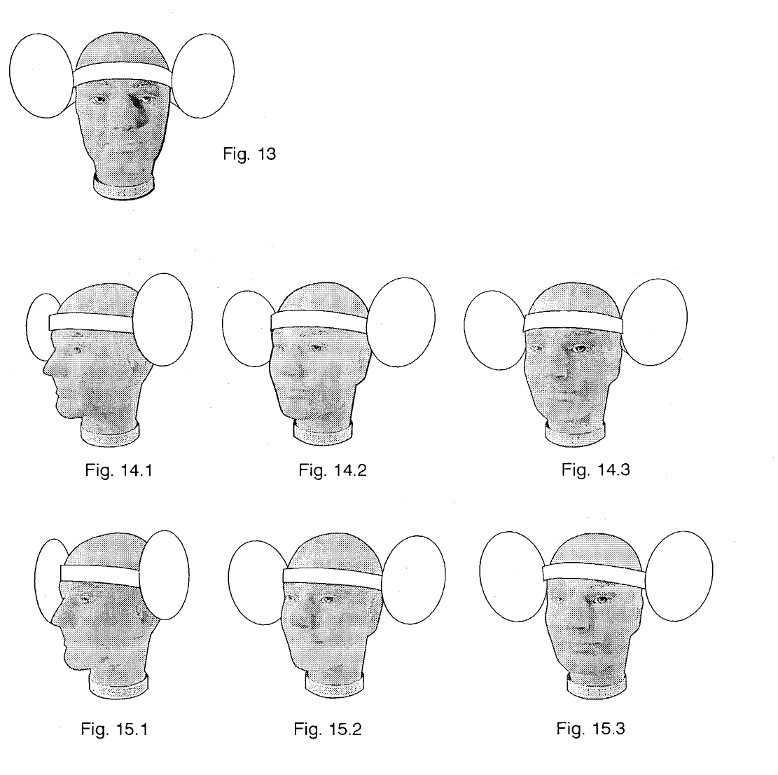

FIGS. 13 to 15 demonstrate the extent to which the different degrees of distortion in relation to the plan dimensions of an item of headwear of the kind illustrated in FIGS. 8 to 10 varies according to the distance between the subject and the viewer. In the case of most embodiments the viewer will in effect be the lens of a camera. FIG. 13 shows a “center” view of an item of headwear similar to that illustrated above at FIGS. 8 to 10. So far as the oval shaped ears at the sides of the wearer's head are concerned the view is barely distinguishable from a plan view.

FIG. 14 shows similar items of headwear as they will appear at a distance of 1 meter when the head of the wearer is turned away from center and to the left by respectively 45 degrees, 22.5 degrees and 15 degrees.

In FIG. 14.1 the horizontal and vertical dimensions of the oval shape of the left ear, disregarding the masking by the wearer's head, are respectively 60 percent and 80 percent of the comparable dimensions of the left ear seen in the view depicted by FIG. 13. The respective dimensions of the right ear in FIG. 14.1 are 95 percent and 110 percent compared with those of the right ear shown in FIG. 13. The reduction in the horizontal dimension and increase in the vertical dimension of the right ear reflects the fact that the ear has moved closer to the viewer but is no longer seen head-on.

The comparable percentages for the left and right ears in FIG. 14.2 are 91/91 and 107/107. Those for the left and right ears in FIG. 14.3 are 100/95 and 106/104.

In FIG. 15 the same three views are shown but in this case the subject is viewed at a distance of four meters or thereabouts. At the greater distance the size of the head and headwear would of course be reduced overall but this has been compensated for by the scale of reproduction on the page. As might be expected, at the greater considerable foreshortening occurs, the comparable percentages being 75/95 and 80/105 in FIG. 15.1; 100/100 and 100/105 in FIG. 15.2; and 100/100 and 100/100 in FIG. 15.3. The changes in perspective brought about by the increase in distance are in any case visible to the naked eye.

It needs to be emphasized that the measurements upon which these percentages are calculated have not been arrived at with the benefit of elaborate instrumentation and are not put forward as a precise indication of the changes brought about by perspective at different distances. The significance of the exercise lies in the perception that the application of most embodiments of the present invention will be related to photographs of individuals, sometimes single, sometimes in pairs and sometimes in groups, in which the distance between camera and subject averages not one meter but at least three meters.

To be user friendly, the range of variables that can be accommodated by non-dedicated embodiments of the invention must necessarily be limited. The amount of distortion applied on account of perspective in the case of non-dedicated embodiments is, accordingly, of the order of that seen in the last mentioned group of figures—FIGS. 15.1 to 15.3. As regards dedicated embodiments where the applied image is precisely tailored to a known target image the perspective will be appropriate to that present in the target image and no approximations in advance are necessary.

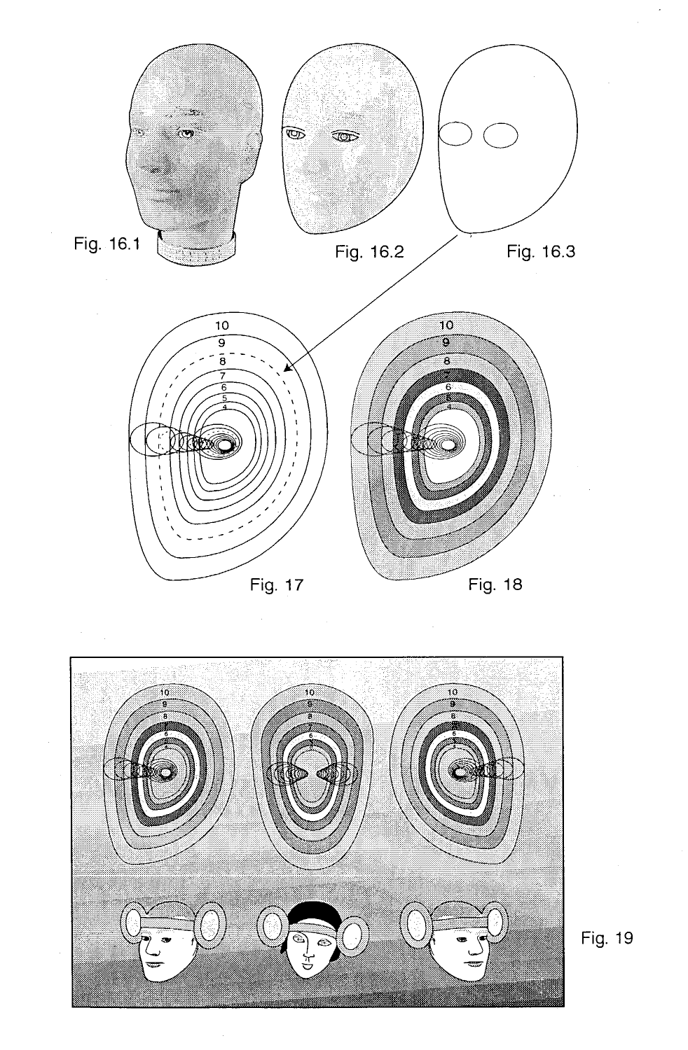

FIG. 16.1 shows a head rotated 22.5 degrees to the left as in FIG. 14.2 above.

The outline of the left side of the face shows a typical profile in which the cheekbone and the indentation caused by the underlying eye socket can clearly be distinguished. FIG. 16.2 shows the same head with the outline smoothed so that the cheekbone and eye socket features are no longer prominent.

Representations of the eyes have been provided which show their position towards the left hand side of the face, the right hand eye slightly larger than the left giving effect to perspective. In the third drawing, FIG. 16.3, the representation of the eyes has been simplified and enlarged. This figure is shown at 60 percent of scale and in the scheme of numbering adopted throughout this application the outline corresponds to head size number 8.

FIG. 17 shows one of the ways in which outlines defining a number of different head sizes can be provided in a small area by superimposing the markings for the different head sizes one upon another. In this instance the markings are arranged in what may be described as a concentric manner. Such a configuration requires the calibration device to be made from a transparent or semi-transparent material To the extent that it may be relevant in the context of this application, numbers are considered to apply to the outline outermost of the number. Where—as in the next following FIG. 18—the marking comprises a band rather than a solid line the entire band is considered to relate a particular head size. It might be argued that in the latter circumstances the number ought to be assigned to a notional line following the co-linear axis of the band but this would be to invest calibration devices in accordance with the present invention with a degree of precision that, although theoretically possible, in practice will never be achieved.

It will be seen that the markings depicted in FIG. 17 (and in later figures) include the oval eye shapes first seen in FIG. 16.3. Both head and eye outlines corresponding to head size number 8 are indicated by broken lines. Lines of different colors and weights, solid and dotted can be used to make devices displaying superimposed outlines more user friendly.

In use a calibration device in accordance with the present invention is laid over a target image that will often be a color photograph in a popular magazine.

The device is designed to measure the size of a head featured in the target image and by assigning to it a specific head size number the user is able to make a selection from a choice of applied images using the same numbering system. The calibration device will also prompt an inexperienced user to determine whether and to what extent the head featured in the target image is turned and if turned, whether to left or right. It is thought that it may be helpful in this regard if there is also provided on the face of the calibration device a small illustration showing the head of a person who is wearing a simple item of headwear with the head turned to the left or the right or facing center as the case may be.

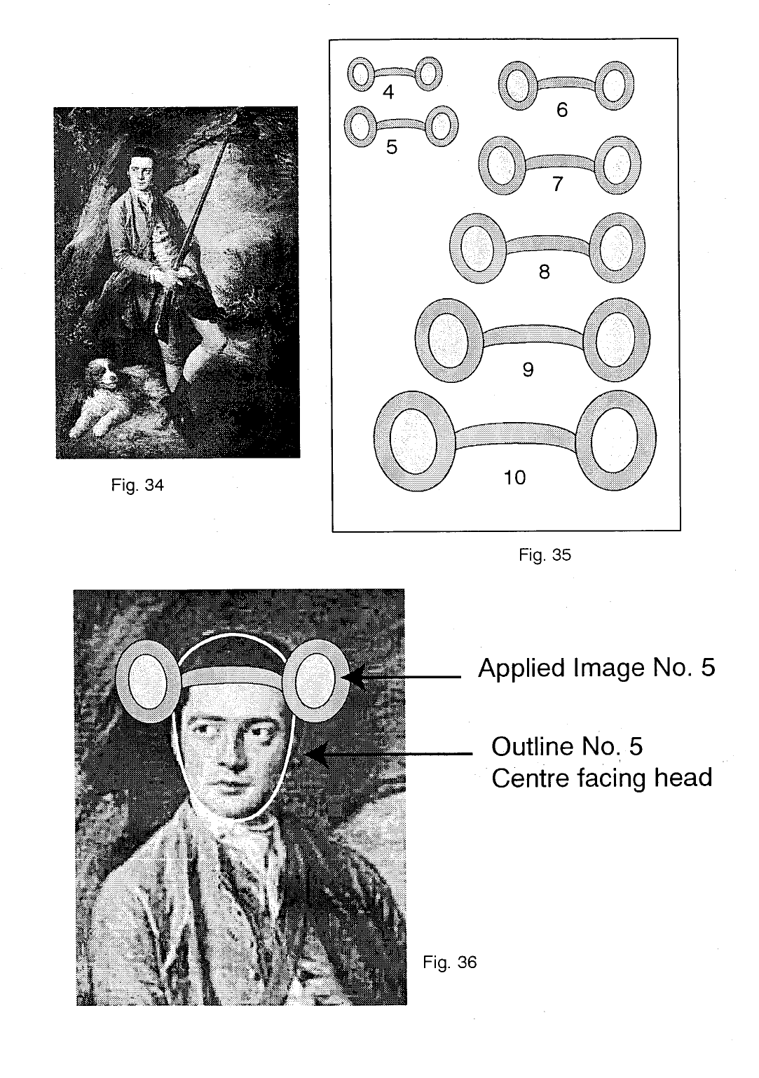

It is anticipated that users will quickly acquire the ability to accurately assess the direction in and degree by which a head is turned by eye but they will still need the calibration device to determine the size of the head and to select a suitable applied image. The use of calibration devices is further discussed below in connection with FIGS. 34 to 82.

FIG. 19 shows in a smaller scale a layout for a calibration device comprised of three groups of outlines: head-facing-left, head-facing-center and head-facing right. Each group embraces a plurality of head sizes ranging from size 4 to size 10. It will be noted from this illustration that the head-facing-center outlines (which in this case are comprised of multi-colored bands) have been simplified in much the same way as those for head-facing-left in FIG. 16.3. The head-facing-right outlines in FIG. 19 are, of course, a mirror image of those for head-facing-left.

The numbering system adopted has been devised for the purposes of the present invention and has no counterpart in other fields of art. Other numbering or lettering systems and other means of identifying different head sizes may be accommodated by calibration devices in accordance with the invention, the upper and lower limits of the range may be varied as also the number of steps.

A calibration device of the kind illustrated at FIG. 19 comprises seven separate bands in each of the three groups. In the case of both the head-facing-left group and the head-facing-right group, the sizes of the bands measured across their horizontal width at their widest point ranges between approximately 23 mm (taking the innermost outline of Band 4) and approximately 80 mm (taking the outermost outline of band 10). The bands successively increase in size at a rate of 120 percent, compound. A total of seven bands across such a range will embrace the great majority of pictures in topical magazines. The addition of an eleventh band at the upper end of the range would make the calibration device unwieldy. The addition of smaller bands at the lower end of the range, to which the numbers one to three can be assigned, is of doubtful value since the application of applied art to such small target images is both fiddly and relatively unrewarding.

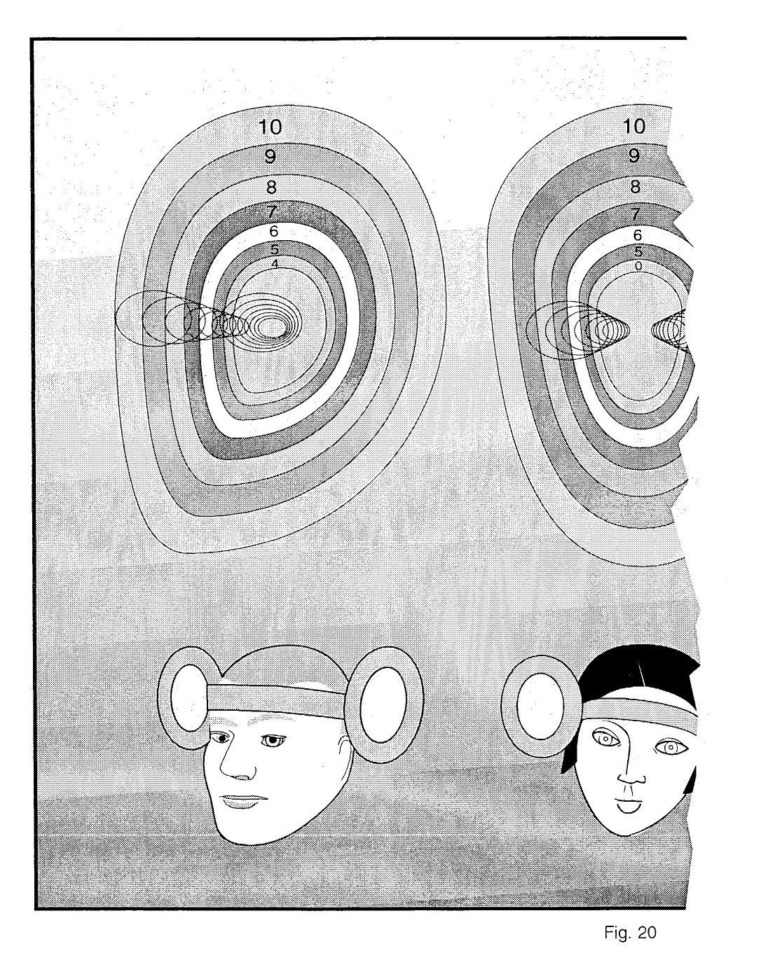

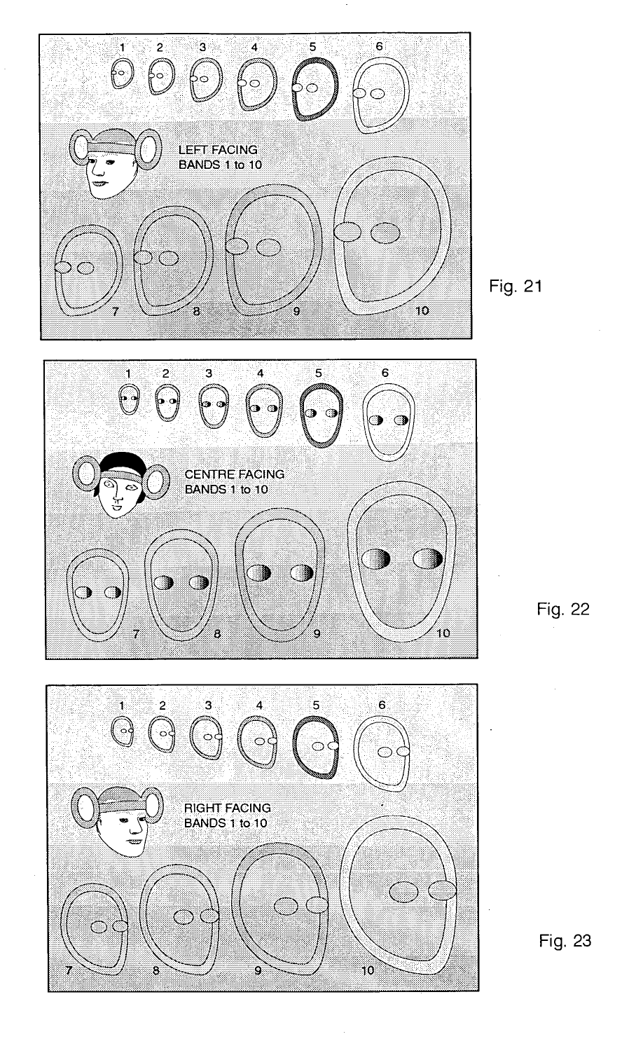

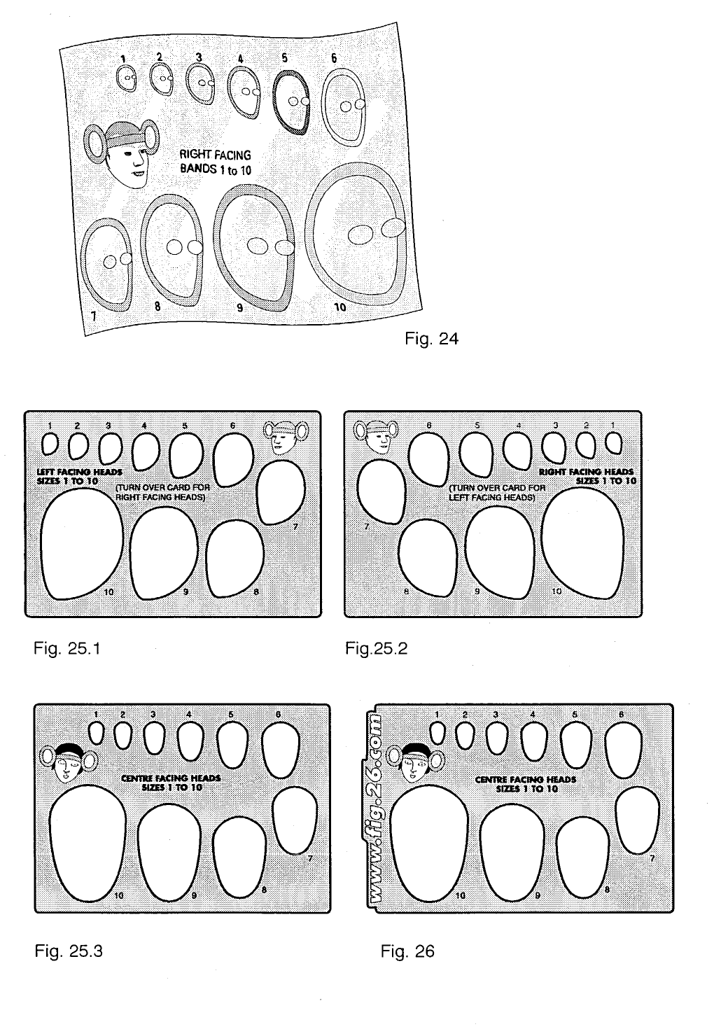

FIG. 19 is shown at 40 percent of scale. FIG. 20 shows a detail of the calibration device illustrated at FIG. 19 at 100 percent of scale. This drawing provides, at a glance, a better impression of the scope afforded by calibration devices in accordance with the present invention.

FIGS. 21, 22 and 23 show an alternative configuration for a calibration device in which the bands representing the different head sizes are not superimposed but are spaced apart. Given the complexity of many target images the greater clarity afforded by such a layout is a considerable advantage. Particularly useful are the schematic representations of eyes that can be “aimed” at the eyes of a target image and may assist the selection of the correct headband size. The representation of eyes in superimposed versions has a collective value but the eyes appropriate to the individual bands are difficult to pick out. The disadvantage is that at least two pieces of transparent material will be required instead of a single piece as is the case with the device depicted at FIGS. 19 and 20. FIGS. 21 to 23 show a three-piece configuration but the number can be reduced to two by arranging for the head-facing-right outlines to accessed by turning over the material on which the head-facing-left outlines are provided. In this way the two items depicted in FIG. 21 and FIG. 23 are combined into a single item that is reversible. Numbers and other written data have to be printed on both sides but this can be effected in the context of a substantially transparent material by under printing a solid color where necessary.

FIG. 24 is a perspective view of the item illustrated at FIG. 23.

FIGS. 25.1, 25.2, and 25.3 show at 25 percent of scale calibration devices made from a non-transparent material such as (possibly rigid) paper card. The apertures corresponding to the different head sizes are provided by die-cutting and are something in the style of the measuring devices sent to prospective customers by jewelers selling rings by mail order. Some users may find such a configuration less easy to use than that shown in FIGS. 21 to 24 since the transparent material is helpful when such complicating factors as hair styles and hats have to be taken into account. Transparency also facilitates the representation of eyes.

FIGS. 25.1 and 25.2 show the obverse and reverse sides of the same piece of material, the obverse side relating to left facing head images and the reverse side to right facing head images. FIG. 25.3 completes the set with apertures relating to center facing head images.

FIG. 26 demonstrates the promotional opportunities afforded by calibration devices that would seem to come more naturally to items made from paper card than from a transparent material—not least because the cost of production is likely to be lower and it is not difficult to envisage mass distribution as part of a mailing shot. The figure is reproduced at 25 percent of scale.

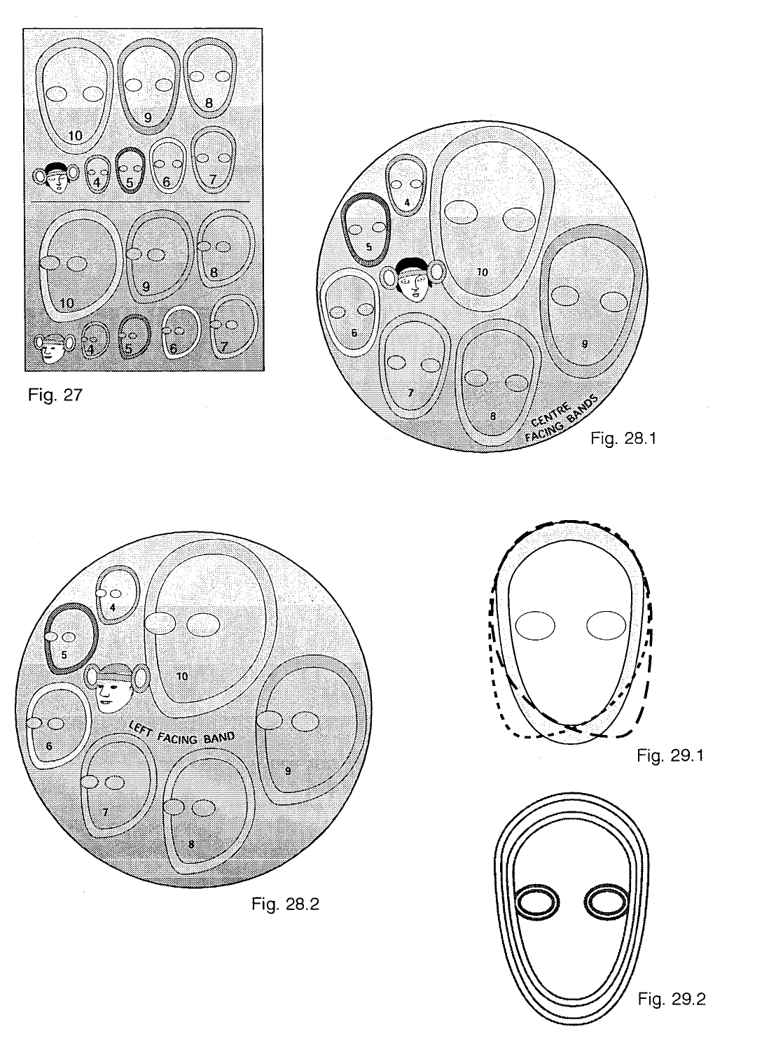

FIG. 27 shows an arrangement in which Band 4 to 10 for both center facing and left facing head sizes are squeezed on to a single piece of transparent material, the intent being that a user will turn it over when the head on the target image faces right. The actual size of this embodiment, 230 mm by 330 mm, would seem to be the irreducible minimum for a calibrator in which the key head sizes and “turns” are provided in a single piece of material with the outlines of the heads not superimposed but spaced apart. The figure is reproduced at 25 percent of scale.

FIGS. 28.1 and 28.2 show the same sets of band in a circular arrangement requiring two pieces of pieces of transparent material. In the case of the center facing calibrator the actual diameter is 200 mm. The left facing calibrator has to be slightly larger and here the diameter is 215 mm. Both figures are reproduced at 40 percent of scale.

FIG. 29.1 demonstrates the means whereby left facing and right facing outlines can be superimposed on a band representing the same size of head in a center facing attitude. The resulting calibration device will be confined to one piece of material of the same size as that illustrated at any one of FIGS. 21 to 24. The respective bands are shown in different kinds of broken line so that they can be more readily distinguished from each other. Different colors may also be utilized The disadvantage of this arrangement lies in the absence of eyes for the left and right facing outlines. It is thought that such a device would be suitable only for relatively experienced users. The band shown in this figure is Band 5, scale 100 percent.

FIG. 29.2 shows a variation on a single black line either to define an outline or the edges of a band for use with a calibrator constructed from a transparent material. A colored line is underlaid by a wider black line. The colored line might be broken to provide even greater transparency. The use of such a graphic device is suggested by the highly colorful and complex nature of certain target images. A somewhat analogous version can be seen in action in FIG. 44 below.

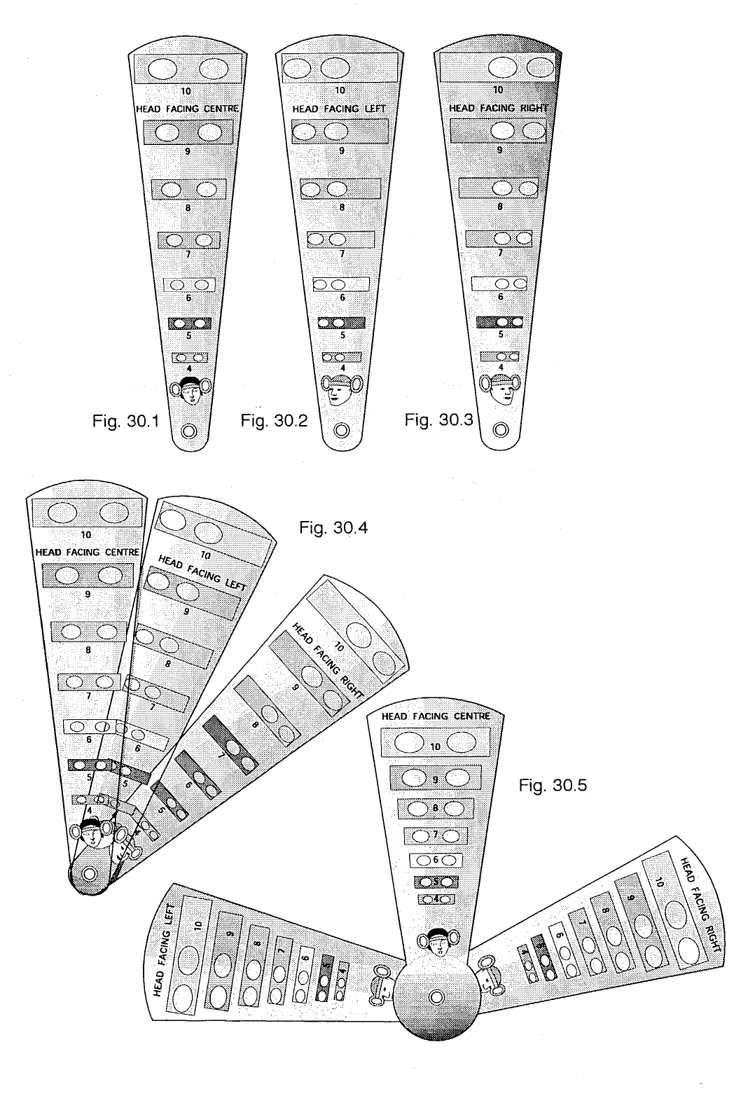

FIG. 30 shows a swatch type calibration device made from a transparent material in which the outlines of the relative head sizes are replaced by bars of different colors. The respective horizontal dimensions of the individual bars correspond to the widths of various sizes of head measured horizontally from side to side across the eyes. The presence of representations of eyes thus contribute to the efficacy of the device. The bars shown on this illustration are the equivalent of Bands 4 to 10. A bar representative of a larger head size, say equivalent to band 11 and applicable to a head size 120 percent greater than that of Band 10, could be added for a lesser space penalty than would be the case with the other calibration devices shown earlier drawings. The compactness of this device is assisted by the facility to mount the three components one above the other, metal eyelet style, in the manner shown in the fourth drawing, FIG. 30.4. The actual maximum dimensions of the individual components are 83 mm by 286 mm in the case of that depicted in FIG. 30.1 and 88 mm by 286 mm in the case of those depicted in FIGS. 30.2 and 30.3. The scale of reproduction is 40 percent.

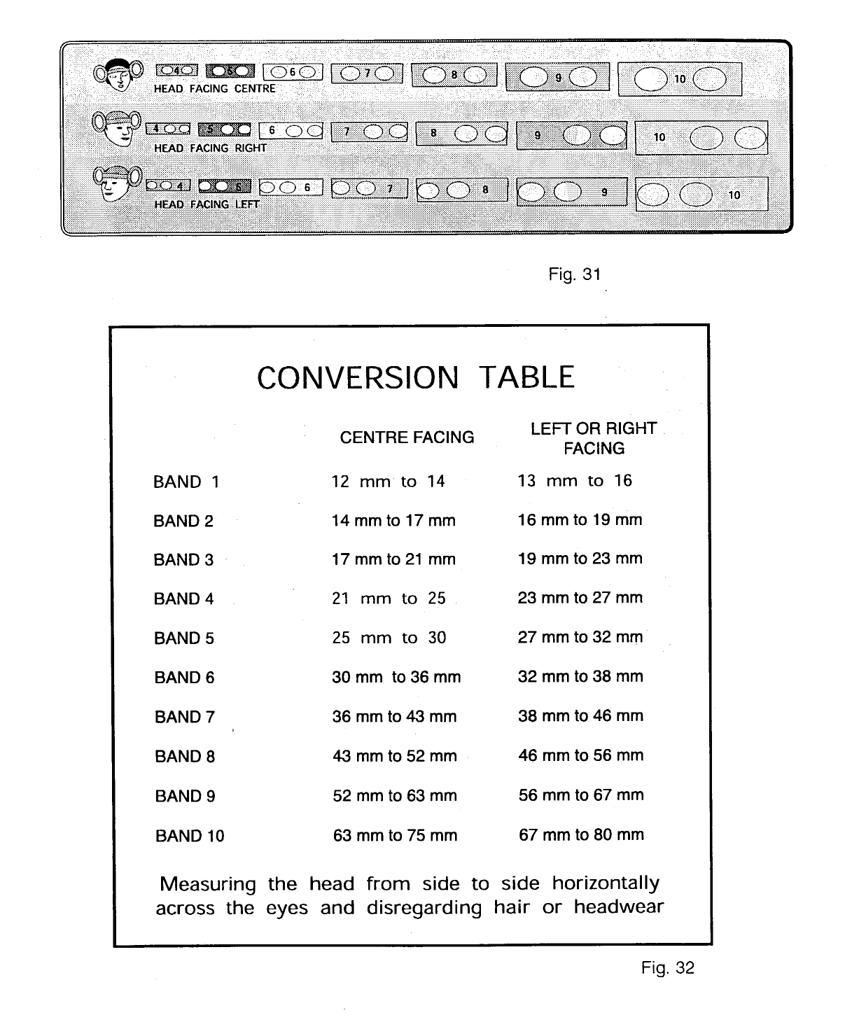

FIG. 31 illustrates another calibration device in which a reduction in size is brought about by substituting bars for bands. Reproduction is at 40 percent of scale. The actual size of this device is 117 by 441 mm—testimony, if any needed, to the compactness achieved by the swatch device described in the preceding paragraph.

FIG. 32 shows a conversion table. Users who do not have access to a calibration device in accordance with the invention may nevertheless wish to take advantage of the invention in its other aspects. They can if they wish use an ordinary ruler utilizing the imperial or metric scale of measurement. They will be greatly assisted by a conversion table of the kind illustrated which (in this instance) converts band sizes to millimeters and vice versa. The resulting figure is rounded off if necessary. It will be a simple matter for the user to place a ruler across the head of the target image and read off the band size from the table.

Calibrating devices in accordance with the first aspect of the invention are likely to employ color coding for the bands or bars and the individual colors can be carried across to the notation of the applied images. The same system of color coding can be incorporated into the table. It is also possible to add a further column setting out equivalent measurements on the imperial scale if required.

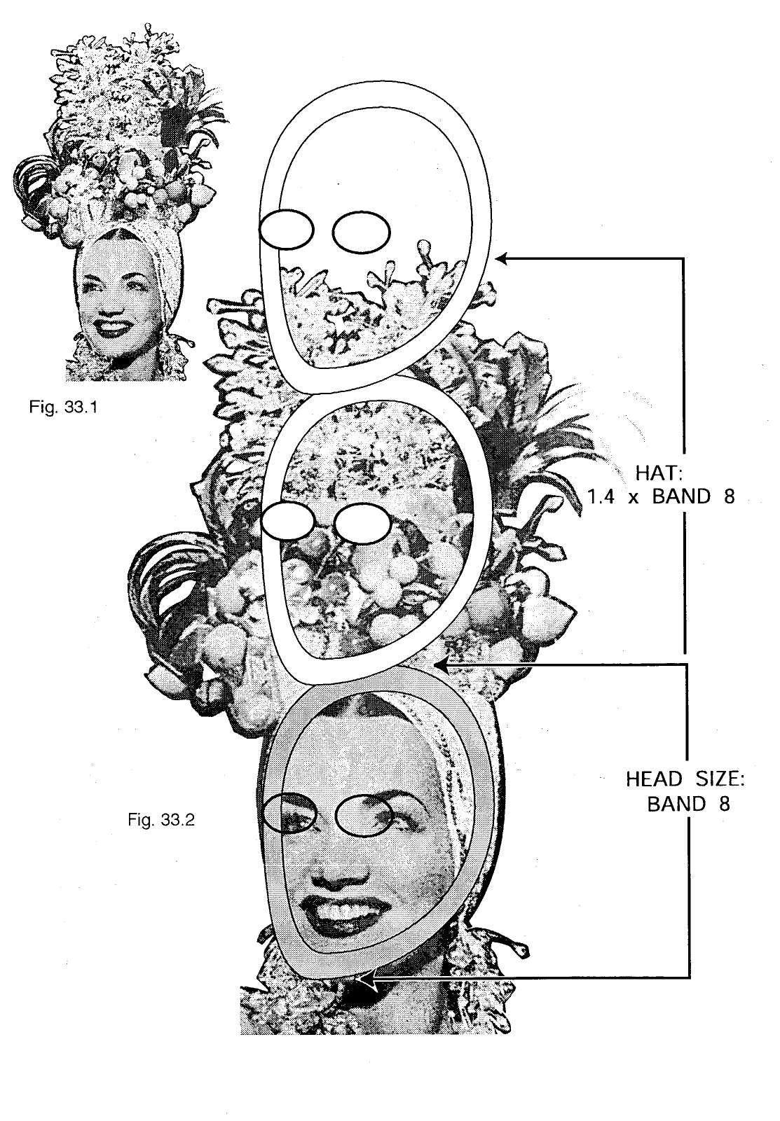

FIG. 33 illustrates the manner in which a calibration device in accordance with the present invention can be used to calculate the relationship between the size of a head on the target image and another feature—in this instance an item of headwear. A famous example of a very large hat is that depicted in FIG. 33.1 which shows the film star Carmen Miranda as she appeared in the 1941 film That Night in Rio. The second figure shows how, using a calibration device of the kind illustrated in FIGS. 19 to 31, it can be quickly established, firstly, that the size of Miss Miranda's face (as reproduced in the second drawing, FIG. 33.2) corresponds to band 8 and, secondly, that the size of her hat, judged by eye, is of the order of 1.4 times the size of her face (measured vertically in each case).

Almost sixty years have passed since the film was first shown and the hat is still considered to be, by any standards, a very large hat. In a scale one to one hundred of hat sizes relative to wearers' head sizes in which a headscarf represents zero Miss Miranda's hat—at 1.4 times the size of her head—can conveniently be taken as representing one hundred. Hats even larger than the Miranda hat (relative to the size of the wearer's head) will achieve a figure in excess of a hundred.

It remains to be seen whether users who avail themselves of the facility of relating the size of headwear, hair styles of other physical attributes of the subject of a target image to the size of subject's head, and by extension to that individual's overall physique, will prefer to express their findings as percentages of head size (here, 1.4) or render them in terms of a scale of one to a hundred.

In the latter case a table will be needed for each kind of item measured.

Present day fashion, as regards hats worn at occasions such as weddings and race meetings, favors those that are wide rather than high. The size of a hat in terms of its width relative to the width of the head of the wearer can be calculated with the assistance of a calibration device in the same way as described above in connection with relative heights. A hat that is both wide and high would merit two calculations with the results separated by a solidus. It would be convenient for all concerned if it could be agreed that in such cases the height would always come first. It should be noted that a figure of 1.4, while indicating a very large hat when referring to height, is not exceptional in terms of width. A hat worn at Epsom racecourse on Derby Day shortly before the filing of this application had a width three and one third times that of the wearer's head. The provision of scales of 1 to 100 for the expression of both calculations will make them more easily comparable.

Used in the manner described in the preceding three paragraphs calibrators in accordance with the present invention have the necessary properties to provide a lingua franca for individuals who study contemporary trends in fashion and photographic journalism. The opportunities for making contact with other individuals with a similar interest that are now available through the World Wide Web are likely to provided a further stimulus to the development of such an activity.

FIGS. 34 to 92 are concerned with the application of images (applied images) to target images in accordance with the present invention in its fourth aspect.

Subsequent figures illustrate applied images in accordance with the fifth aspect as well as the fourth aspect of the invention.

Applied images in accordance with the fourth aspect of the invention will relate to facial or other physical features or to an item of headwear or other items appropriate to a human or other animal or humanoid or animal-like head. Such applied images may be dedicated to a specific target image, and precisely configured accordingly, or not dedicated to any particular target image. In the latter case the relevant dimensions of the target image are ascertained and a selection made from a range of applied images similar in design but in different sizes and corresponding to different attitudes of the head. To ascertain the dimensions of the target image a calibrating device in accordance with the first aspect of the invention can be used or, alternatively, a conventional measuring device such as a ruler. In the case of dedicated images no measurements are needed.

FIG. 34 shows a well known painting by the 18th Century artist Thomas Gainsborough. The head of the subject provides a target image. Although the eyes of the person depicted are looking in the direction of the viewer's left the head is center facing.

FIG. 35 shows a plurality of non-dedicated applied images comprising representations of an item of headwear formed by a pair of oval ears joined together by a headband. The representations are of the same image, differing only in scale. The smallest representation corresponds to Band (or outline) 4 on the calibration devices illustrated in earlier figures. The rate of increase in the size of the representations is 20 percent compound. There are seven sizes in all, denominated 4 to 10, and the set fits comfortably into an A4 (210 mm by 297 mm) format. The figure is reproduced here at 40 percent of scale. The headwear is designed to be used with center facing target images. It is similar to that shown at FIGS. 8 to 10 and can also be seen in a number of illustrations of calibration devices.

FIG. 36 shows at 100 percent of scale a detail from the picture shown at FIG. 34.

Superimposed on the head is the outline corresponding to center facing head size No. 5 and over the outline the related applied image No. 5. (Henceforth bands, rather than outlines, will be featured in the drawings.) The oval eared headband design in its center facing form adapts itself well to most target images because it can be moved upwards and downwards within a limited range with out lessening the realism of the representation. Many other designs are less forgiving.

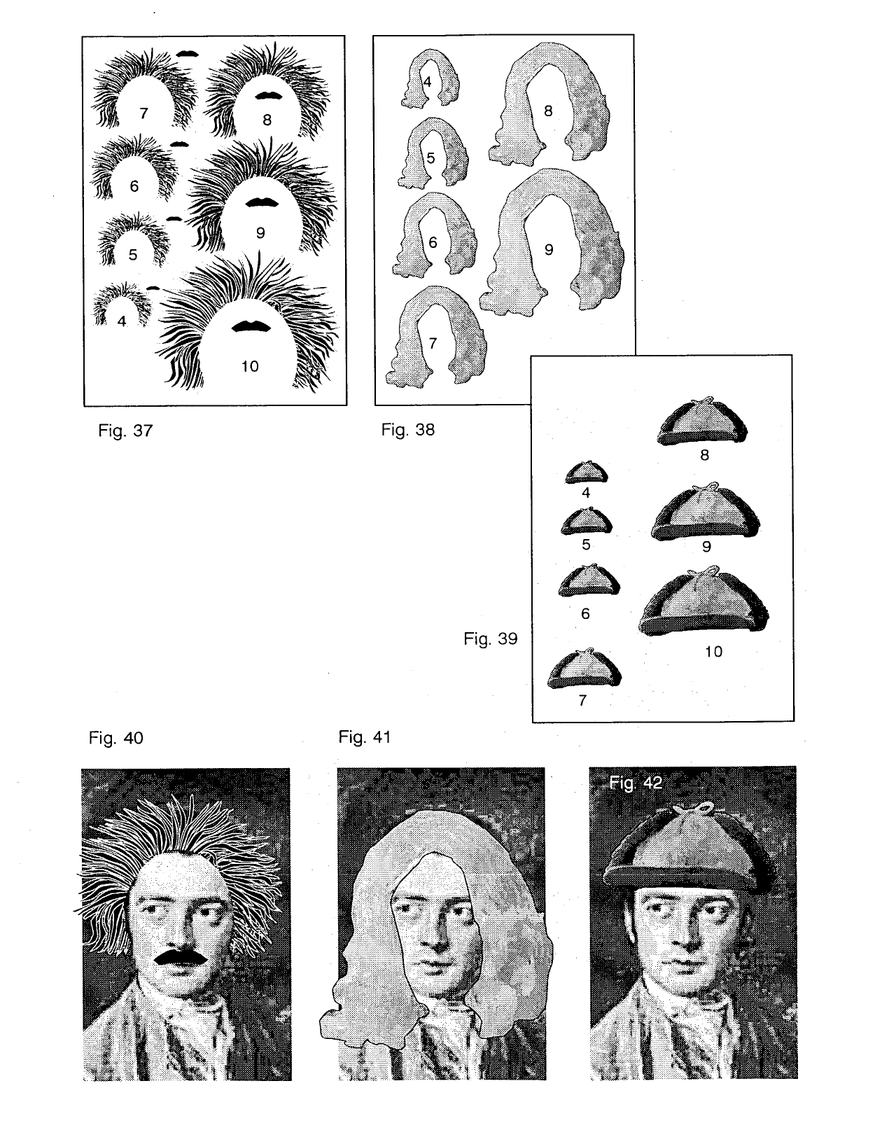

FIGS. 37 to 42 perform the same exercise with three groups of center facing non-dedicated applied image designs arranged in sets numbered 4 to 10 in the case of FIGS. 37 and 39 and 4 to 9 in the case of FIG. 38. In the latter instance the applied image No. 10 would not fit into the A4 format. Reproduction of these three sets of applied images is at 30 percent of scale.

The set of images depicted at FIG. 37 are taken from a portrait of Prof. Einstein and comprise representations of both his hair and his moustache. The latter is provided as a separate item to be positioned independently of the hair according to the features of the target image. The applied images shown in FIG. 38 comprise another hairstyle (based on a shop display wig) and those in FIG. 39 are a representation of a peaked hat with flaps, the flaps in this instance tied together over the top.

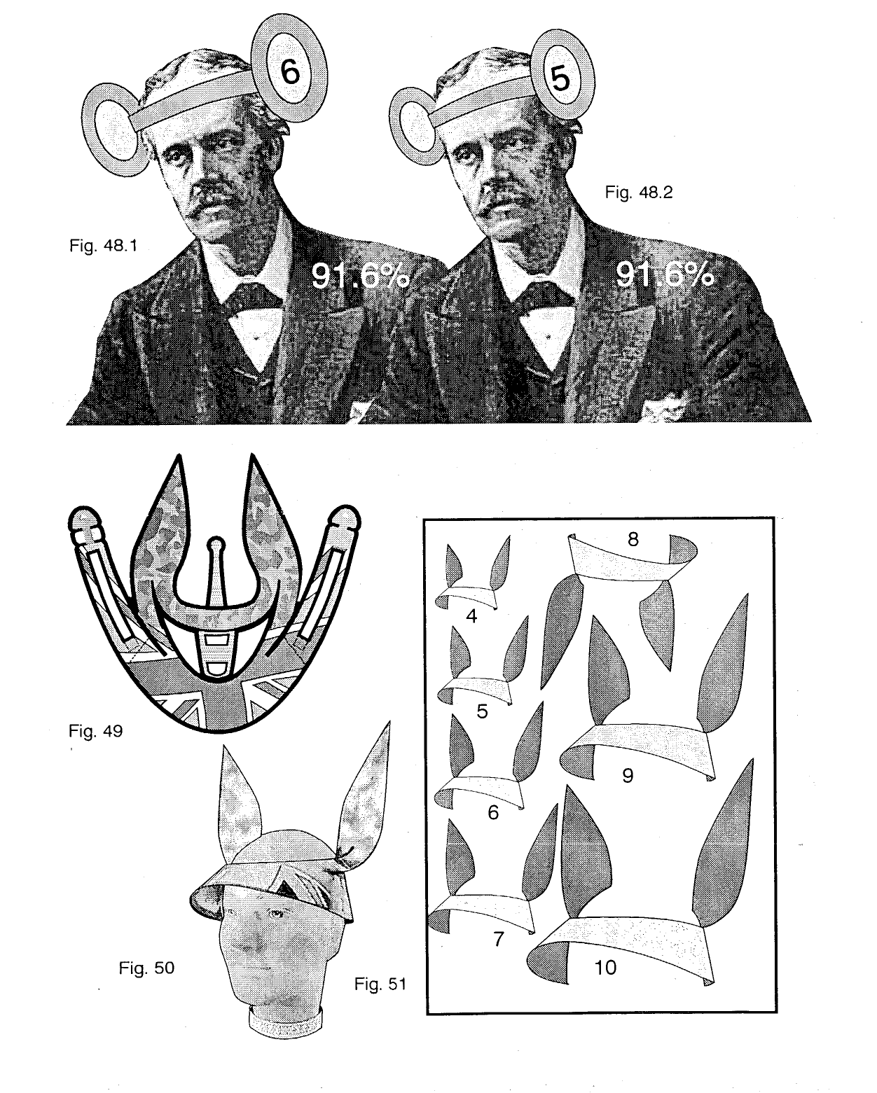

FIGS. 40, 41 and 42 show the applied images relative to head size No. 5 in position on the same target image as was featured on the preceding page. The scale of reproduction on the page is again 100 percent. It will be observed that, except in the case of the hat, the applied images do not fit the target images perfectly. The lack of perfection is a product, inter alia, of the size of the percentage increases between the head sizes represented in the sets of applied images. These percentage increases correspond to those found in the calibration devices (120 percent compound). The implications of limiting the number of steps in what is in effect a trade-off between user choice on the one hand and cost and convenience on the other are further examined below at FIGS. 48 to 64 and 79 to 82.

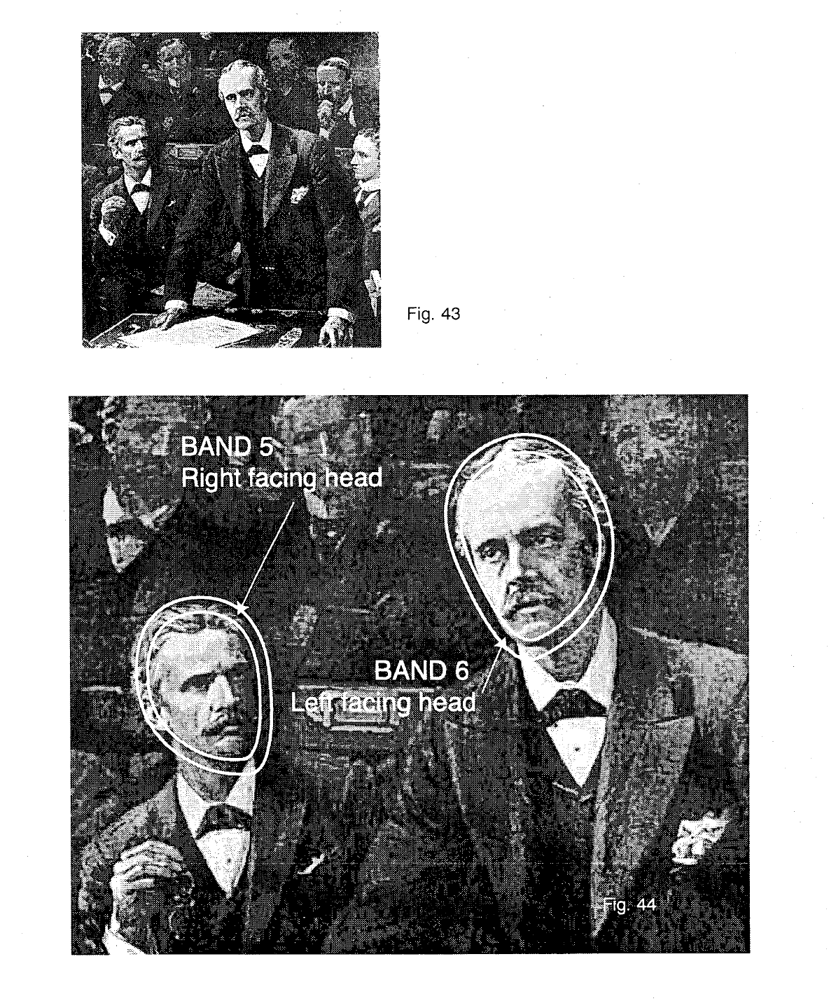

FIG. 43 shows a Victorian parliamentary scene reproduced on the page at one-third scale. A detail from the drawing is shown at FIG. 44 at 100 percent of scale. On this second drawing the respective outlines of Band 5 and Band 6 have been reproduced on the principal figures, that provide the target images. It will be observed that the left hand target image comprises a right facing head the size of which approximately corresponds to Band 5 and the right hand target image comprises a left facing head which corresponds to Band 6. The Band 5 head shows a somewhat greater degree of rotation than the Band 6 head.

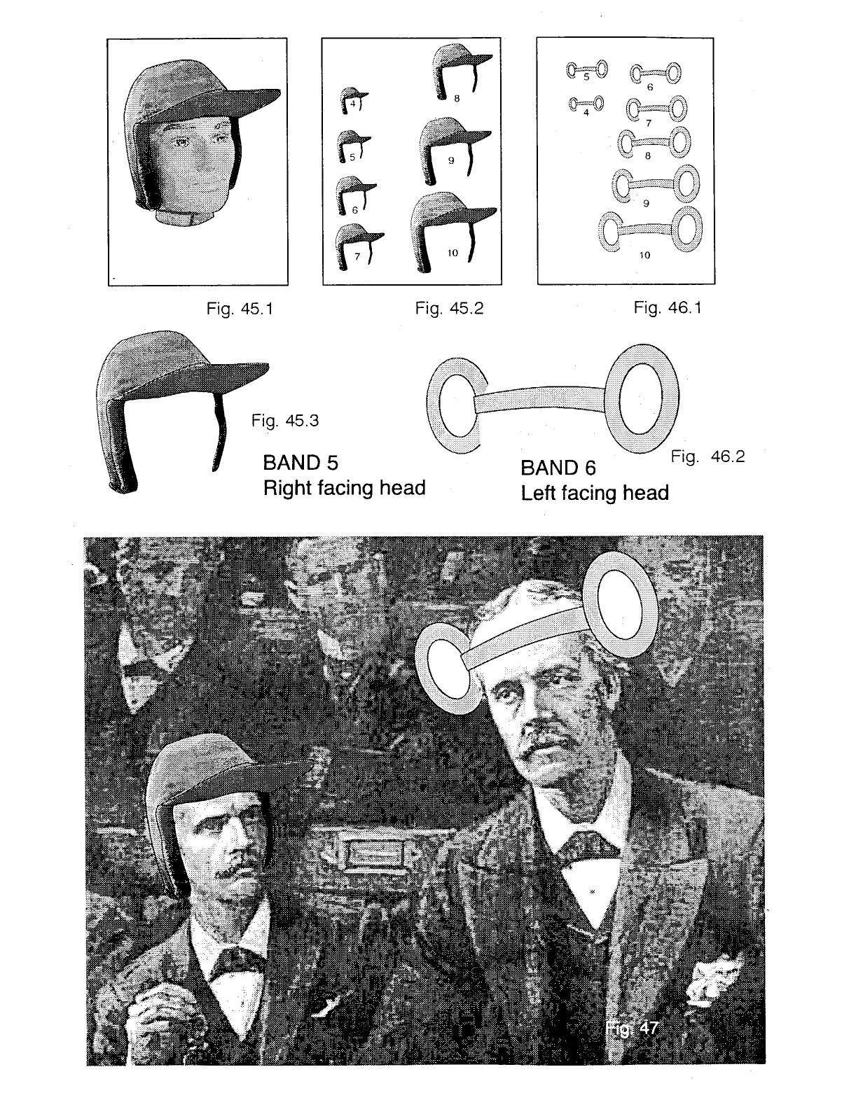

FIG. 45.1 shows the flapped hat headwear style selected for the left-hand figure.

The user is supplied with a set of seven applied images appropriated to a right facing head differing only in scale. A thumb nail picture of how an applied image appears when worn would be a useful addition to a set of such images wherever space allows.

The set of images from which the user chooses is shown at FIG. 45.2. The format as before is A4 and the scale of reproduction on the page is 20 percent.

FIG. 45.3 shows the applied image appropriate to Band 4 at 100 percent of scale.

FIGS. 46.1 and 46.2 show the left facing version of the eared headwear seen earlier in its center facing form in FIG. 35, the scale of the reproductions being respectively 20 percent and 100 percent. It will be noted that the artwork here is bounded by a black line, comic art style, but that the black line is discontinued along that edge of the applied image that marks the point where the depicted headwear would (when actually worn) disappear out of view behind the head.

FIG. 47 shows the flapped hat and the oval eared headwear in position on the wearers' heads. In the case of the latter the match is not absolutely perfect by reason of the simplified line taken by the cut-round of the left ear that does not (and will rarely, if ever) exactly correspond to the left hand side of the wearer's face. In this example the effect of perspective can be seen clearly with the left-hand ear much smaller in size than the right hand ear and the headband progressively reducing in width along its length. The headband is slightly curved upwardly and is so delimited as to appear to disappear out of view around the brow of the wearer's head.

FIG. 48 demonstrates the latitude afforded by an applied image such as the oval eared design seen in the preceding FIG. 47. In the first drawing, FIG. 48.1, the target image is reproduced not at 100 percent of scale as in FIG. 47 but at 91.6 percent of scale. The same Band 6 oval eared headwear is nevertheless applied.

In the result it is over large for the target image but can be considered to be just within the bounds of what is acceptable. In the second drawing, FIG. 48.2, Band 5 headwear is applied to what may be thought better effect notwithstanding that, strictly speaking, the Band 5 size would be appropriate to a target image reproduced on the page at 83.3 percent of scale. Fashions in oval eared headwear may be presumed to be along the same lines as those appertaining to conventional headwear where for a given style some wearers prefer a relatively large shape and others a more compact shape. Such variations in taste were very evident when bowler hats were popular wear among office workers. It will often be the case, when the choice of applied image falls halfway between two sizes, that the applied image that is on the small side will be preferred to one that is overlarge. Decisions of this kind do not to be made regarding applied images that are dedicated to specific target images.

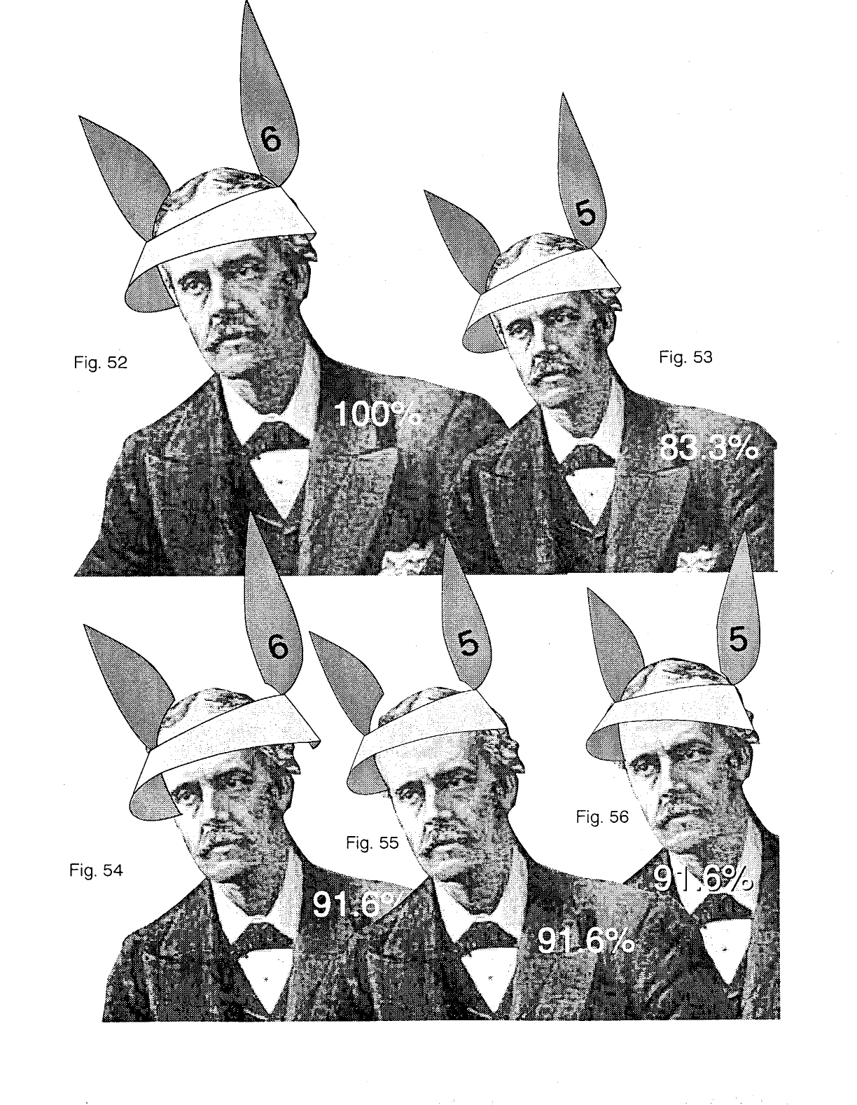

FIGS. 49 and 50 illustrate a known novelty hat design in which a single piece of flexible material, typically paper card of 300 gsm weight, is folded and slotted so as to produce an eared visor. FIG. 51 shows an A4 layout of left facing applied images in sizes 4 to 10. Such a design, in the context of the present invention, tends to be relatively less forgiving than other designs such as the oval eared headwear. In FIGS. 52 and 53 (where the size of the target image exactly corresponds to that of the applied image) a close to perfect fit is achieved. This is not the case in FIGS. 54 and 55 where the target image is reproduced at a scale that falls between two band steps. FIG. 56 shows, however, that it is often possible to get a better fit by rotating an applied image so that an item of headwear appears to be worn at a jaunty angle.

Applied images of the kind seen in FIG. 51, et al., require special die-cutting treatment due to the lack of adequate contiguous surfaces between the ears and the headband. Two solutions are available: The applied image can be subdivided into three separate elements to be positioned one at a time on the target image by the user. Alternative the applied image can be retained as a single image but printed on a transparent material.

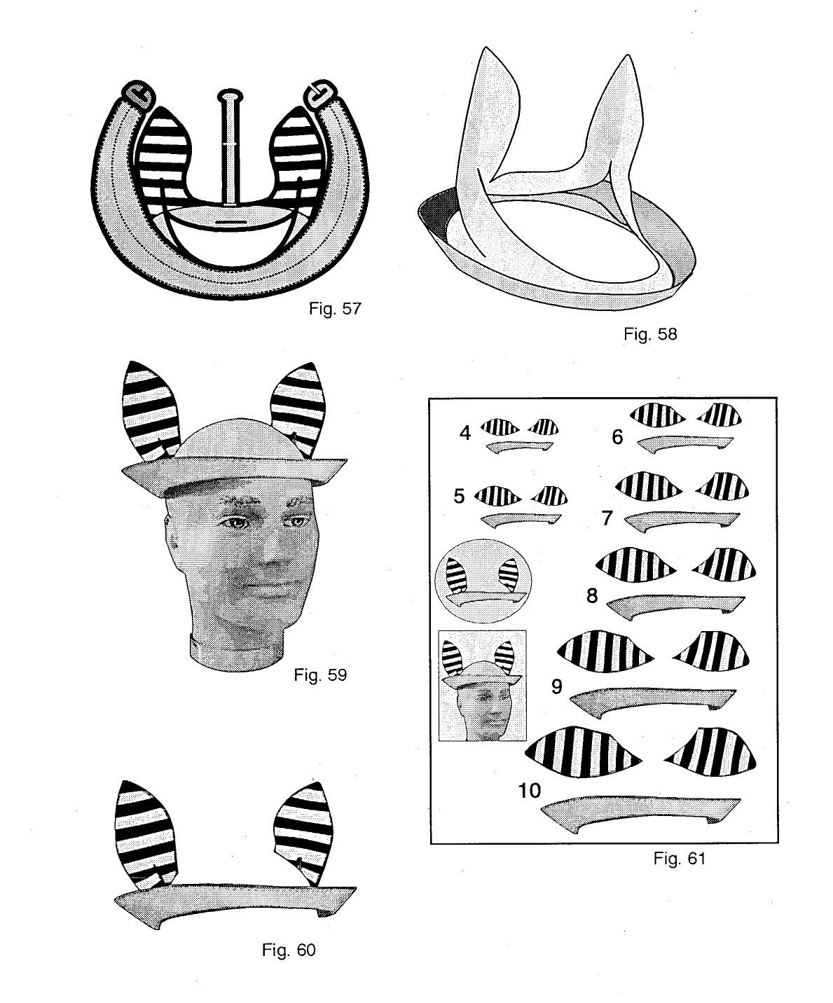

FIG. 57 shows another known item of novelty headwear comprising a topless brim to which are attached a pair of ears. The perspective view in FIG. 58 shows a similar item in the assembled state. FIG. 59 shows the headwear on the display head in a right facing attitude. In FIG. 60 the display head is masked to reveal the applied image. It is reproduced at 100 percent of scale, the size being Band 6. This, as we have seen, is appropriate to a FIG. 47 type target image.

The layout seen in FIG. 61 (reproduced at 40 percent of scale) serves two purposes. It subdivides the applied image into three separate components (the first of the solutions described above) and it economizes in space. In this situation, however, the provision of an illustration showing the end result on the same sheet as the applied images is not only desirable but also essential.

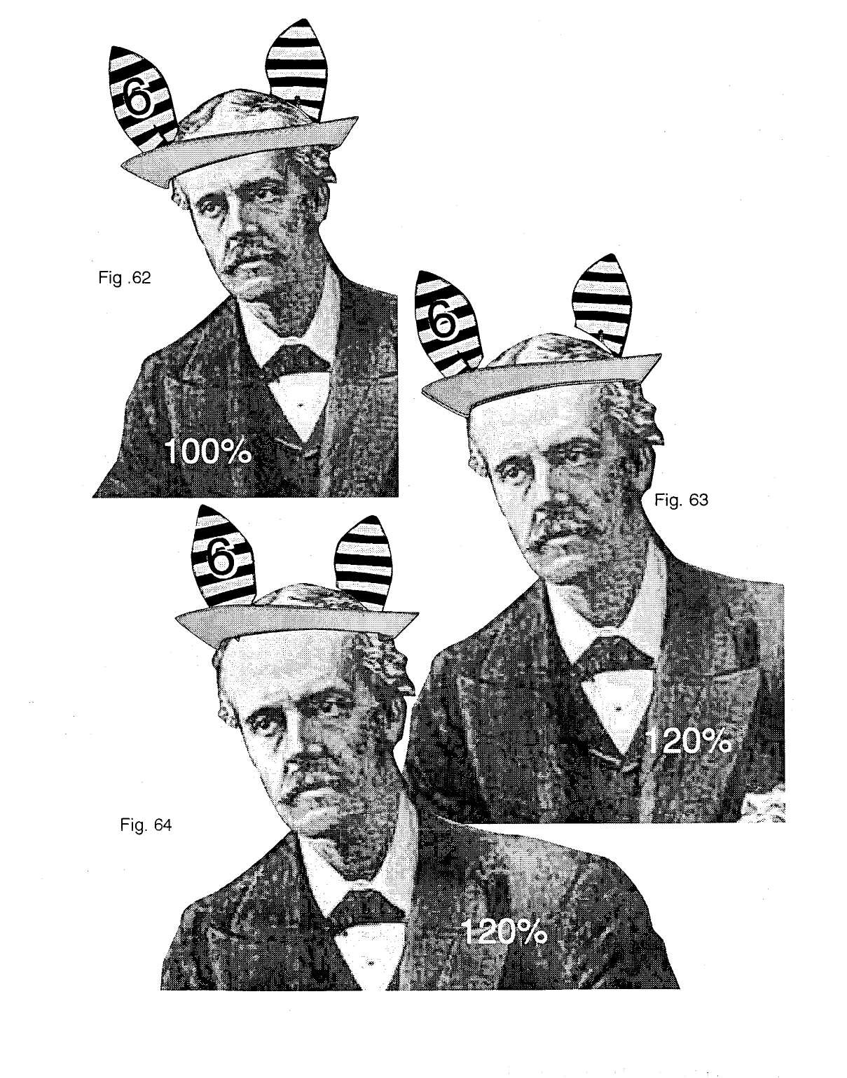

FIG. 62 demonstrates the effect of applying the Band 6 image illustrated in FIG. 60 to the FIG. 47 target image. As might be expected, there is a good fit. In FIGS. 63 and 64, however, the target image is enlarged by 20 percent to a size that corresponds to Band 7, the applied image remaining at Band 6. In FIG. 63 the applied image is exactly as it appears in FIG. 60. The brim can be comfortably accommodated by positioning it at a higher point on the head but the ears hardly make contact. In FIG. 64 the ears are individually aligned with the top of the head of the target image, a realistic effect being achieved.

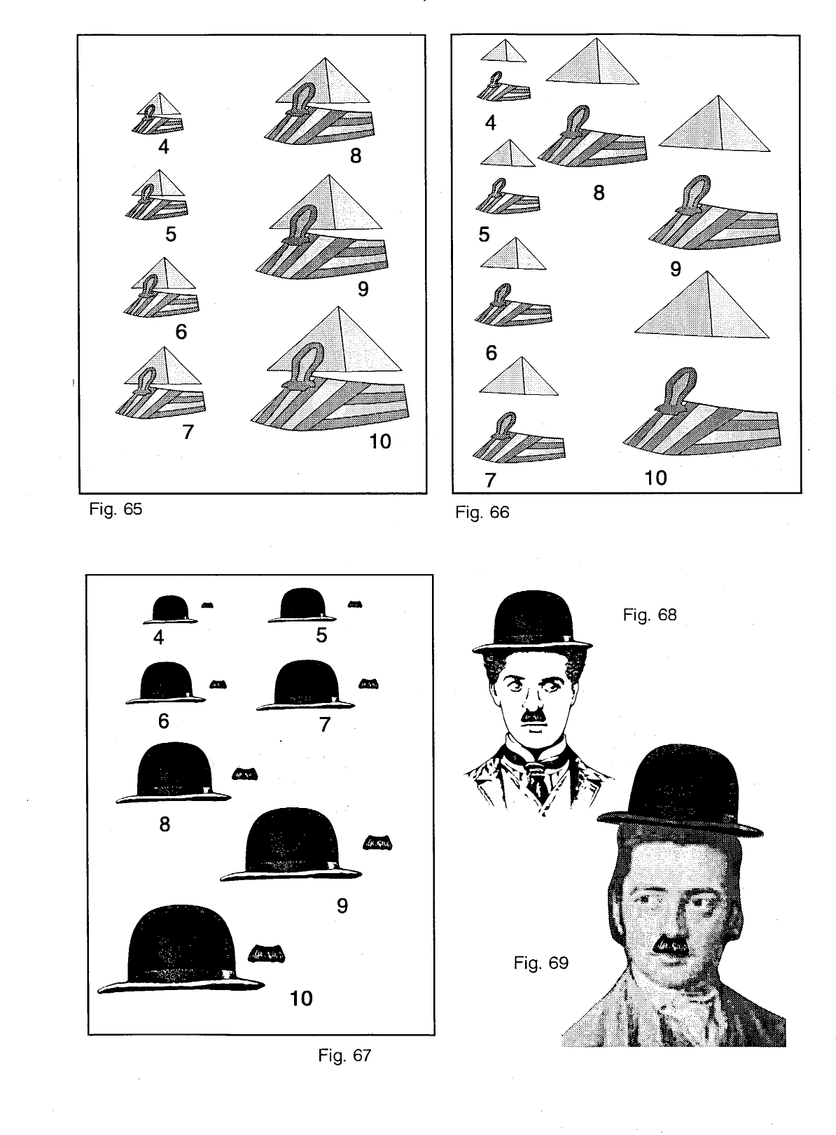

FIGS. 65 and 66 show how an applied image comprising a pyramid hat, similar to that seen at FIGS. 11 and 12 above, can be subdivided into two elements.

respectively comprising a bowler hat and a moustache, the inspiration coming from the famous comedian Mr. Charles Chaplin, pictured in FIG. 68. The bowler hat and the moustache will always have to be applied separately (in the case of non-dedicated applied images) because differing facial characteristics do not permit otherwise. In. FIG. 69 the Band 6 bowler and moustache are seen in position on the Thomas Gainsborough figure, reproduced to the same 100 percent of scale present in earlier drawings. It will be noted that the system of calibration correctly identifies the appropriate size of bowler hat required to obtain the Chaplin effect.

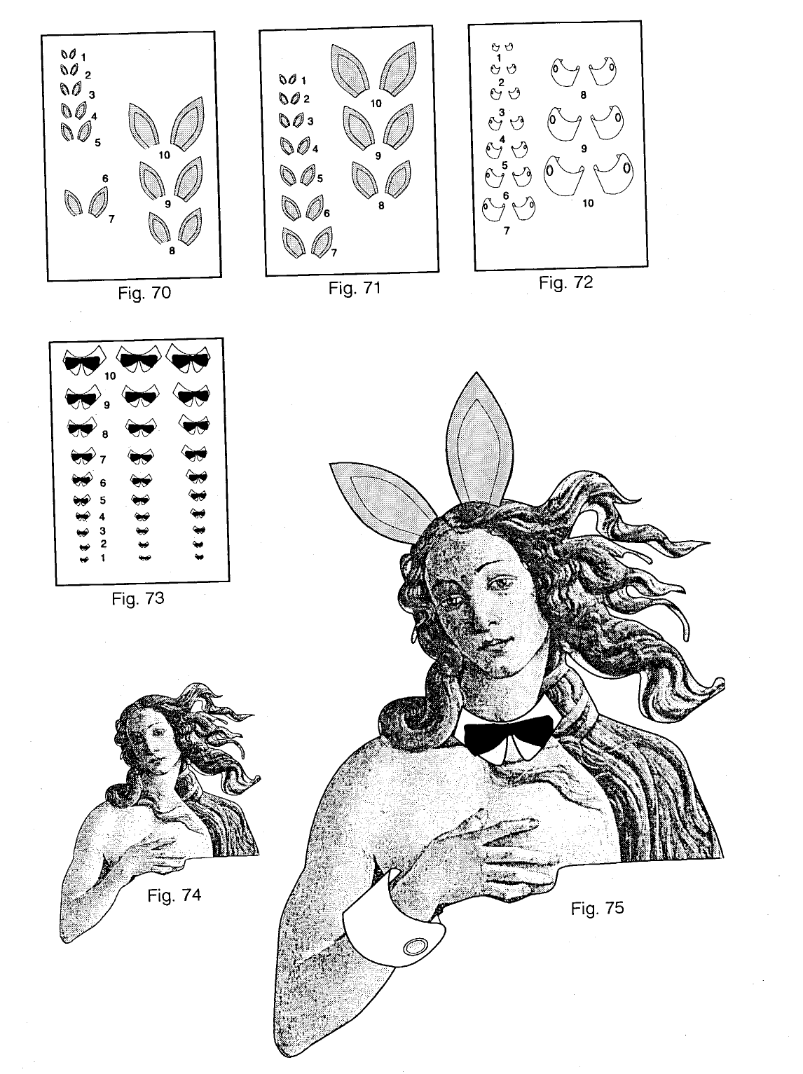

FIGS. 70 to 73 show sets of applied images along the lines of the uniform worn by Bunny Girls that is made up of a pair of ears, a collar and bow tie, and a pair of cuffs. As with the bowler hat and moustache described in the preceding paragraph these elements must be applied separately with the exception of the ears that may be retained as a pair. FIGS. 70 and 71 show sets of left facing and center facing ears. FIG. 72 shows a set of cuffs that are multi-directional and FIG. 73 shows left facing, center facing and right facing collars and ties. Right facing ears are not shown but could, if desired, be provided in the same range of sizes and split between the other ear sets. These items are relatively small and it has been possible therefor to provide applied images for Bands 1 to 3 in addition to those for Bands 4 to 10.

In the scheme of things it would be useful to provide a limited selection of lower Band size items provided that the calibration device is configured accordingly—as is the case with those devices illustrated at FIGS. 21 to 26.

FIG. 74 shows a detail from The Birth of Venus by Botticelli. The artist's model has long been regarded as the epitome of sexual attractiveness and opinions will be divided as to whether the addition of Bunny accoutrements, as seen in FIG. 75, adds anything to the lady's charms. FIG. 75 does, however, have one useful point to make. The head of Venus is clearly left facing, but her body is center facing, dictating a like choice of collar and tie. Just as eyes may be looking in one direction and the head pointing in another, a body is apt to go in its own direction.

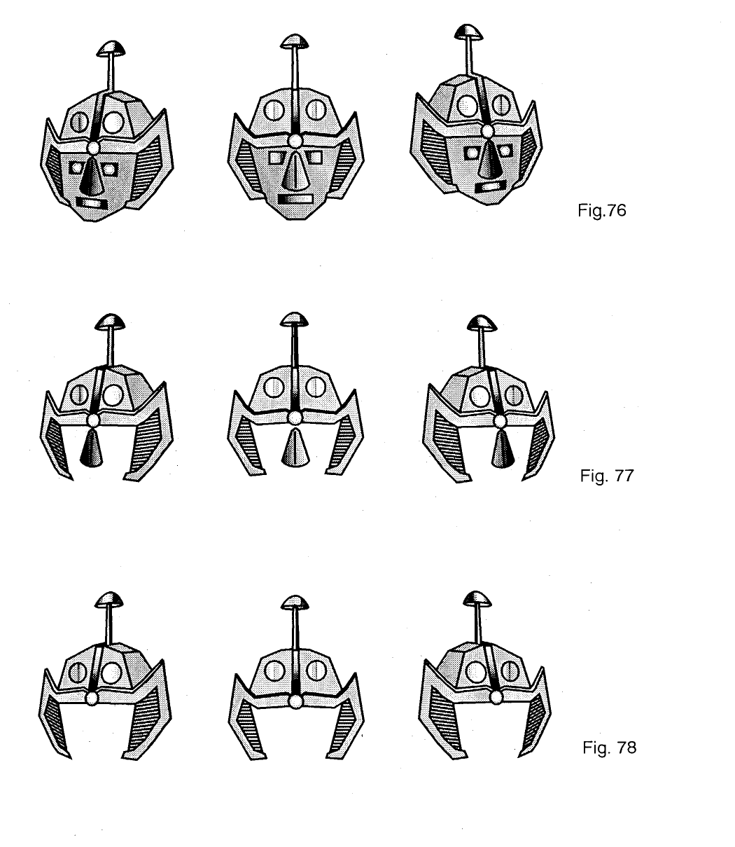

FIGS. 76 to 82 show robot (or humanoid) style applied images in left, right and center facing attitudes. In FIG. 76 the head of the target image will be fully covered. In FIG. 77 the coverage is partial but will include a replacement nose.

In FIG. 78 most of the facial features of the target image remain in view.

FIGS. 79 to 82 demonstrate that applied images of the kind described in the preceding paragraph are able to cope well with variations in target image size.

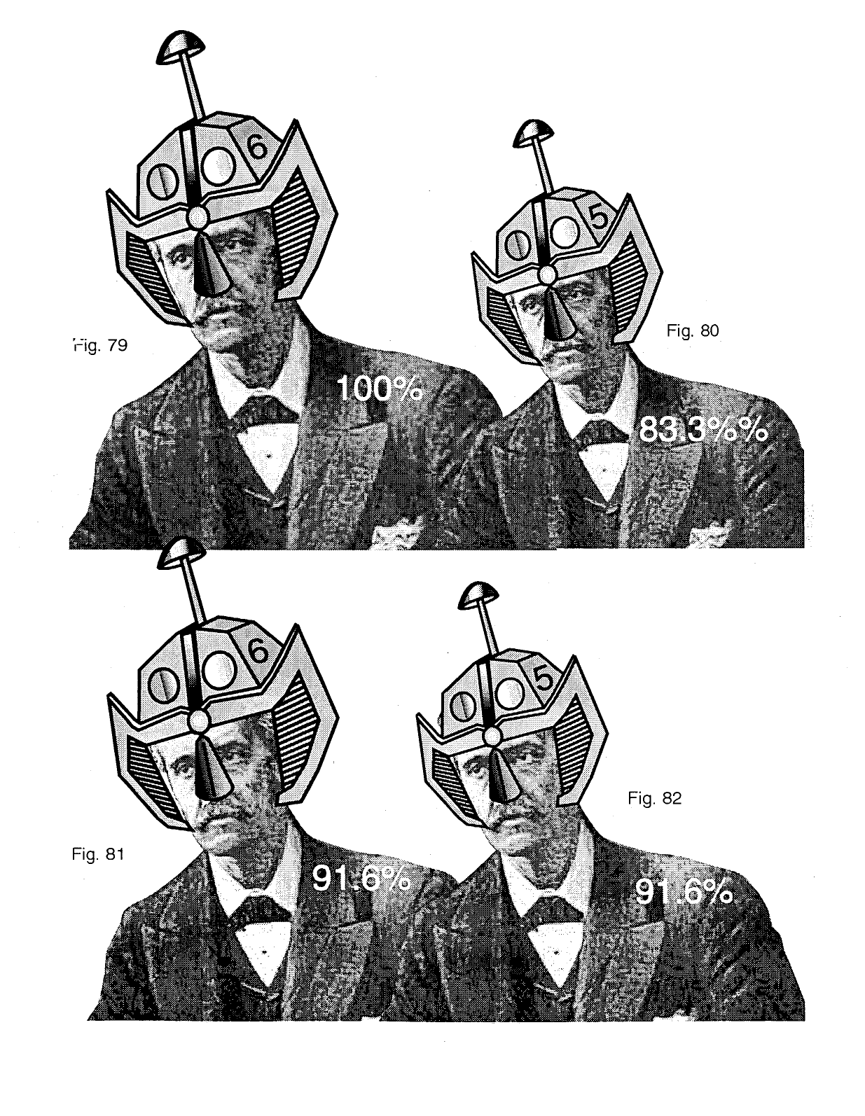

FIGS. 79 and 80 show Band 6 and Band 5 applied robot images on appropriately sized target images. FIGS. 81 and 82 show that both sizes of applied image are, moreover, able to accommodate a target image the size of which lies between the two bands. Applied images will often have the advantage of being fantasy creations for which there is no precedent in life. Thus the normal rules of taste, convenience and usefulness that govern what is oversize and what is undersize do not apply. A problem that designers of applied images in accordance with the present invention are more likely to encounter is that caused by the large hair arrangements and hats that will sometimes be found in target images, and that can not be completely obscured by non-dedicated applied images.

Botticelli's Venus (FIG. 74, above) with her hair streaming in the sea breeze presents insuperable problems for many (but as we have seen, not all) non-dedicated applied images.

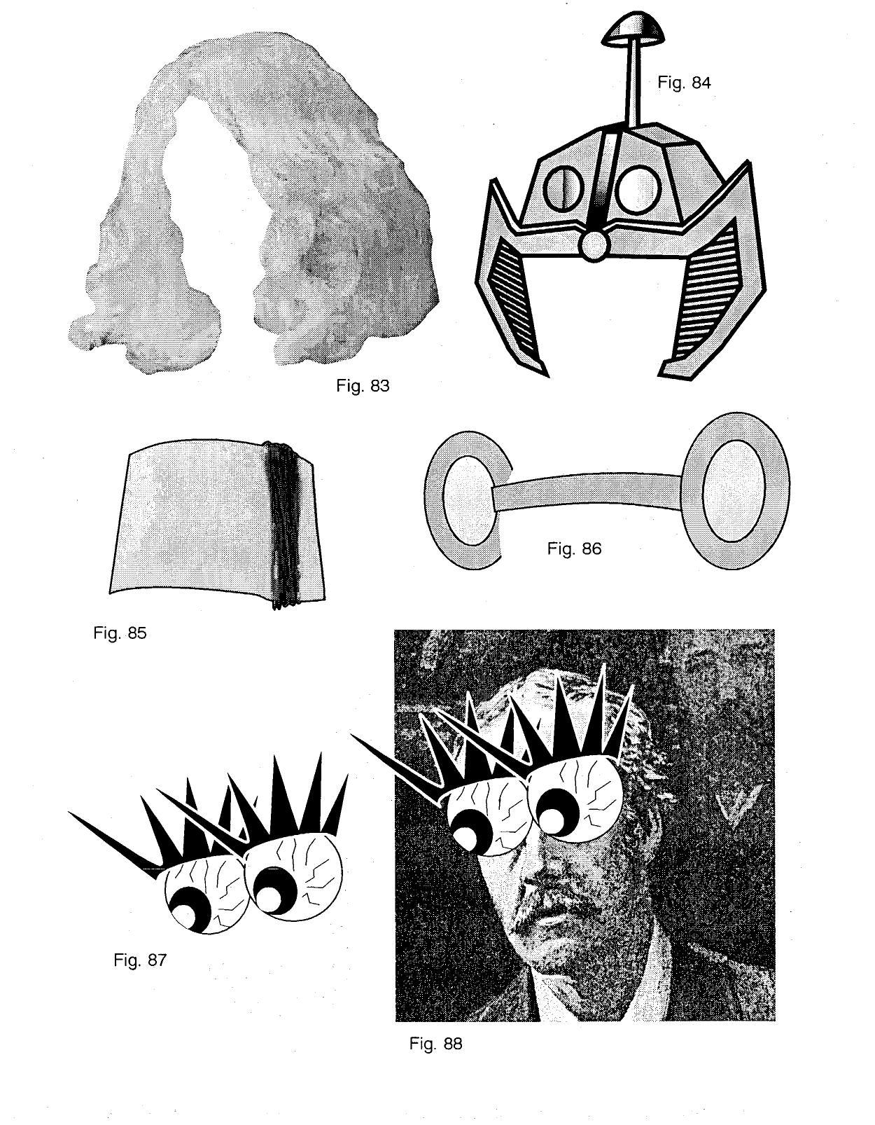

FIGS. 83 to 87 are life size representations of applied images in accordance with the invention in the form of refrigerator door magnets (“fridge magnets”). It can be assumed that most applied images will be attached to target images that appear in magazines. From time to time such pictures may be cut out of a magazine and displayed on the metal door of a refrigerator utilizing a decorative magnetic attachment device to secure them in position. The novelty of the items illustrated in FIGS. 84 to 87 lies in the fact that they are adapted to co-operate with the imagery of a picture depicting a head of some kind (the target image) and give the impression of forming part of it, at the same time adding an element of relief from the flat plane. As with the general run of applied images, magnet type applied images will fall into two categories, dedicated and non-dedicated. In the non-dedicated category users will have a plurality of magnets bearing the same image but differing in scale from which to make a choice. The average size of applied images incorporated into fridge magnets is likely to be greater than is the case with other types of applied image, both in order to accommodate the magnet and to secure a decorative presence on the door of the refrigerator. A similar configuration can be employed for mounting applied images on to such items as office notice boards where a pin replaces the magnet.

The five examples illustrated are appropriate to Band 8. FIG. 83 is a left facing version of the center facing hairstyle seen at FIG. 41 above. The FIG. 84 robot head is similar to that which appears in FIG. 78. The fez and eyeballs have not be seen before.

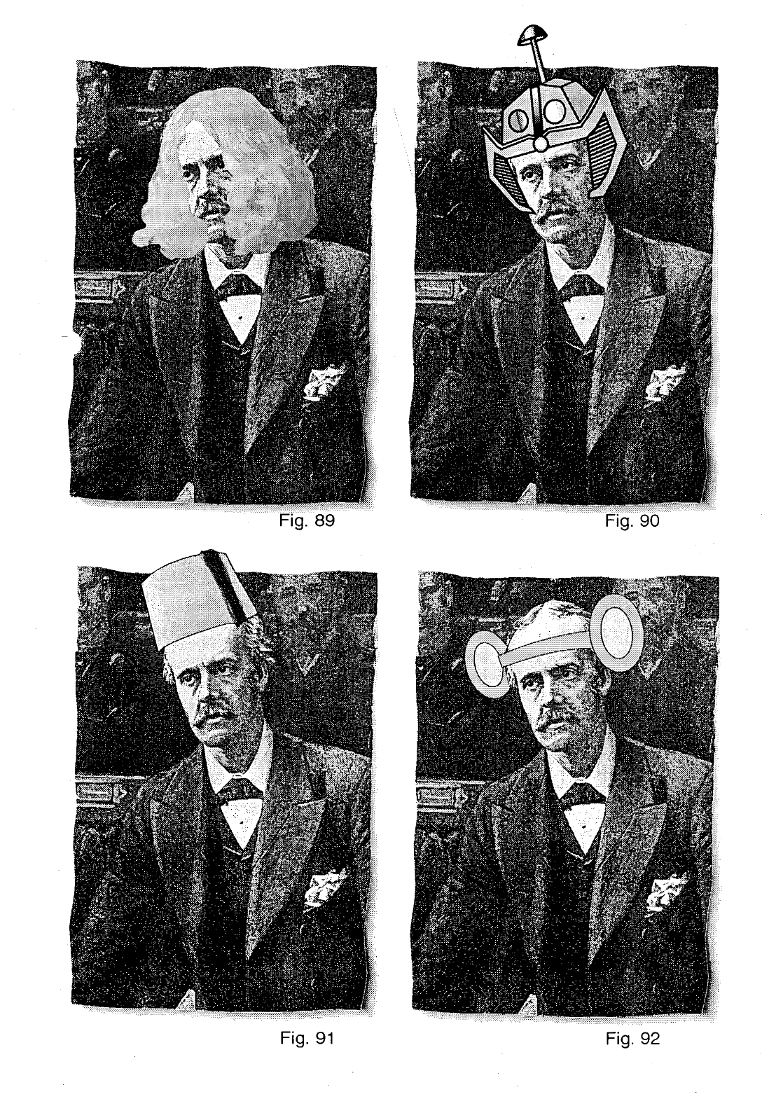

FIG. 88 shows in close-up detail an eyeball fridge magnet in position over a Band 8 head reproduced at 100 percent of scale. FIGS. 89 to 92 show the other four fridge magnets as they might appear in position on a cutting taken from a magazine, the reproduction on the page being at 40 percent of scale.

The popularity of fridge magnets and pins in accordance with invention will doubtless depend upon the extent to which self-adhesive embodiments of the invention are able to achieve iconic status so that members of the public will wish to incorporate them into their domestic environment.

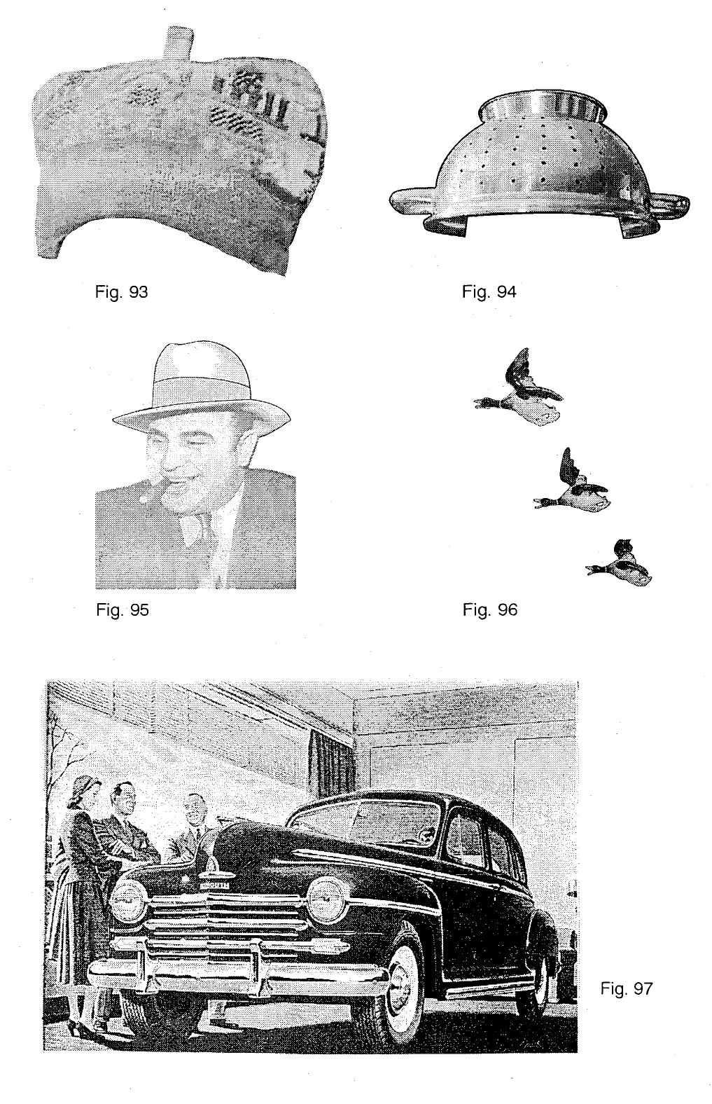

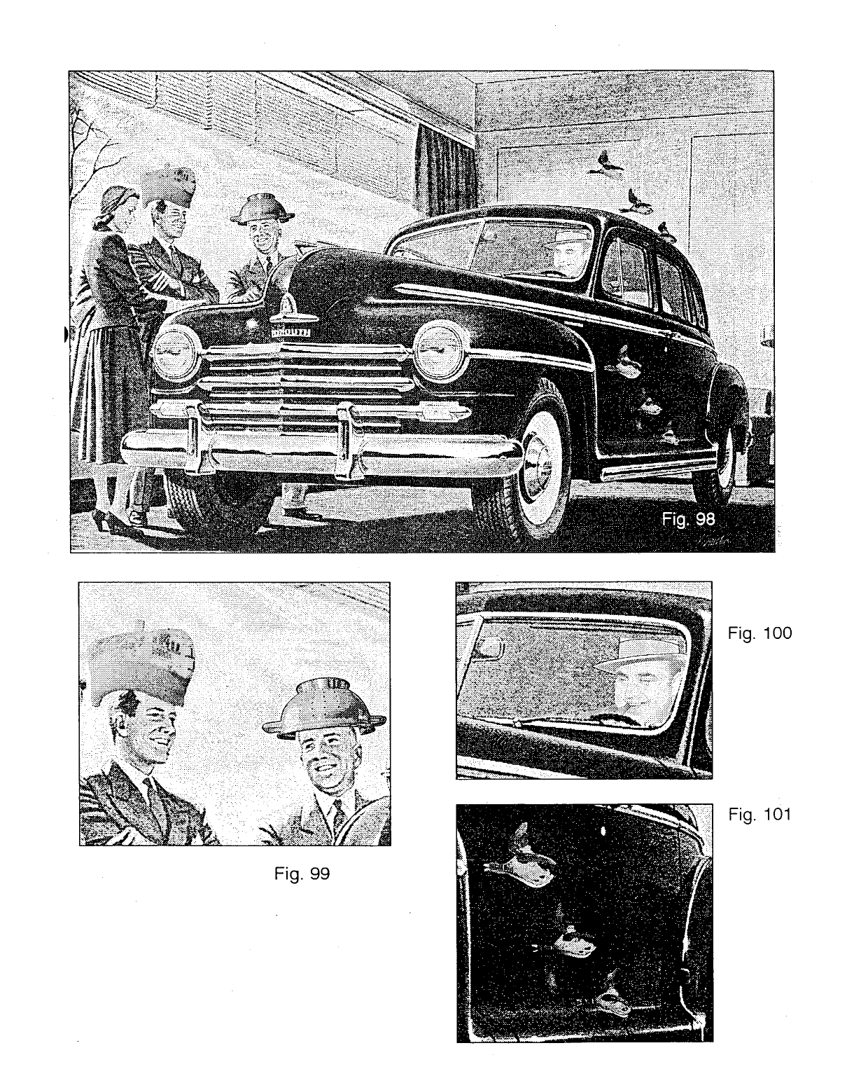

FIGS. 93 to 101 demonstrate how a singe embodiment can embrace both the fourth and fifth aspects of the present invention at the same time. The applied images illustrated in FIGS. 93, 94 and 95, respectively a tea cosy, a colander and the late Mr. Al Capone of Chicago, are in accordance with the fourth aspect. The tea cosy and the colander are (as will become apparent) items of headwear and Mr. Capone combines both facial features and an item of headwear in a single image. The three flying ducks, illustrated at FIG. 96, are by contrast adapted for use with a target image that depicts the interior architecture and furnishings of a motor car showroom, the car itself comprising an inanimate object. The target images conforming to the fourth aspect of the invention are the two men and the little girl in the driving seat of the car. The target images conforming to the fifth aspect of the invention are the rear wall of the show room and the driver's side door panel.

FIGS. 93 to 101 also demonstrate how both non-dedicated and dedicated applied images might be present in the same embodiment. The Tea Cosy (right facing) and colander (center facing) could be either non-dedicated or dedicated. In their non-dedicate form both images are particularly useful having no problems with ears and being relatively non-directional and possessed of sufficient bulk to accommodate the larger hair styles. The Capone and duck images can only be provided in a dedicated form. The application of the Capone image requires substitution of a large part of the right hand side of the windscreen together with the door quarter light and fixing the size requires an exercise of artistic judgement, the little girl previously occupying the driving seat providing not very much to work on. The flying ducks require to be sized and perspective must be applied—little or none as regards those flying along the rear wall but a substantial amount on the door panel. This will be evident from the detailed view provided at FIG. 101. The flying ducks are of course an iconic image notable for its in-built perspective.

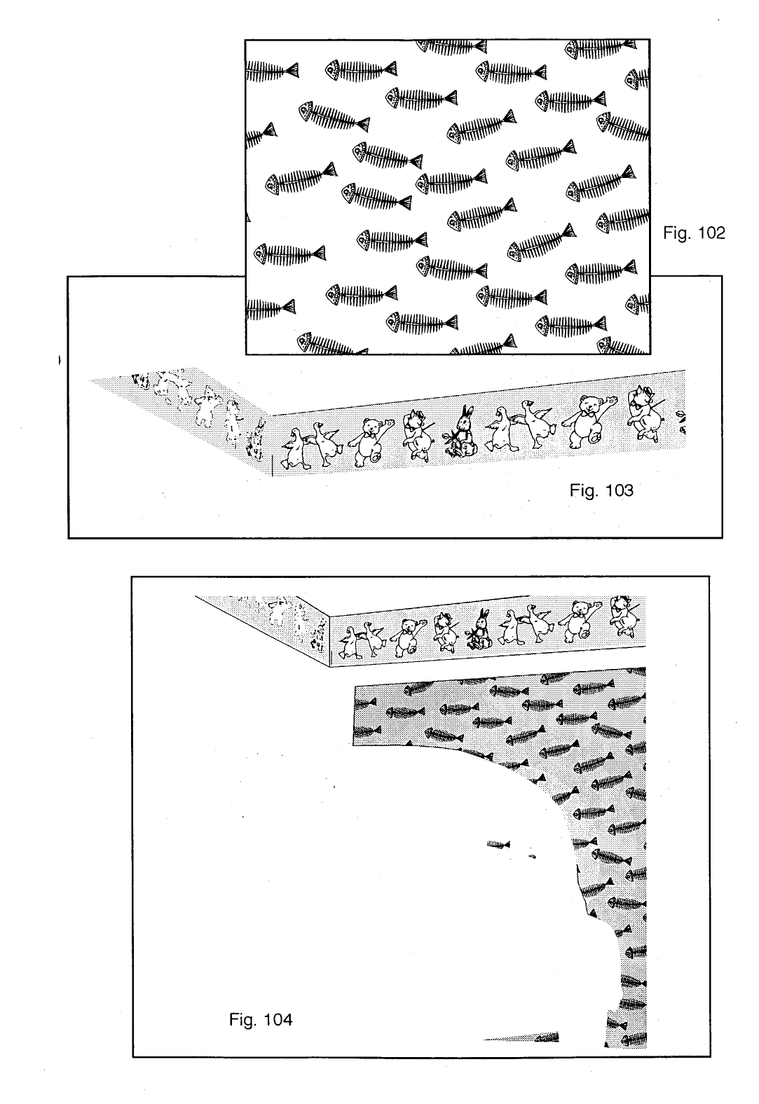

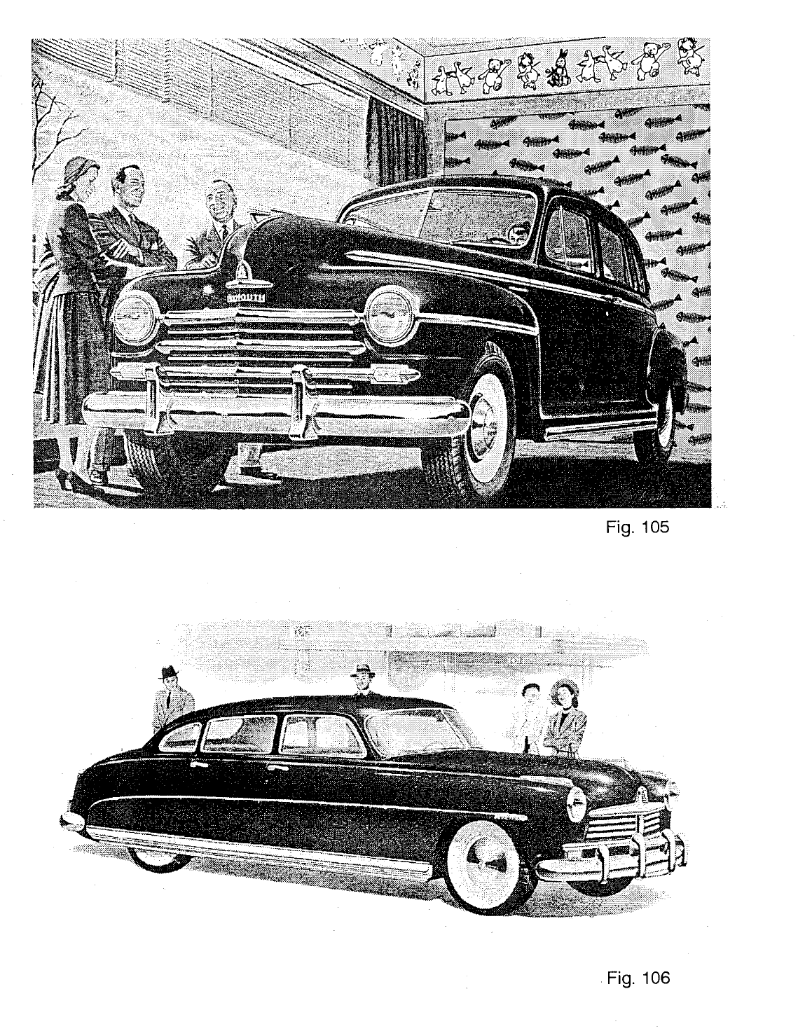

FIGS. 102 to 105 and 106 to 108 are illustrative of two further embodiments of the invention in accordance with its fifth aspect. For the same motor car showroom seen in the preceding figures a customized wallpaper and frieze have been created. Perspective has been applied to both wallpaper and frieze but is more noticeable with the latter.

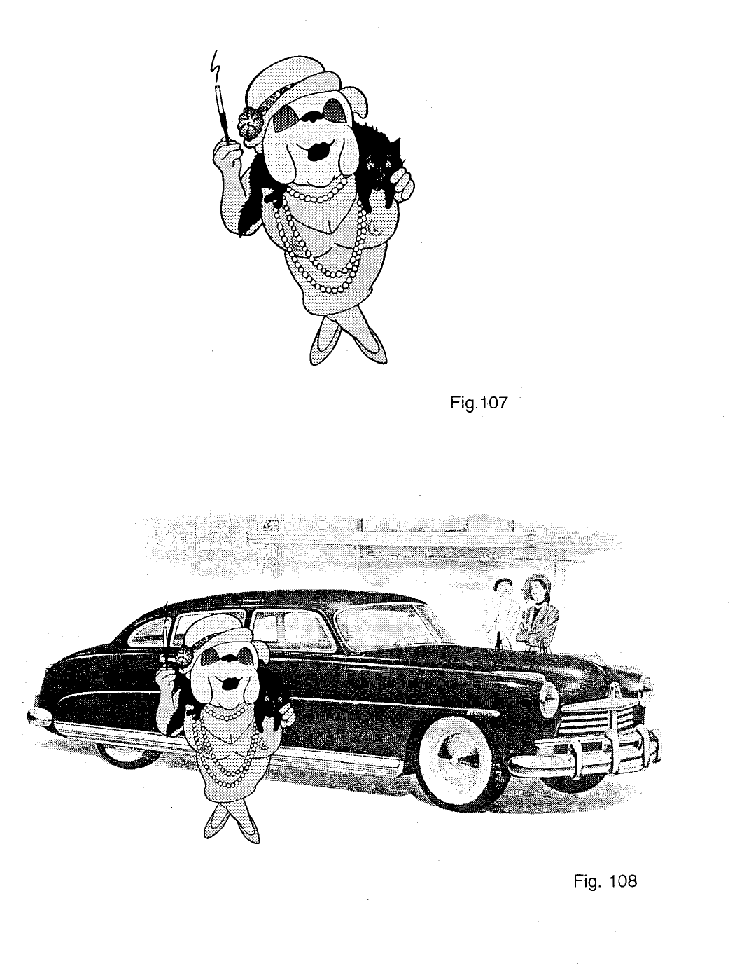

FIG. 106 is another motor showroom example, the target image comprising an inanimate object in the form of a motor car. The applied image, illustrated in FIG. 107, is distinctly animate.

Dedicated applied images in accordance with the fourth and fifth aspects of the invention will often have in common the fact that the respective target images are published in the course of a commercial enterprise that is unconnected with the provision of the respective applied images. A system of cross-reference, what might be termed a concordance, of the kind disclosed by the present invention is required to marry up applied images to target images.

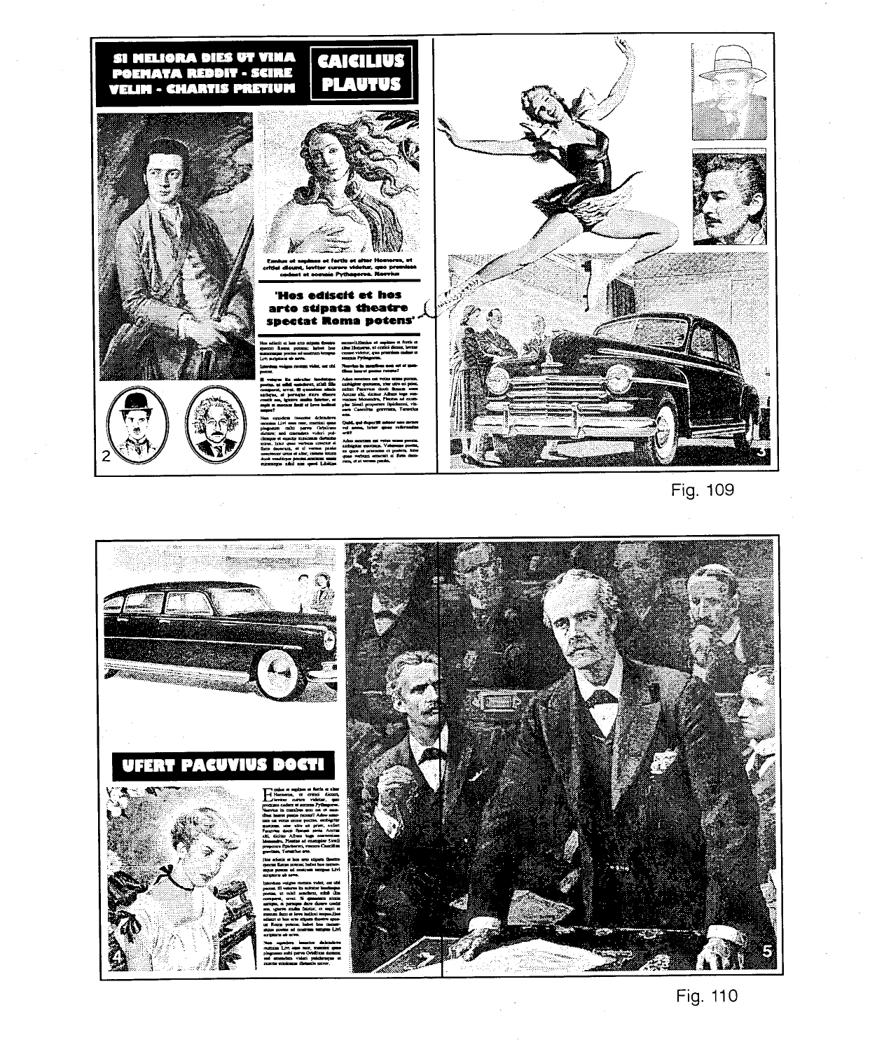

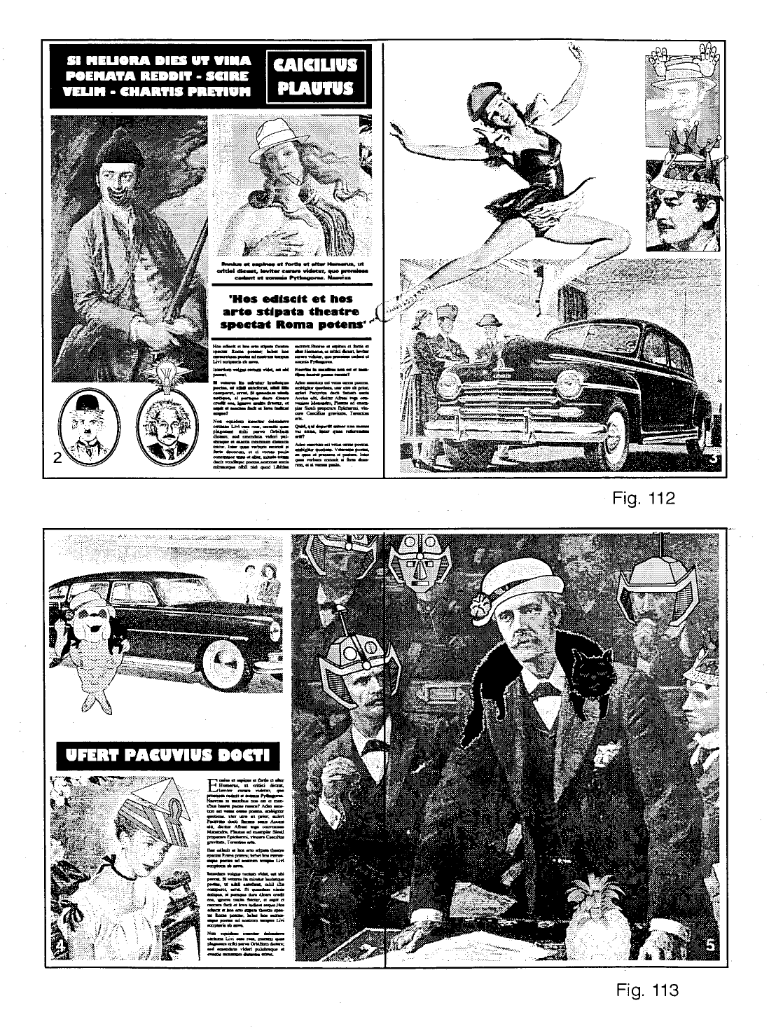

Typically the target images will be published in a newspaper or magazine or catalogue. FIGS. 109 and 110 each show a two two-page magazine spread in “dummy” form, pages 2 and 3 in FIG. 109 and pages 3 and 4 in FIG. 110. FIGS. 112 and 113 show the same two two-page spreads following the addition of a number of applied images the majority of which could equally be dedicated or non-dedicated. The notable exception is Botticelli's Birth of Venus to the subject of which has been applied Mr. Al Capone's hat and cigar (Mr. Capone appearing elsewhere on the page). To fit the hat over Venus's head the surrounding area has had to be cleared of much of the lady's hair. In the result the applied image comprises more than the hat. A single applied image incorporates both hat and cigar. the cigar by itself would occasion no difficulty.

Certain of the other images in FIGS. 112 and 113 have not previously appeared in the drawings. The Gainsborough gentleman is wearing a beanie hat and an applied image in the form of bared teeth has been placed over his face. Einstein has a light bulb, indicative of his genius and appropriate to a head. Mr. Capone is wearing an item of split headband headwear, similar to the oval eared design but replacing the oval shapes by waggly fingers, over his hat. It has been suggested that such items of novelty headwear may one day become de rigeuer for wear over conventional headwear. Mr. Errol Flynn is wearing another item of novelty headwear (the family name of which is “Brain Defender”) and a portion of the same design can be seen on the head of the right hand figure in the parliamentary scene below. The hat and cat stole, first seen in FIG. 107, is again being worn by the animal figure but has also been translated to the speaker at the despatch box. The last mentioned is now graced, it will be noted by a plastic pineapple style ice bucket and is an example of an embodiment of the invention in its fifth aspect.

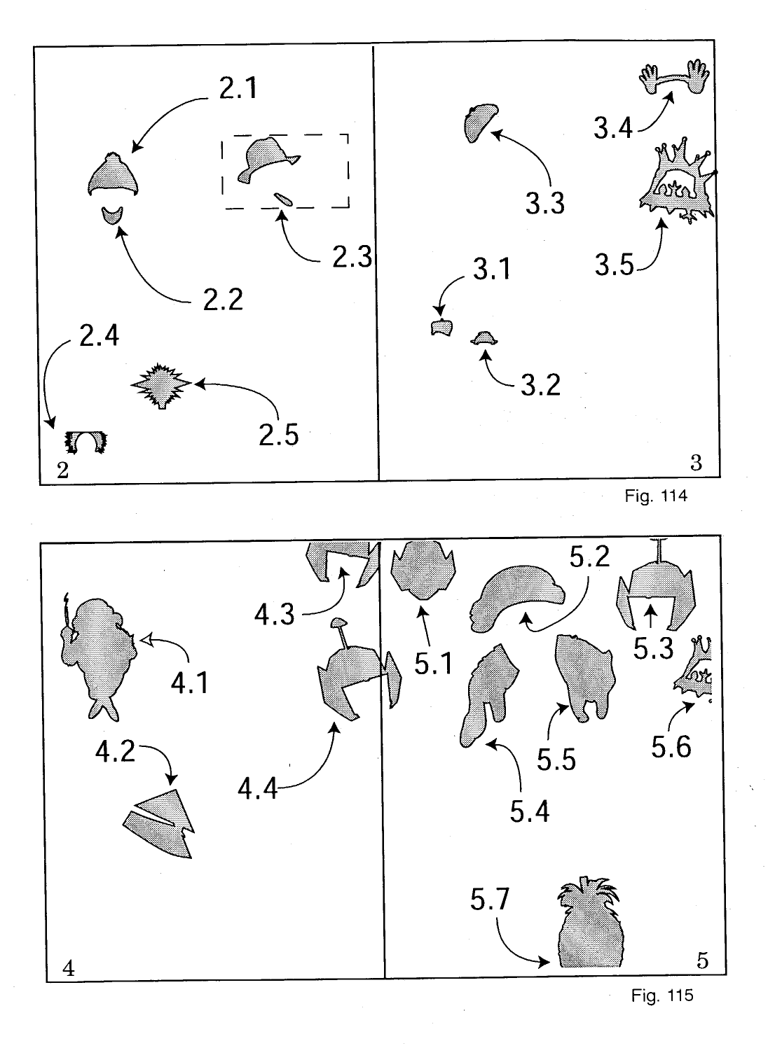

FIGS. 114 to 121 demonstrate the manner in which applied images are cross-referenced to target images so as to enable a user to match an applied image to the target image and the advantages that will flow if the applied images are reproduced on a transparent material. The figures take, by way of an example, the two two-page “dummy” spreads illustrated in the preceding figures.

FIGS. 114 and 115 show page plans based upon the dummy pages 2-3 and 4-5 illustrated in the preceding FIGS. 112 and 113. These page plans show in schematic form the positions on the respective pages in which it is suggested that the supplied applied images might be placed. The page numbers are a key source of reference appearing both in the corners of the plan view of the pages and as a component of the individual reference numbers. It can be argued that to show any more detail would be to deny to the user much of the pleasure of anticipation that the activity is capable of generating. These page plans can be reproduced in the literature accompanying the applied images in whatever size may be appropriate. The scale of reproduction is likely to be less than that seen in the figures since plan views of several pages may be required.

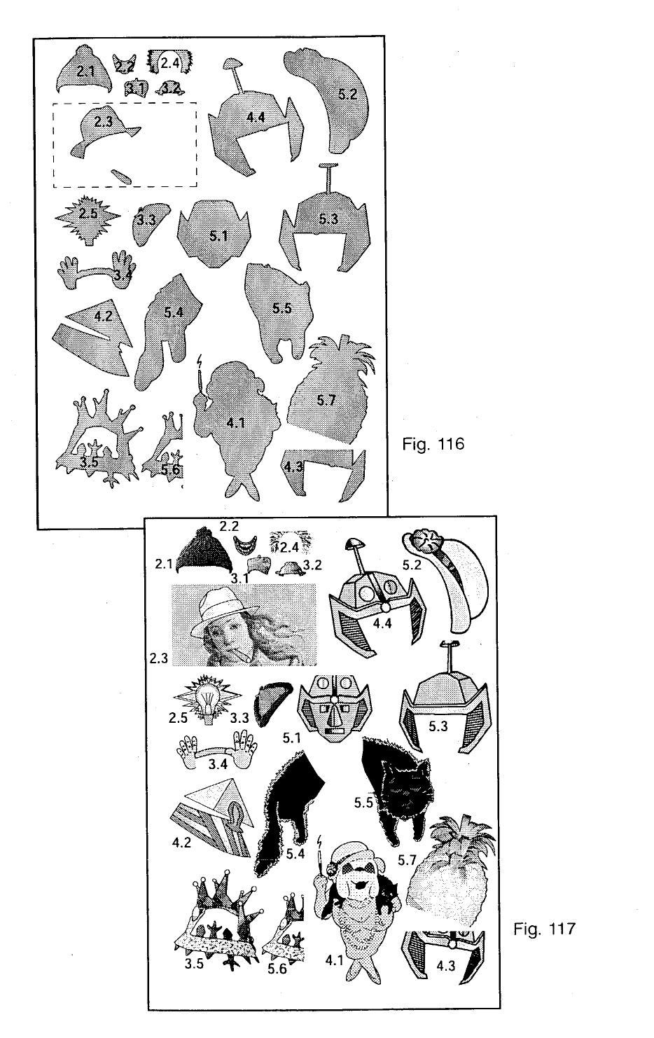

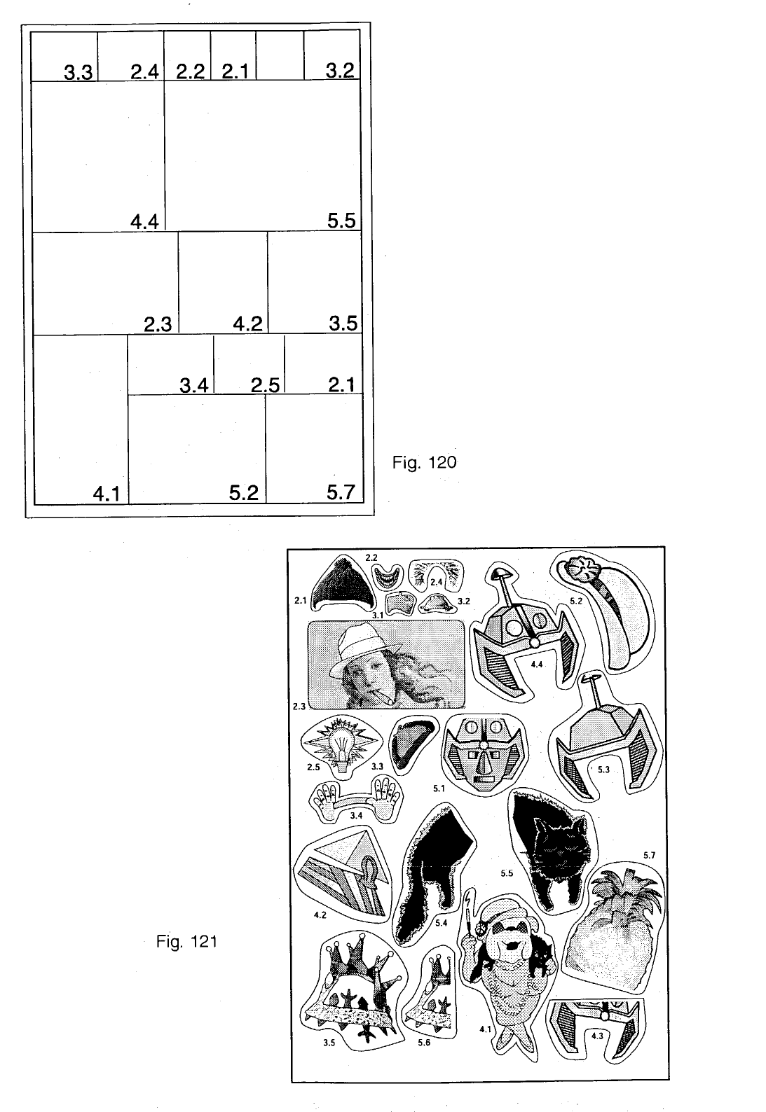

FIG. 116 shows an optional second reference stage in which such detail as appears in the page plans is related to the position of the applied images on their individual sheets. The presence of an applied image layout plan of this kind would obviate the necessity of providing reference numbers on or adjacent to the applied images themselves. Such a reference system might be considered a preferable alternative to clipping the corners as in the FIG. 119 embodiment below. The layout plan will also be a useful promotional tool, perhaps for display on the front cover, giving only an indication of what lies ahead for the user.

FIG. 117 shows a layout of the applied images required for the two two-page spreads on an A4 sheet of self-adhesive material. The reference numbers incorporating the page numbers on which the target images appear are shown beside each applied image. A user could, therefor work directly from the applied images to the actual page on which the target images appear, working out for himself or herself what applied image fits on what target image, referring only to the FIG. 114/115 page plans in case of need. The challenge would be similar to that of a crossword puzzle. The use of a re-positionable rather than a permanent adhesive in such circumstances would be helpful.

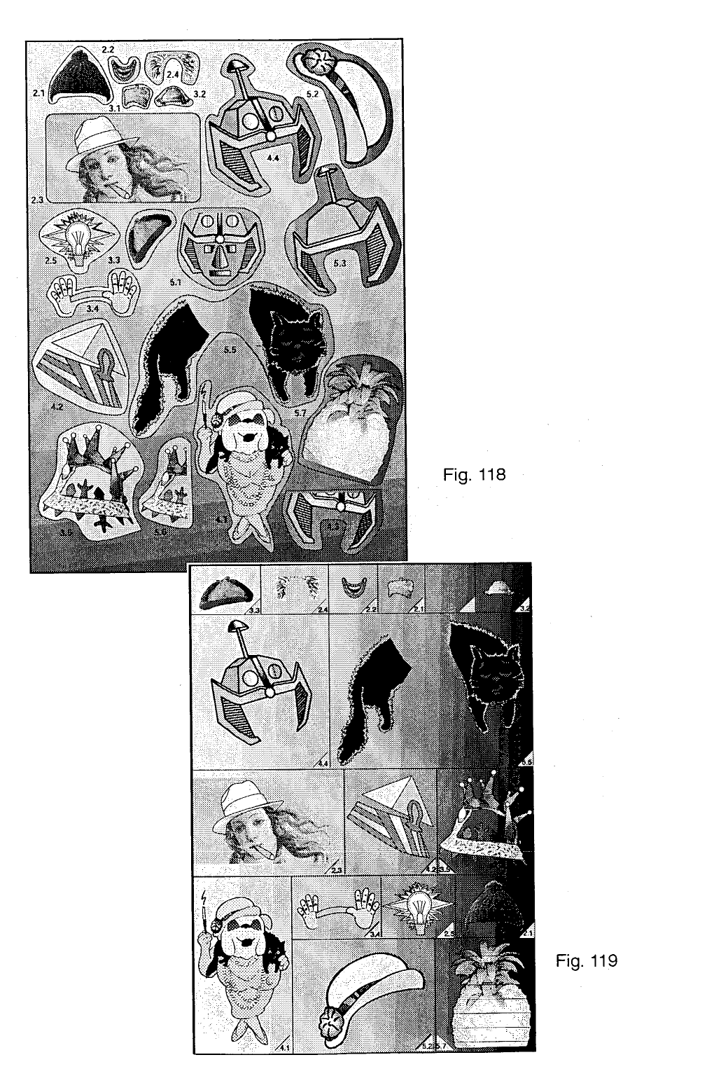

FIGS. 118 and 119 show two different ways of laying out applied images on to the obverse surface of a transparent material provided with a self-adhesive reverse surface. In both cases the images are able to be peeled off the backing sheet but in FIG. 118 the die-cut outline follows the shape of the applied image to a greater or lesser extent whereas in FIG. 119 the applied images are laid out on material divided up by straight lines into a geometric grid. Provided the applied images are produced on material with good properties of transparency the appearance of the applied image in the center of its square or oblong once in position over the target image may not be very different from that of images more closely defined by the cutter. An advantage of the grid system is the saving in time and money in making the cutting forms. Indeed it is possible to envisage applied images being designed to fit pre-existing grid type cutting forms with forms being used again and again. The countervailing disadvantages of the grid system are two fold. It is relatively uneconomic in terms of space, about a fifth of the imagery in the FIG. 118 layout finding no place in the FIG. 119 layout. Secondly, and less easy to evaluate, the applied images produced on a grid system may lack some of the elegance of those produced with customized outlines. There may, however, be a place for both kinds of die-cutting.

FIG. 119 provides page reference numbers on corners that can be left on the backing sheet or removed before the applied image is placed in position. The incorporation of these corners will increase the cost of die-cutters and they will take longer to make. In certain circumstances a separate layout plan such as that illustrated at FIG. 120, that performs the same function as the layout plan shown at FIG. 116, may be preferred.

The use of a transparent material for the reproduction of applied images has much to commend it for its ability to cope with intricate outlines such as those in evidence in many of the applied images present in FIG. 117. A particular examples is the “Brain Defender” item of headwear reference number 3.5 in which artwork totally encloses un-artworked areas.

In FIGS. 115, 116, 117 and 121 the cat stole is provided as a pair of items. The user will position these items on either side of the neck and shoulders of the speaker at the despatch box. In FIGS. 118 and 119 the two sides of the cat stole are formed from the same piece of material. This is only possible if the material on which the image of the cat stole is produced is transparent and not opaque.

Applied images provided on an opaque white backing will require less complex outlines that cutters will have to follow as closely as possible, with the risk of registration problems arising from time to time. Cut to a black surround applied images will have something a pop art/comic art feel about them that may, however, be preferable in certain circumstances.

Mention should be made of the possibility of reproducing applied images on a transparent material that is itself provided on a transparent or semi-transparent backing material. This would allow applied images, particularly non-dedicated applied images, to be offered-up to the target image before being removed from the backing sheet and committed to the target image. Selecting an appropriate applied image in relation to a target image falling between two band sizes will often be a matter of trial and error and anything that mitigates the problem is deserving of consideration.

FIG. 121, however, shows a similar set of applied images to those seen in preceding figures as they might appear printed on an opaque white substrate accompanied by similarly colored backing paper. Since the outlines of the cutter can only approximate to the outlines of the respective applied images a loss of realism in the end result would have to be endured.

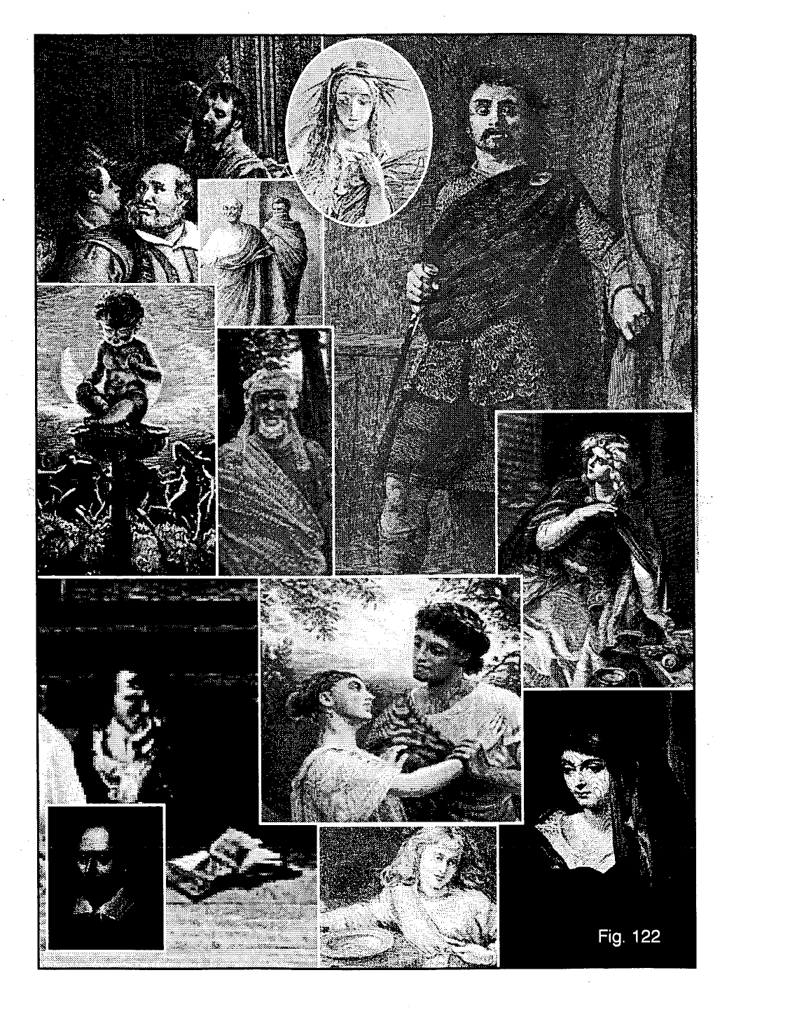

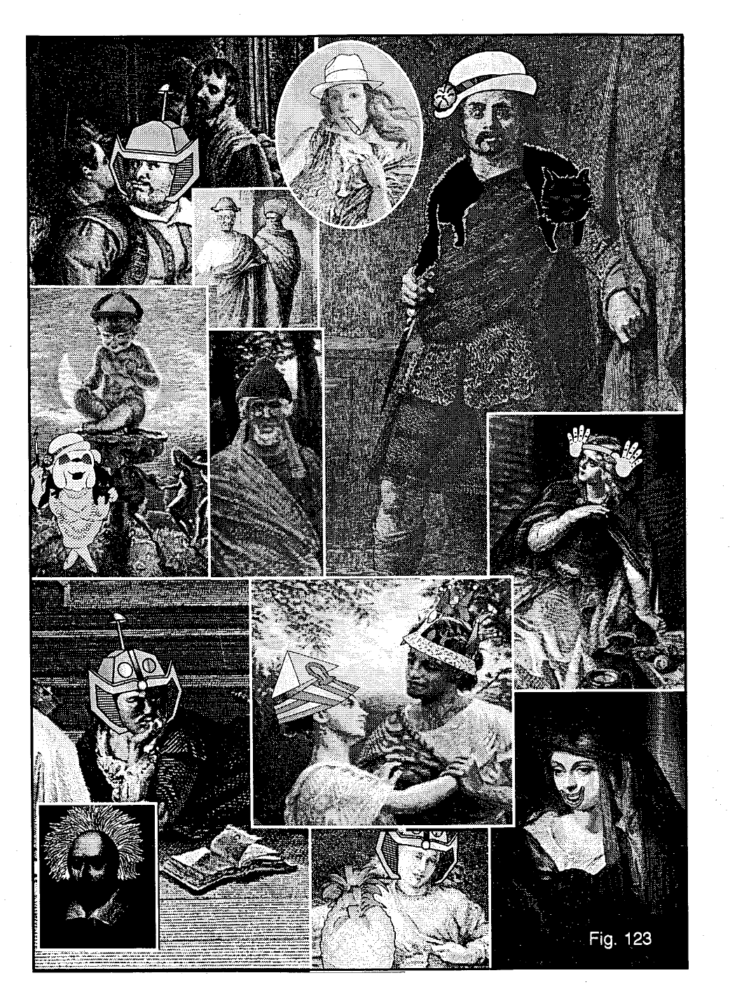

FIGS. 122 and 123 demonstrate the manner in which applied images adapted for use with specific target images but in the event not so employed can be put to use with a set of target images produced not independently but for the purpose.

The first figure reproduces engravings of characters appearing in the plays of William Shakespeare. The second figure shows how the applied images appearing in FIG. 117, et al, might usefully be applied to the engravings. It must be born in mind that the engraving are taken from a Victorian edition of the plays and were obviously not created with the applied images in mind. The “fit” accordingly leaves something to be desired. In practice target images compiled for the purpose of finding employment for “remaindered” applied images would usual comprise new drawings connected by a narrative and would exactly match the applied images in question.

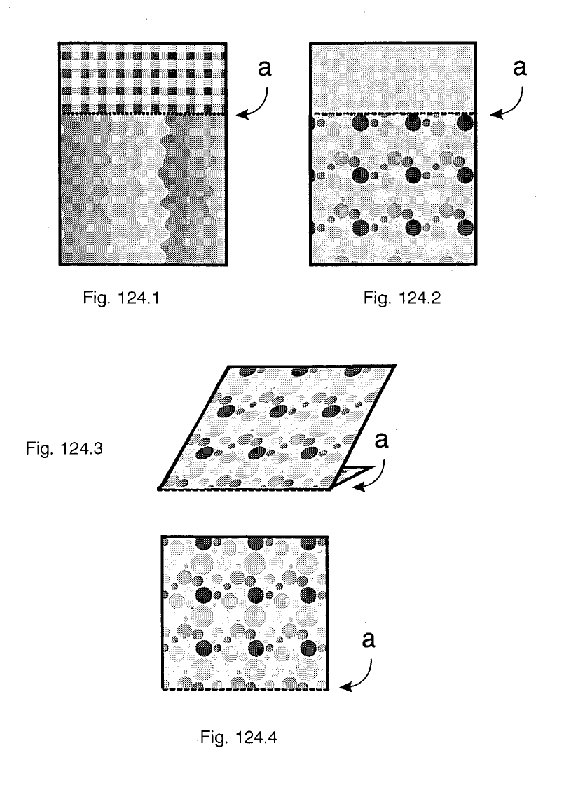

FIGS. 124 to 133 relate to flap devices in accordance with the present invention that position an applied image on or over a target image. The applied image is reproduced on the obverse surface of the flap. When the flap is raised the target image is revealed. These figures are shown at one hundred percent of scale.

FIGS. 124.1 and 124.2 show a plan view of the obverse and reverses surfaces, respectively, of a flap device in its most simple form. The upper part of the item (distinguished by a plaid pattern) is stuck to the material on which the target image is reproduced or, alternatively, a transparent overlay. The lower part (wavy striped pattern) carries the applied image. Between the two parts is a line of fold marked “a” on the drawings that acts as a hinge for the flap. In the reverse view the upper part, tinted gray, carries the adhesive. The lower part (shown in a blob pattern) may either be left blank, artworked in such a way as to merge with the underlying illustration of which the target image forms part, or display a message or symbol. FIGS. 124.3 and 124.4 show the flap partly raised and lying flat against the underlying surface respectively.

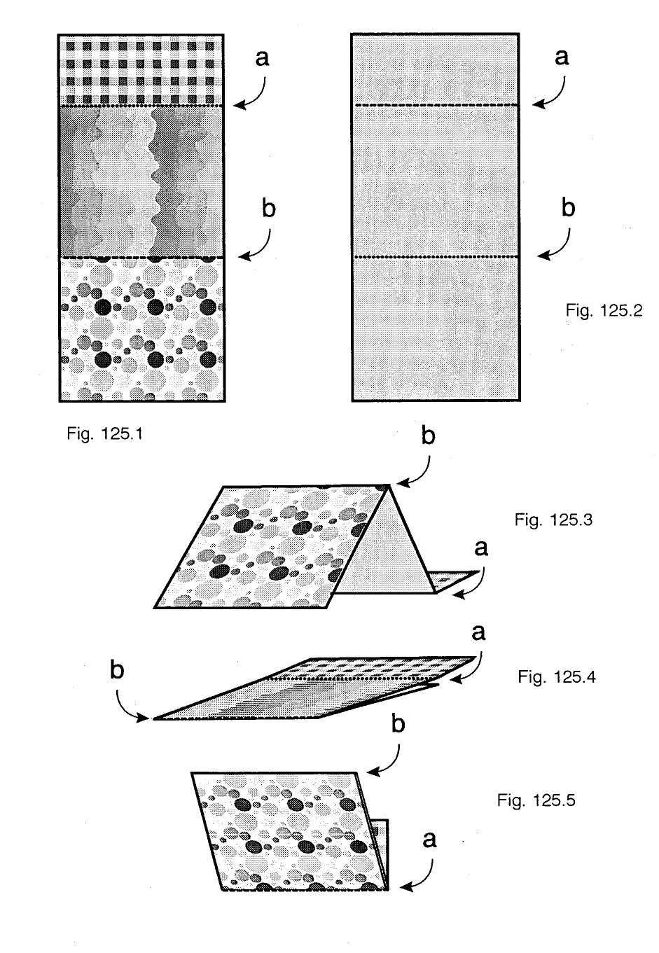

FIGS. 125.1 to 125.5 show an alternative configuration in which only one side of the item requires to be printed, the other side being provided with adhesive. The flap is formed by folding the two halves of the lower part back-to-back about the line of fold marked “b” on the drawing. This fold lies parallel to the line of fold marked “a.” The latter line of fold acts as a hinge for the flap. It is necessary for the outlines of the two parts of which the flap portion is comprised to be mirror images of each other and for them to be arranged symmetrically about the line of fold “a.” FIG. 125.2 shows the reverse surface to which adhesive is applied, FIGS. 125.3 and 125.4 show stages in the assembly of the flap, In FIG. 125.4 the flap appears almost to be in a closed position in which the target image would be concealed from view. FIG. 125.5 shows the flap almost fully open. Artwork may be along the lines described in the preceding paragraph.

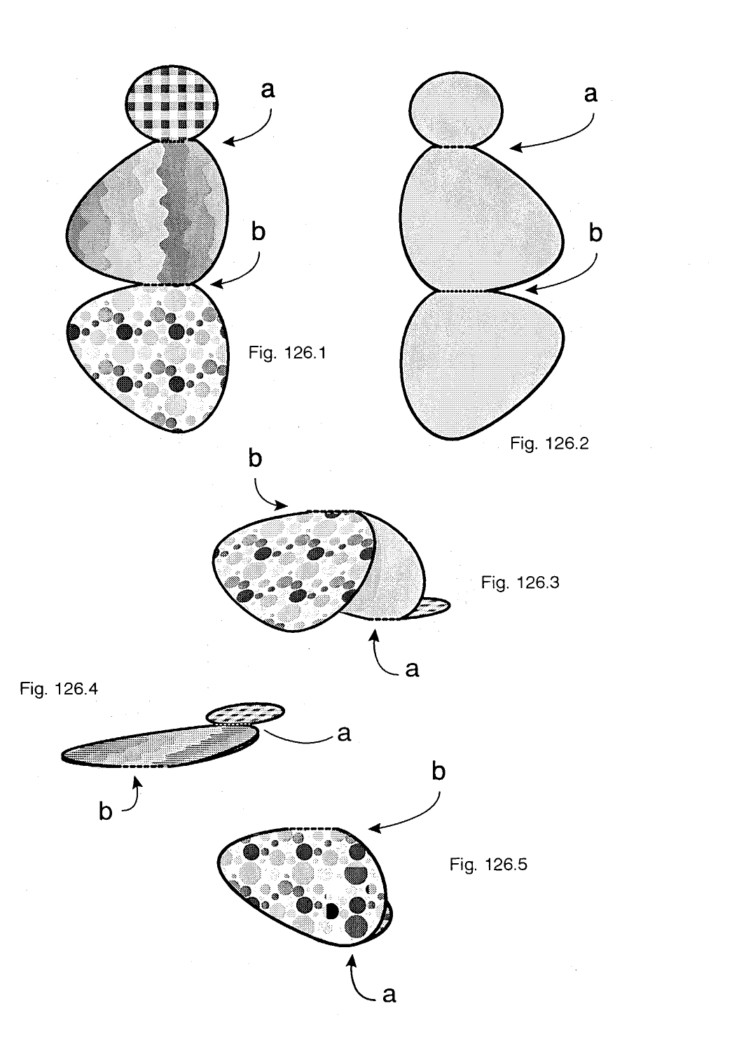

FIGS. 126.1 to 126.5 show, in views similar to those that are the subject of the preceding paragraph, that a flap does not have to be rectangular in shape. What is important is that the outline shapes of the two surfaces that comprise the flap proper should be a mirror image of each other and symmetrical about the line of fold “b.” It is also possible for the material on which the flap is reproduced to be rectangular but for the printed portion to be along the lines shown in these drawings with the remaining surface transparent.

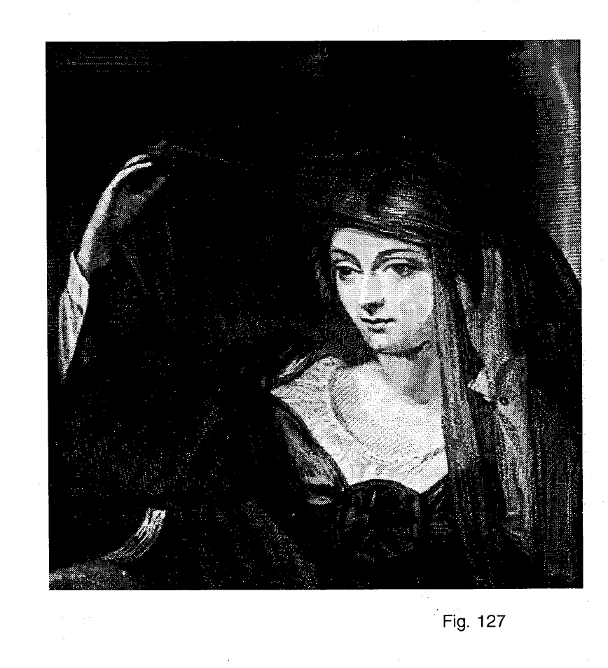

FIGS. 127 to 133 demonstrate how flap embodiments work in practice.

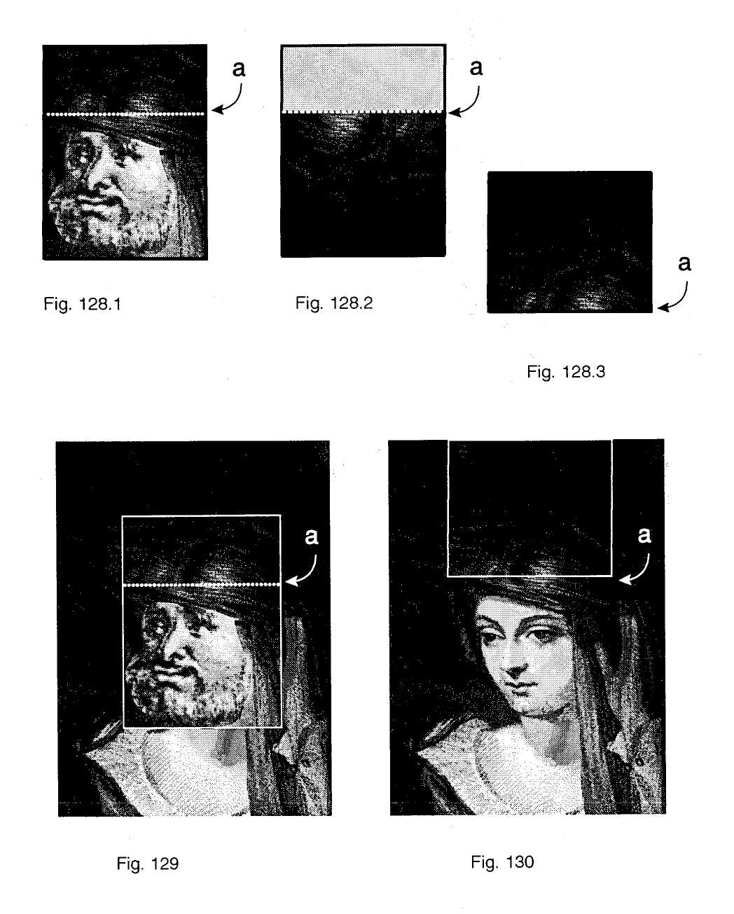

FIG. 127 is taken from an engraving of the character Olivia in Shakespeare's ‘Twelfth Night’ (the same as previously seen in FIGS. 122 and 123). The purpose of the flap is to overlay the lady's face with an image of Falstaff (also present in the earlier figure). The construction shown in FIGS. 128 to 130 replicates the simple form of flap seen in FIGS. 124.1 to 124.4. Particularly to be noted is the artwork on the lower part of the reverse side, shown in FIG. 128.2, that reproduces the dark area proximate to the target image that lies above the lady's head. As seen in FIG. 128.2 the artwork is upside down but when the flap is in the raised position, as seen in FIGS. 128.3 and 130, it is correctly aligned in relation to the underlying illustration.

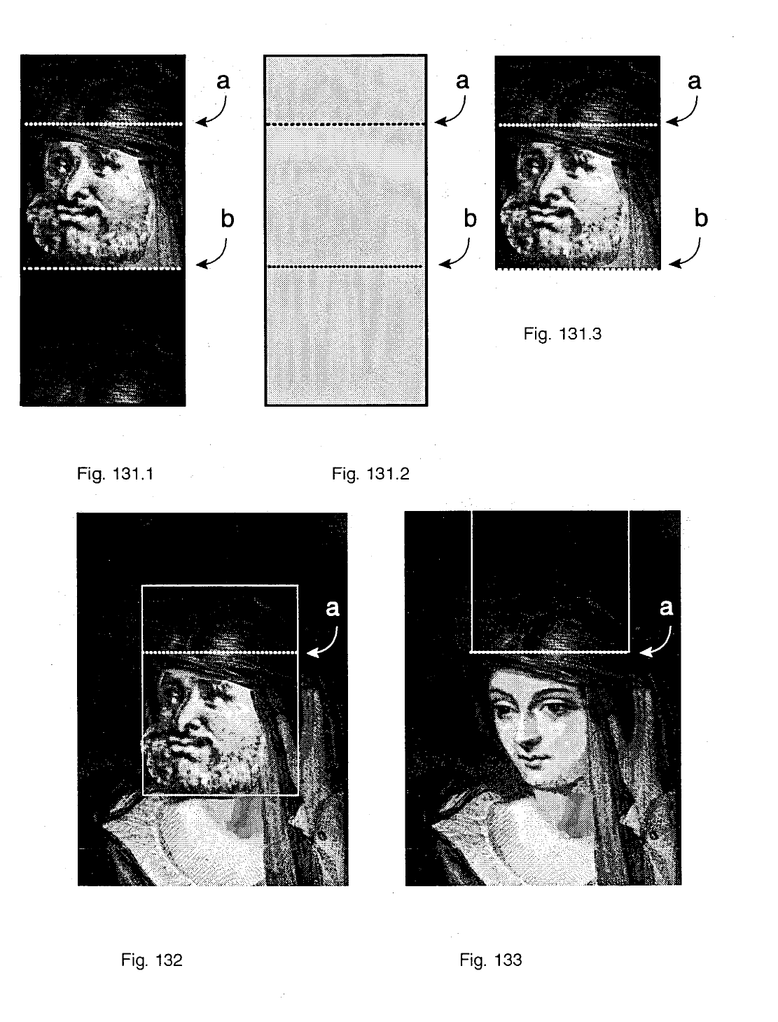

The construction shown in FIGS. 131.1 to 131.3 replicates the alternative form of flap seen in FIGS. 125.1 to 125.5. Here again the reverse side of the flap is artworked in such a way that it will merge with the underlying illustration when the flap is in the raised position.

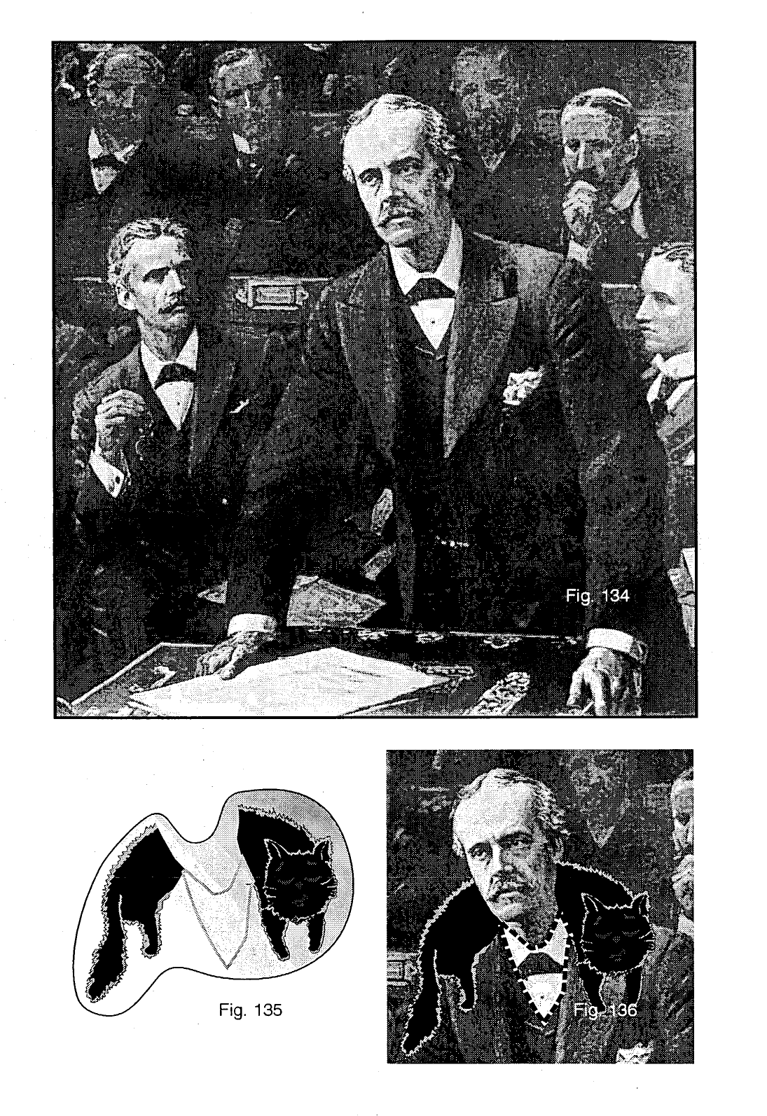

FIG. 134 shows the now familiar parliamentary scene unadorned by an applied image. FIG. 135 shows a dedicated applied image in the form of the same cat stole seen in FIG. 113 et al. Correct positioning on the target image is assisted by the addition of a semi-transparent outline that corresponds to the line feature formed by the outline of that part of the shirt and collar of the principal figure which is on view in the illustration. In FIG. 136 the cat stole is in position, the outline shown by a dotted line. In practice the outline would be almost invisible.

These figures are shown at 100 percent of scale.

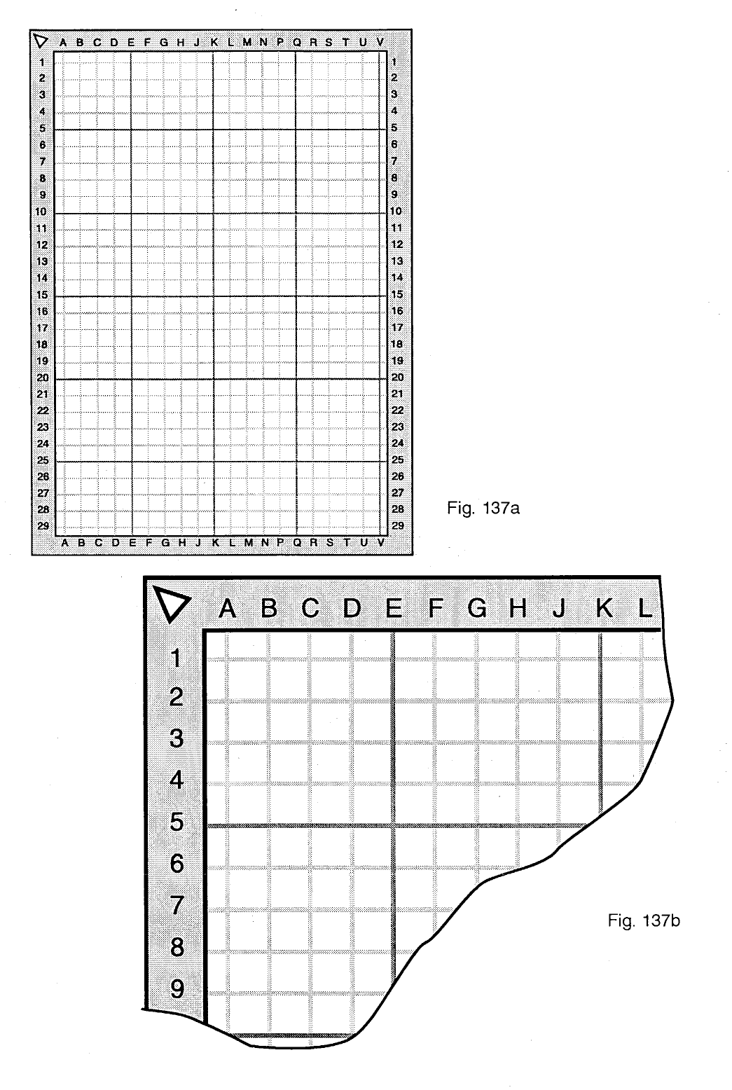

FIG. 137a shows a grid device of sufficient size to cover at least the greater part of a page of a typical popular magazine. The drawing is reproduced at 40 percent of scale but the actual dimensions of the grid overall (including the bounding borders) are approximately 230 mm by 320 mm. FIG. 137b shows a detail of the grid at 100 percent of scale. The horizontal and vertical lines of which the grid is comprised are respectively spaced apart by 10 mm. As configured, the device has one pair of axes the origin of which is at the top left hand corner. This corner is marked with an arrow. The graduations along the horizontal axis of the grid are labeled with letters of the alphabet and those along the vertical axis with numbers.

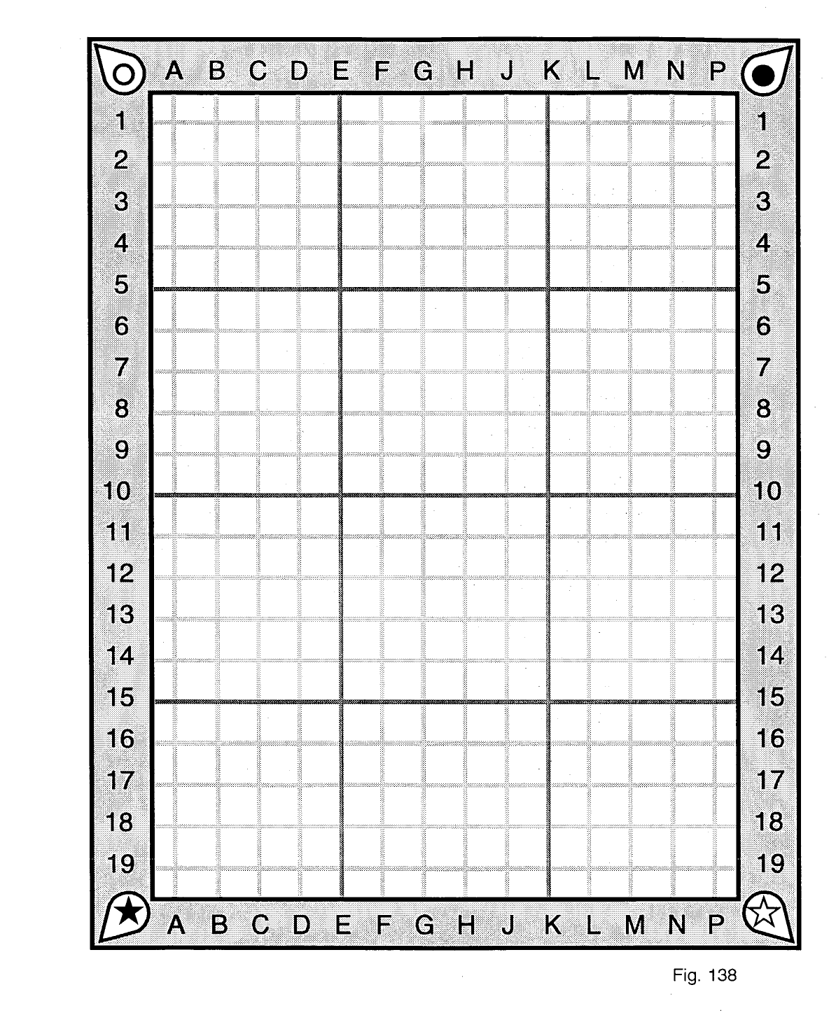

FIG. 138 shows at 100 percent of scale a smaller grid but one which is configured in such a way that it is able to accommodate a full size magazine page. The dimensions overall (including the bounding borders) of the grid illustrated are approximately 170 mm by 220 mm. The lines of which the grid is comprised are arranged in a similar fashion to those seen in the previous drawings. It will be noted, however, that the four corners of the device are distinguished one from another by symbols. The symbol in the top left hand corner is a circle, the symbol in the top right hand corner is a black spot, the symbol in the bottom left hand corner is a black star and the symbol in the bottom right hand corner is a white star. The artwork surrounding the symbols is such as to clearly associate them with the respective corners of the device.

The device illustrated is provided with four pairs of axes. For each pair of axes there is an origin that is at or proximate to a corner of the device. No two pairs of axes have an origin at the same corner. The lines of the grid are parallel to the respective axes. The letters and numbers appertaining to the graduations along the respective axes are read in ascending or descending order as required.

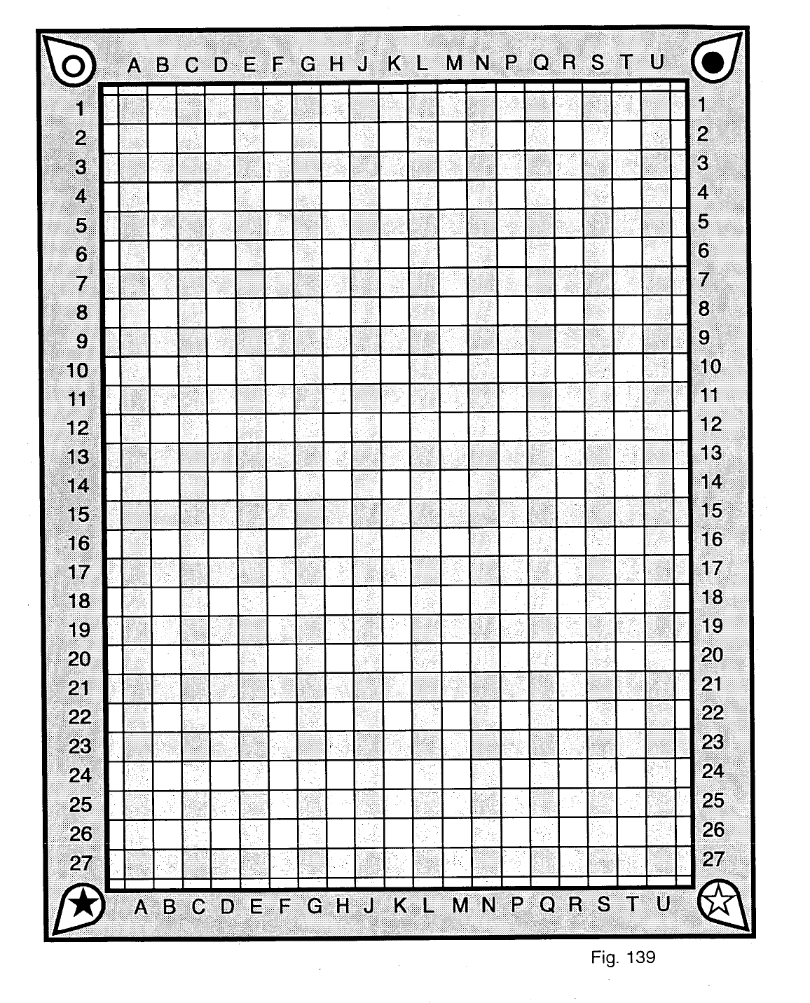

FIG. 139 shows a grid device similar in size and configuration to that shown in FIG. 138 but with the spaces between the horizontal and vertical lines reduced to 7 mm and forming bands in each case. The bands are distinguishable one from another by contrasting colors but are semi-transparent nevertheless.

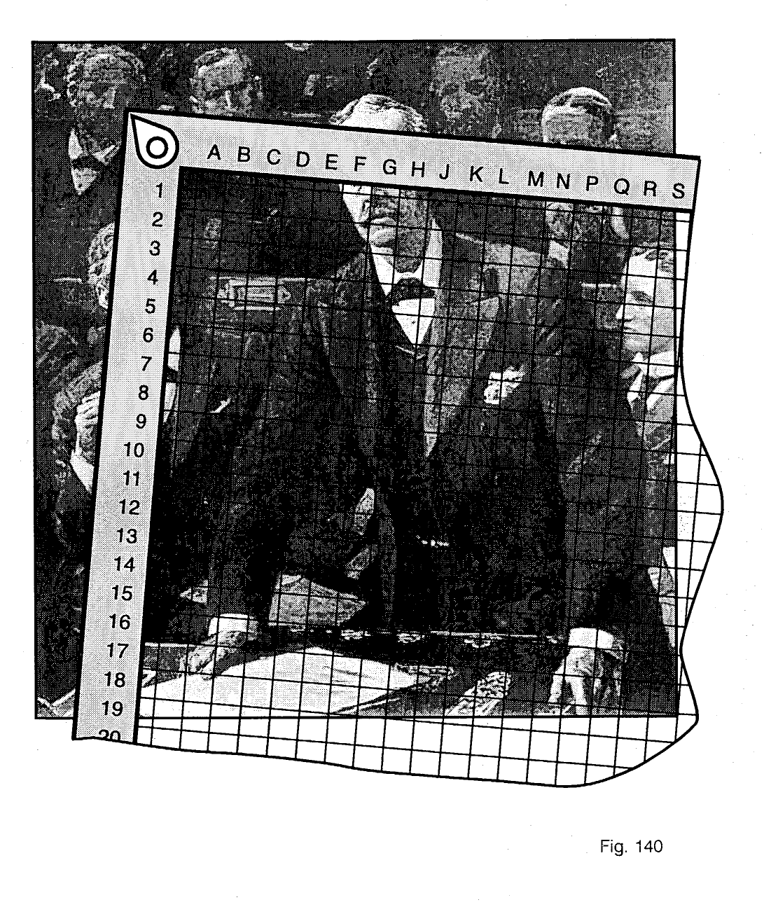

FIG. 140 shows the grid device illustrated in the preceding figure in the course of being offered up to a flat substrate comprised of the parliamentary illustration shown in previous figures, the scale of the reproduction being 100 percent. The active corner of the device is that distinguished by the circle symbol.

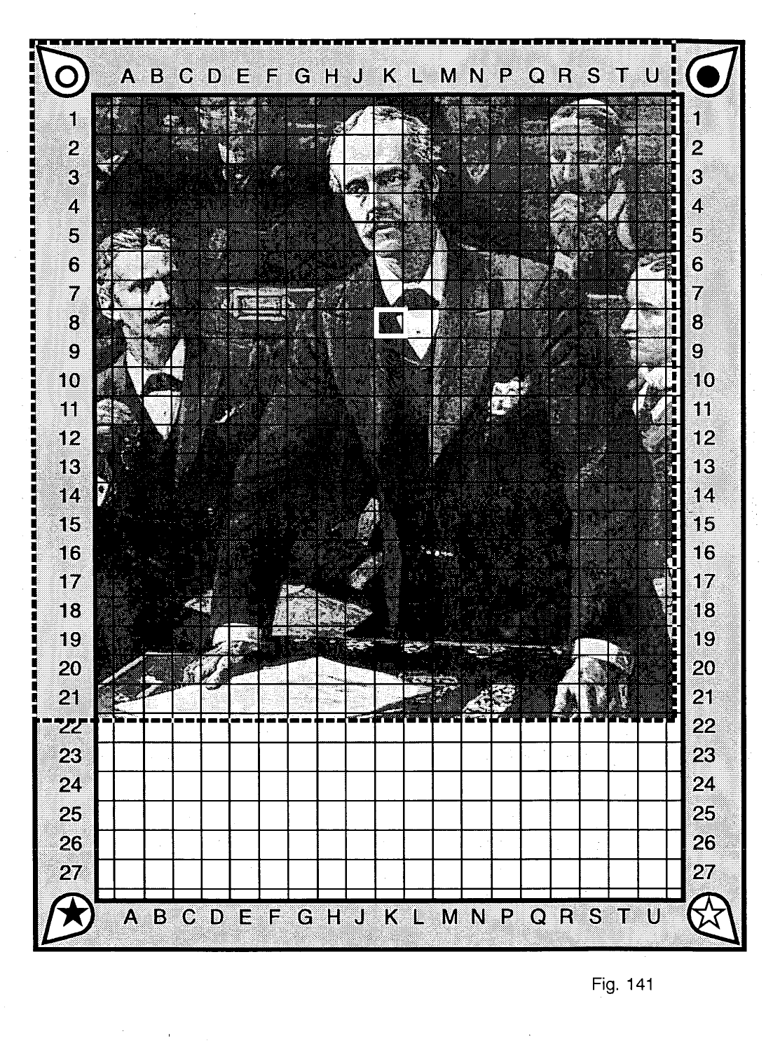

FIG. 141 shows the grid device now correctly positioned over the illustration with the corner of the device marked with a circle aligned with the upper left hand corner of the underlying illustration. The edges of the latter are shown by a dotted line. A square rectangle outlined in white indicates the point on the underlying illustration that is being identified. The co-ordinates of the rectangle—read along the horizontal and vertical graduated axes which intersect at an origin located at a point proximate to the top left hand corner of the device—are “K8.” In directions to a user the location of the rectangle would be indicated by a circle followed by “K8.”

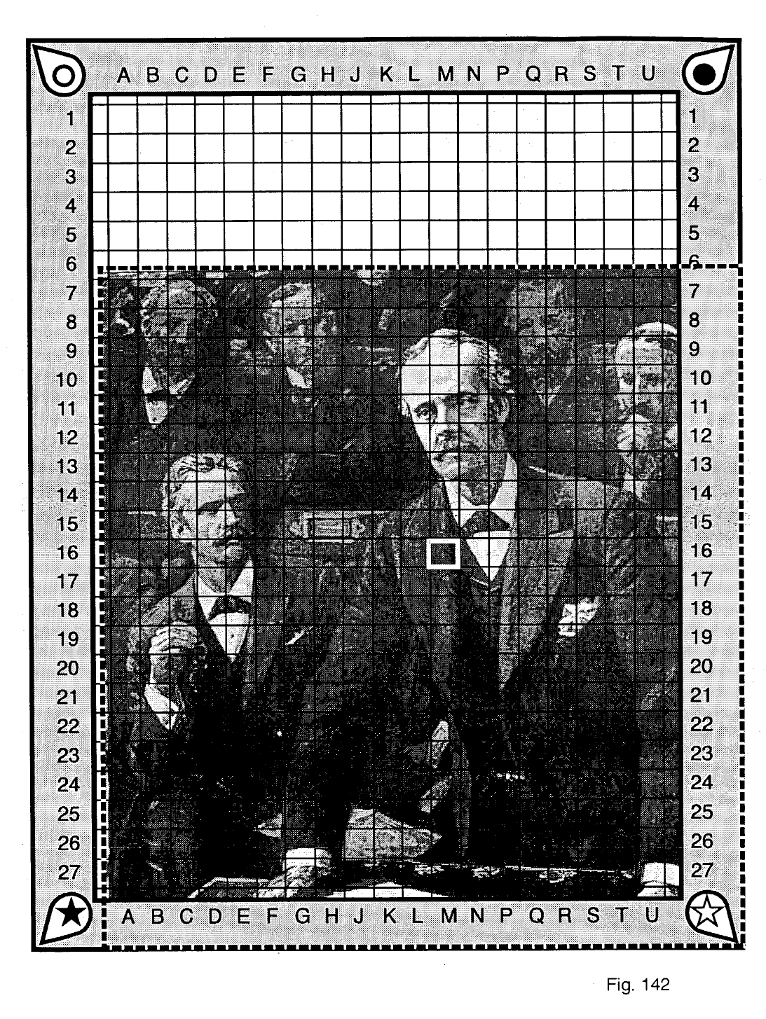

FIG. 142 shows the same grid device aligned with the bottom right hand corner of the illustration. In this instance the co-ordinates of the rectangle will be read along the horizontal and vertical graduated axes which intersect at a point proximate to the bottom right hand corner of the device. In directions to a user the location of the rectangle (the position of which relative to the underlying parliamentary illustration has not changed) would be indicated by a white star followed by “M16.”

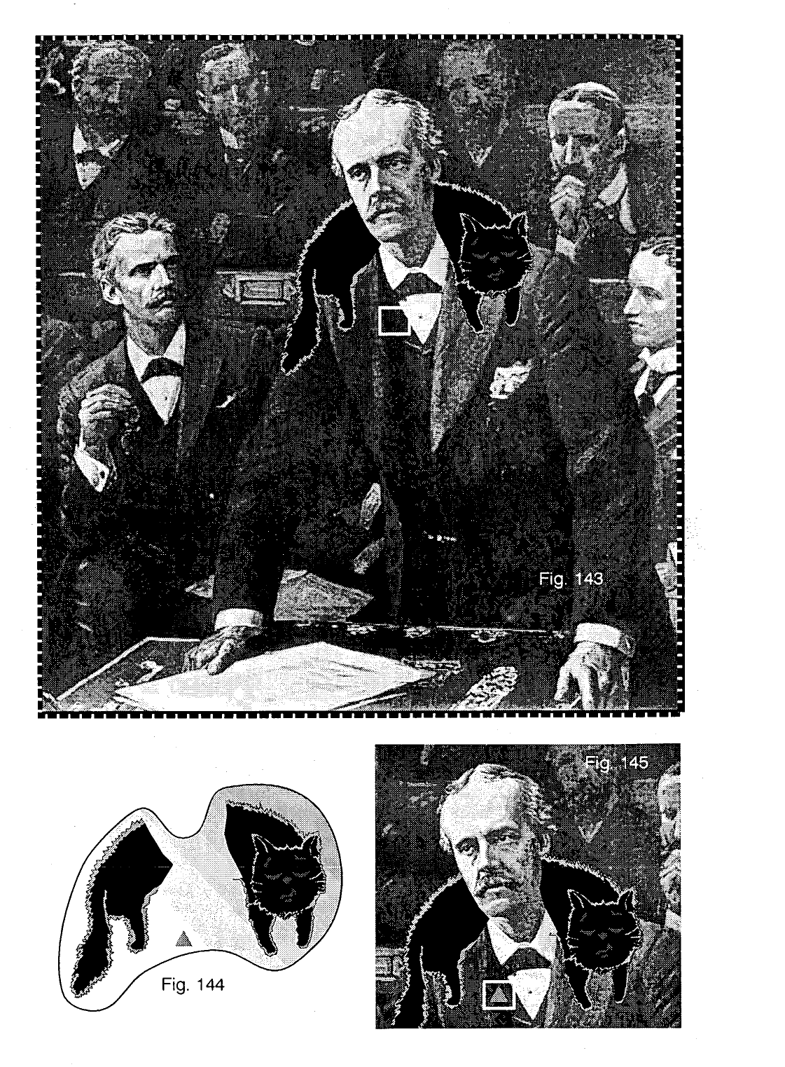

FIG. 143 shows the relationship between the cat stole, in its intended position, and the rectangle. In FIG. 144 the applied image is shown as it would appear prior to removal from the backing sheet. A mark in the form of a semitransparent triangle has been added that is so positioned that when superimposed on the parliamentary illustration the cat stole will be accurately located “around” the neck of the principal figure.

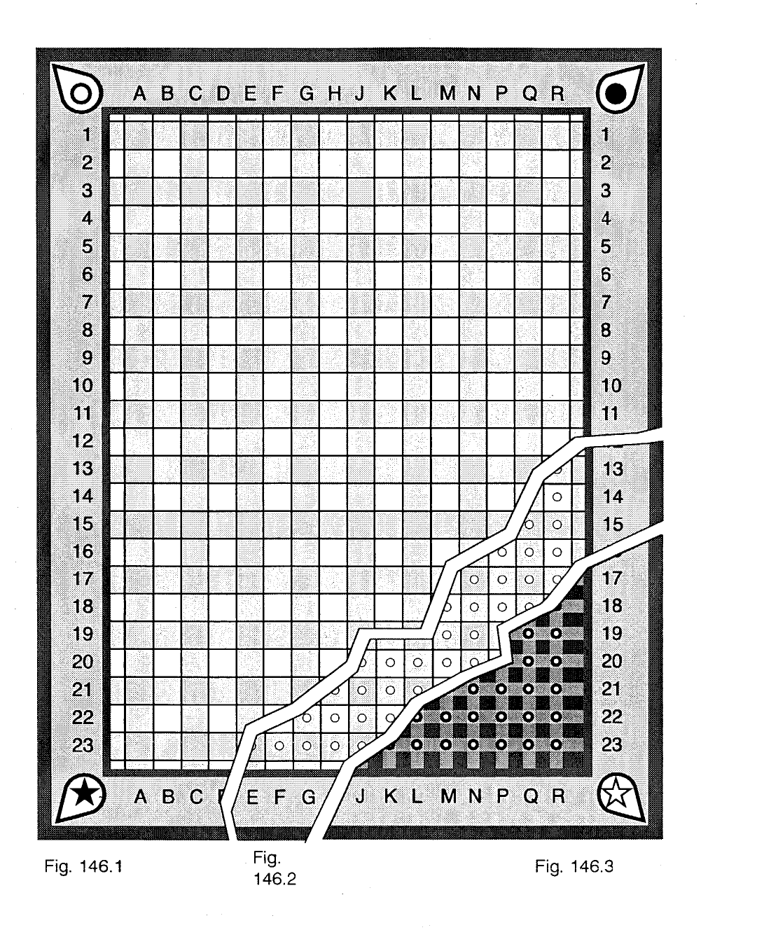

FIGS. 146.1 to 146.3 demonstrate by way of three details varying degrees of transparency in a grid device. At 150 mm by 190 mm the device (shown at 100 percent scale) is smaller than those previously illustrated, but it is nevertheless able to accurately position a dedicated applied image anywhere on the page of a typical popular magazine with dimensions of the order of 240 mm by 330 mm.

In each detail the borders of the device are opaque. In FIG. 146.1 the grid portion is comprised of horizontal and vertical bands which are tinted but largely transparent. In FIG. 146.2 the degree of transparency is increased by the addition of 2 mm diameter apertures positioned at the points of intersection of the bands. Through these apertures a pen or pencil or pin or similar article can be passed so that a mark can be placed on the surface of a flat substrate comprising a page, photograph, illustration, etc., for which co-ordinates have been provided. In FIG. 146.3 the degree of transparency is reduced, the device being totally opaque except for the apertures.

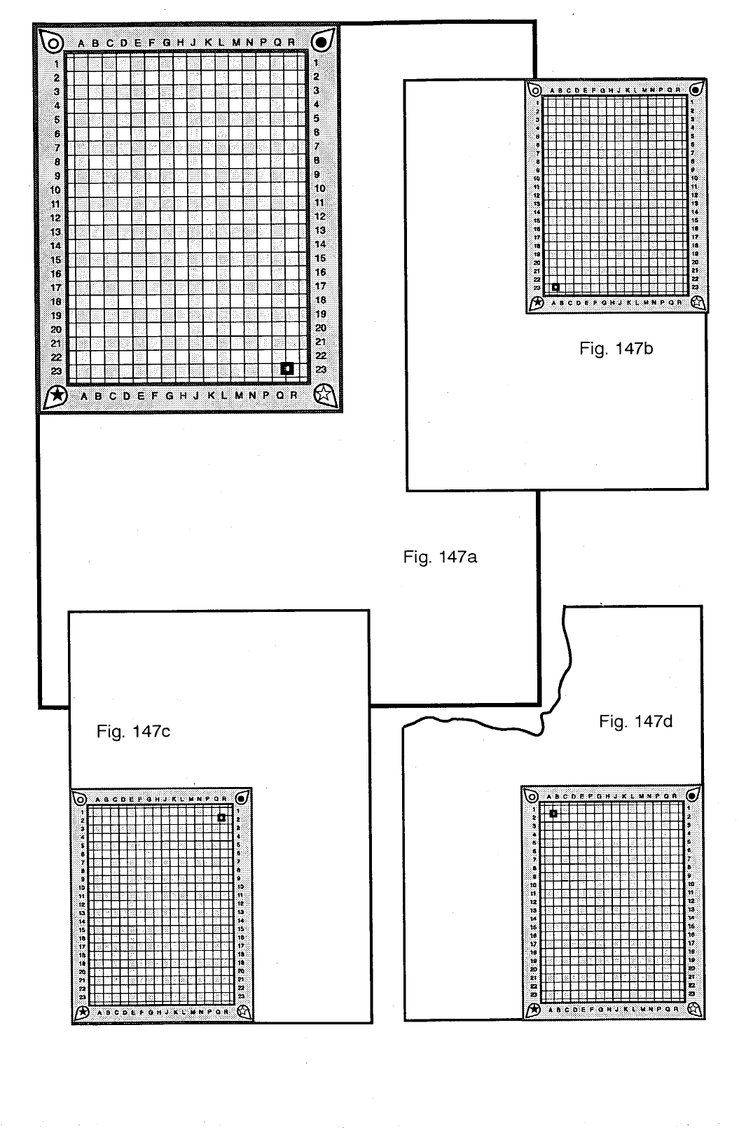

FIG. 147 shows a magazine page with dimensions of the order referred to in connection with FIG. 146. In FIG. 147a the scale of reproduction is 50%. The center of the page is indicated by a black outlined rectangle. In this first drawing the top left hand corner is the active corner of the grid device and the co-ordinates of the rectangle could be described by using the symbol for the circle followed by ‘Q/R23’. In practice a point falling squarely within a box formed by the bands of the grid and proximate to the rectangle would be chosen and the mark on the applied image positioned accordingly, of course.

In FIGS. 147b, 147c and 147d, where the scale of reproduction is 30 percent, the respective active corners of the grid device are the top right hand, bottom left hand and bottom right hand corners. These corners are respectively designated by a black spot, black star and white star. It will be seen that the area proximate to the rectangle at the center of the magazine page can thus be accessed by the grid in all four positions.

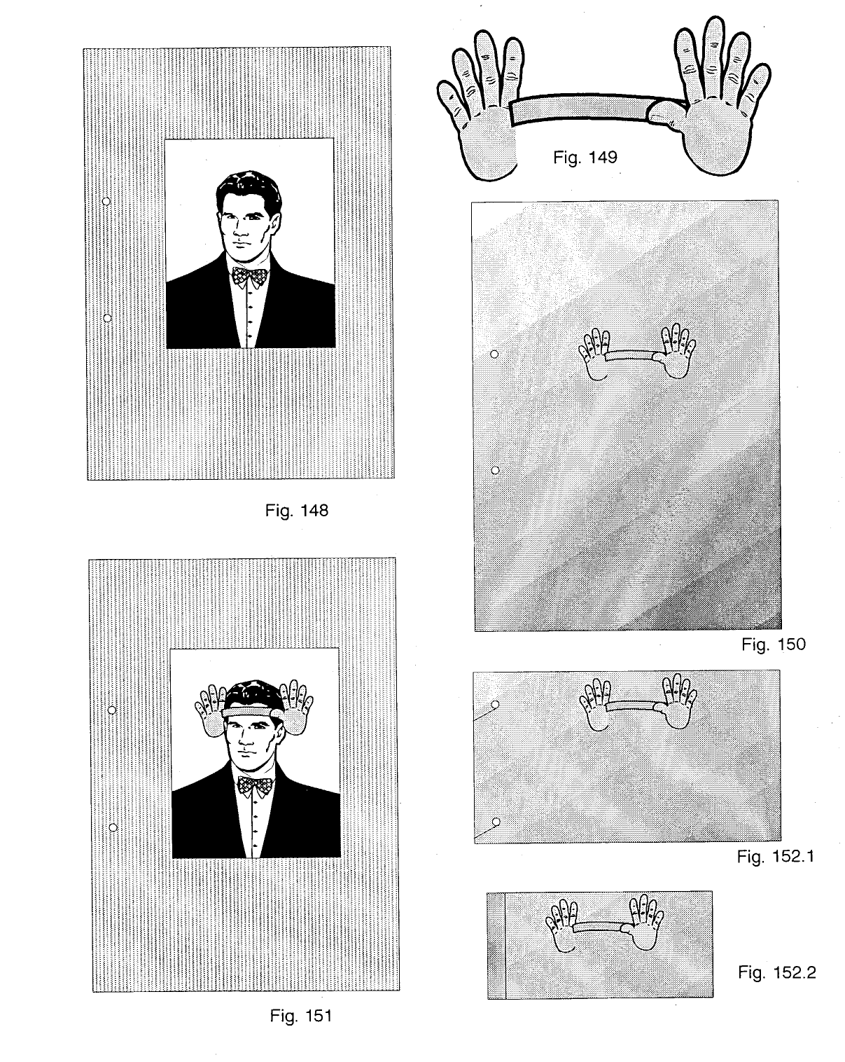

FIG. 148 illustrates a page from a photo album or scrapbook on which a portrait of a man has been mounted thereby providing a target image. The page has two holes along its left-hand edge. FIG. 149 shows an item of headwear of the kind previously illustrated which item comprises an applied image. FIG. 150 shows the applied image in position on a transparent piece of material the shape of which piece of material corresponds to that on which the target image is mounted, two holes corresponding to those on the page also being present. The positioning of the applied image on the transparent material is such that when it overlays the page, as shown in FIG. 151, it is aligned with the underlying target image and forms a composite image in a dimensionally appropriate manner.

Both page and transparent overlay are adapted to be placed in a ring binder, unwanted lateral displacement being thereby inhibited. The applied image and, a fortiori its adhesive backing, do not come into contact with the target image.

FIG. 152.1 shows a transparent overlay the height of which is less than that of the page in the photo album or scrapbook as illustrated at FIG. 148. The holes in the margin are joined by a slit to the proximate edge so as to permit insertion and removal without opening the rings of the binder.

FIG. 152.2 shows a transparent overlay that incorporates a self-adhesive strip along its left-hand edge instead of holes. In use such an overlay will be adhered to one side of an album page away from the photograph on which the target image is produced. Scrapbooking enthusiasts may find such an arrangement more convenient.

FIGS. 148 and 150 to 152.2 are at 35 percent of scale. FIG. 149 is at 100 percent of scale.

FIG. 153 shows the page of an album such as that referred to the preceding drawings with the transparent overlay being rotated on a curved plane along the axis comprised by its left hand edge. The facility of temporarily lifting an applied image off a target image so as to view the latter in its unmodified state is not without value.

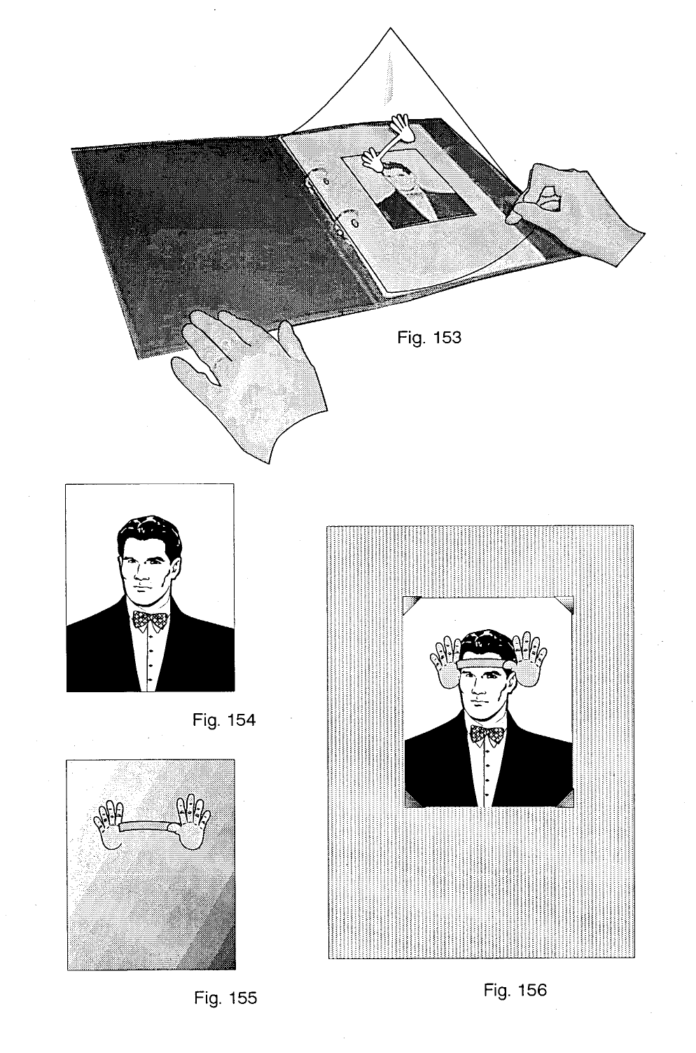

FIG. 154 shows a photograph on which a target image is reproduced and FIG. 155 shows an item of headwear that it is desired to superimpose over the target image. In this instance superimposition is achieved and unwanted lateral displacement inhibited by using conventional photo corner mounts in the manner illustrated in FIG. 156—the same photo corner mounts doing double duty for the photograph and for a transparent overlay cropped to the same size as the photograph. These figures are at 35 percent of scale.

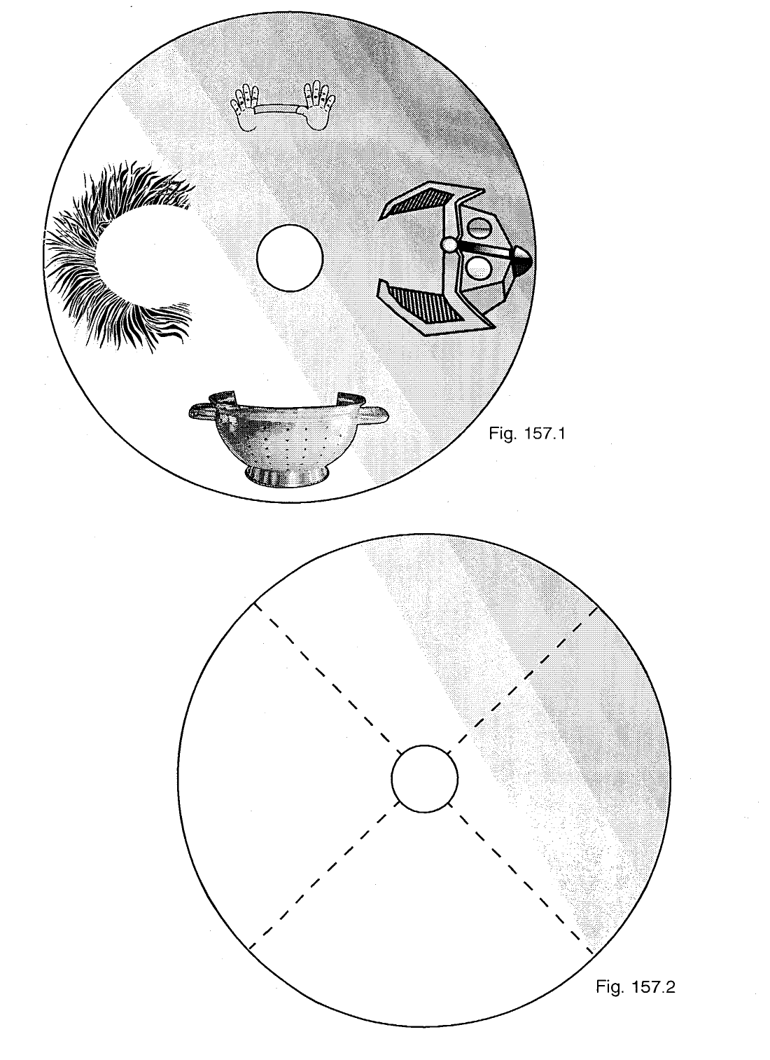

FIG. 157.1 shows four applied images arranged around the outer edge of a circular portion of material that is transparent and has at its center an aperture.

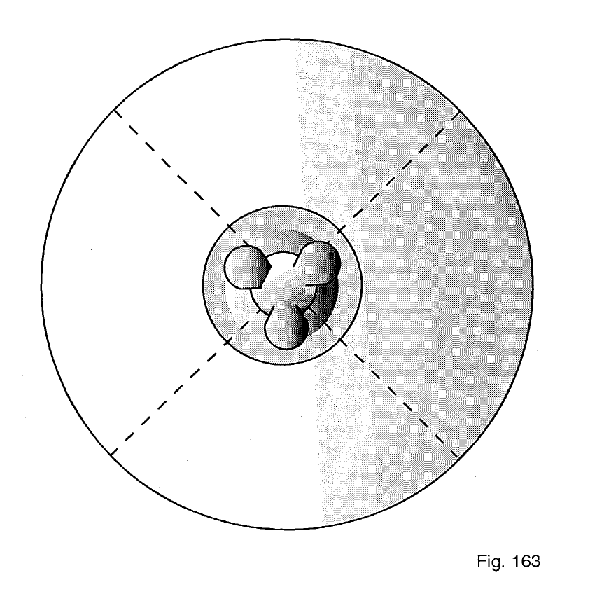

The circular portion is a rotatable female element adapted co-operate with a fixed male element. FIG. 157.2 shows a similarly configured element on which no applied images are present but which is marked in such a way as to provide a guide to a user as to where such images should be positioned. These figures and those that follow up to and including FIG. 163 are shown at 65 percent of scale.

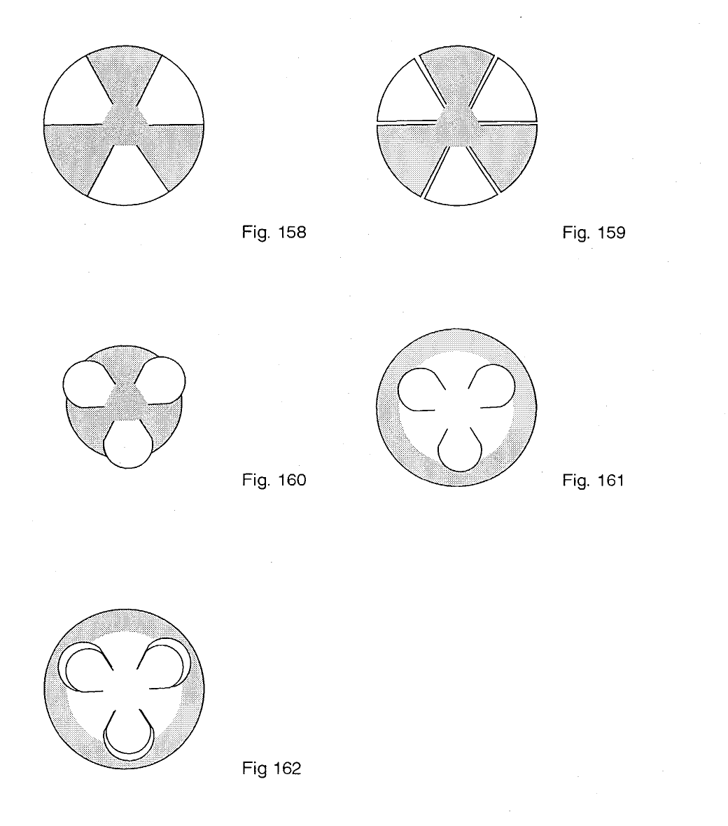

FIGS. 158 to 162 show five different configurations of male element. Each of the elements is provided with three tabs that, the element being made from a flexible material, can be passed through the aperture in a female element and function as an interlocking mechanism. The means whereby interlocking is achieved is demonstrated in the following drawing, FIG. 163. This shows a FIG. 157.2—type circular rotating female element interlocked with a FIG. 161 fixed male element—the scale in either case being again 65%. In all these drawings the solid shaded area indicates a self-adhesive substance by means of which the male element is fixed to the page of an album or scrapbook or, alternatively, a transparent overlay. The addition of adhesive would not, however, materially diminish the transparency of the device overall.

In FIG. 158 the tabs comprise a plurality of radial cuts the innermost and outermost ends of the cuts being respectively of a lesser and greater diameter than the innermost edges of the apertures in the depicted female elements.

In FIG. 159 a gap is provided between the tabs the purpose of which is to facilitate the grasping of the tabs between finger and thumb prior to interlocking with the rotary element. It must be born in mind that by the time when the rotary and fixed elements are brought together the fixed element is likely to be stuck down flat on a page. The interposition of a gap between the self-adhesive areas and the tabs is therefor likely to improve the user friendliness of the device. In FIG. 160 the same result is largely achieved by having the tabs project beyond the adjacent material.

In FIGS. 161 and 162 the petal shaped tabs are formed by, respectively, partially and totally enclosed cut-outs. Shrouding the tabs in this way would seem to invest them with a neater appearance. In the examples illustrated the self-adhesive material is annular in shape but the area of self-adhesion could, if thought necessary, be extended across the entire area other than that represented by the tabs. FIG. 162 is the more user-friendly version in which apertures are provided between the tabs and the enclosing material. It is qualities of user-friendliness that largely determine the number of tabs. Two tabs would be easier to interlock than three and four tabs would reduce the play between male and female elements. Three tabs has been found to be a satisfactory compromise in practice.

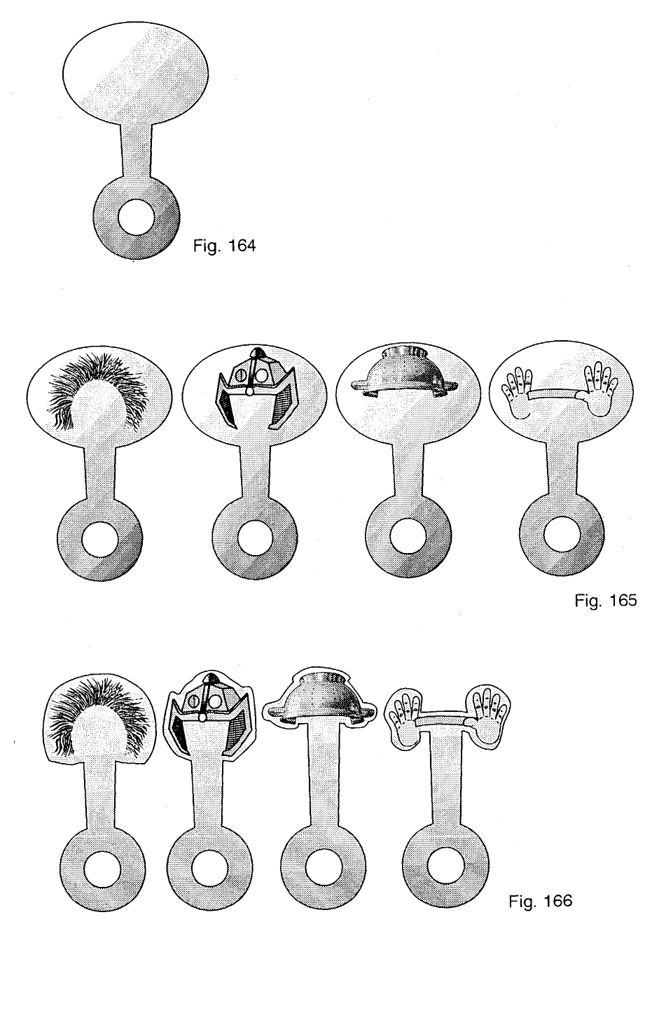

The remaining figures illustrate rotatable elements that are not circular but are shaped as arms, the applied image being placed at one end and the interlocking mechanism securing the arm to the fixed element at the other. The scale is in every case 35 percent. FIG. 164 shows a plane arm made from transparent material with an area shaped to accommodate a range of applied images of different shapes and sizes. FIG. 165 shows a selection of such arms with applied images in position. A user might do the placing of such applied images or, alternatively, the arms could be supplied with images already printed on them.

FIG. 166 shows arms that are customized to the individual images—a relatively costly process in terms of die-cutting forms and inventory, but resulting in a product that is more striking in appearance.

The applied images that are placed second and fourth from the left in FIGS. 165 and 166 are left facing images in each case. Printing a mirror image of the respective designs on the reverse surface will make them optionally available to the user in a right facing form. The form of printing likely to be preferred is one that places a substantially white layer of ink on the surface and applies color above it. It may be possible to confine the white layer to only one side of the transparent material.

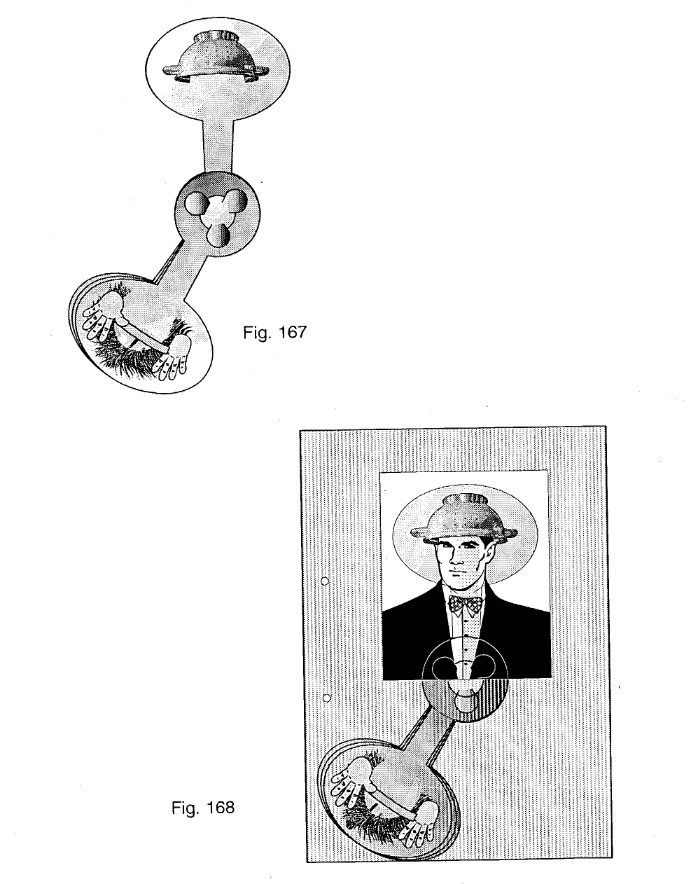

FIG. 167 shows four FIG. 151—style arms interlocked with a single rotary device.

More arms could be added if desired. FIG. 168 shows these arms in position on what might either be a page of an album or scrapbook or a transparent overlay.

It will be noted that rotary devices are less suitable for the simultaneous application of multiple applied images to the same photograph (a group photograph, for example) than the flat transparent overlays shown in the earlier drawings.

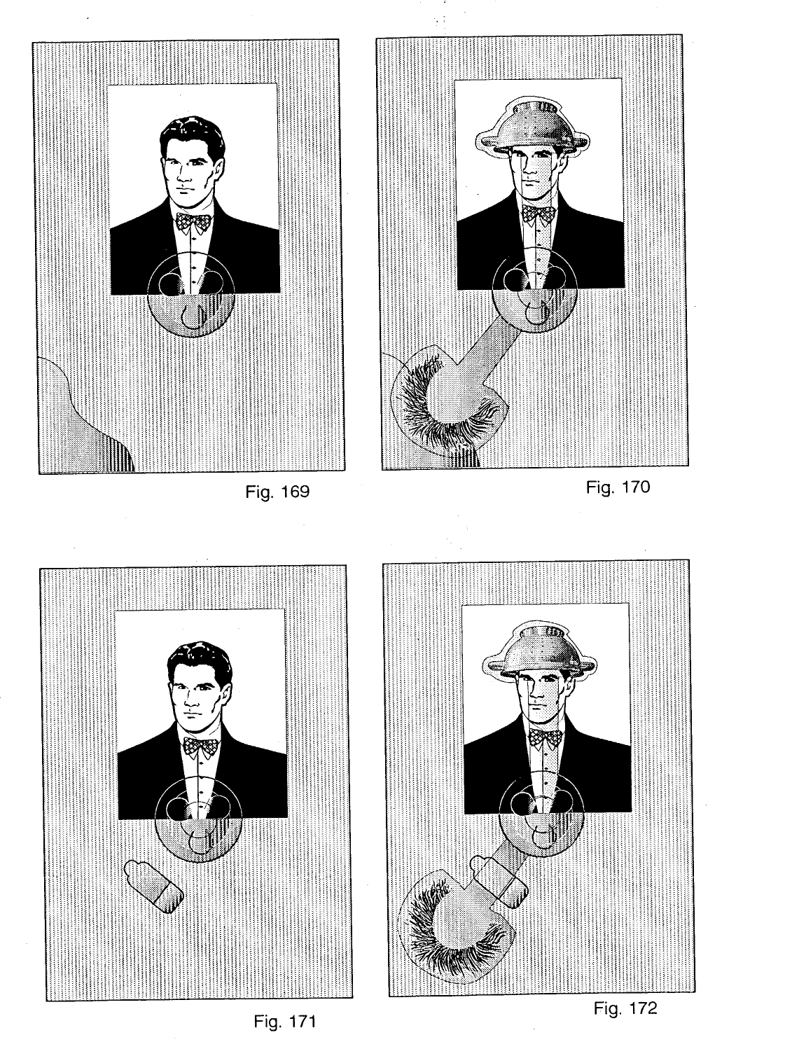

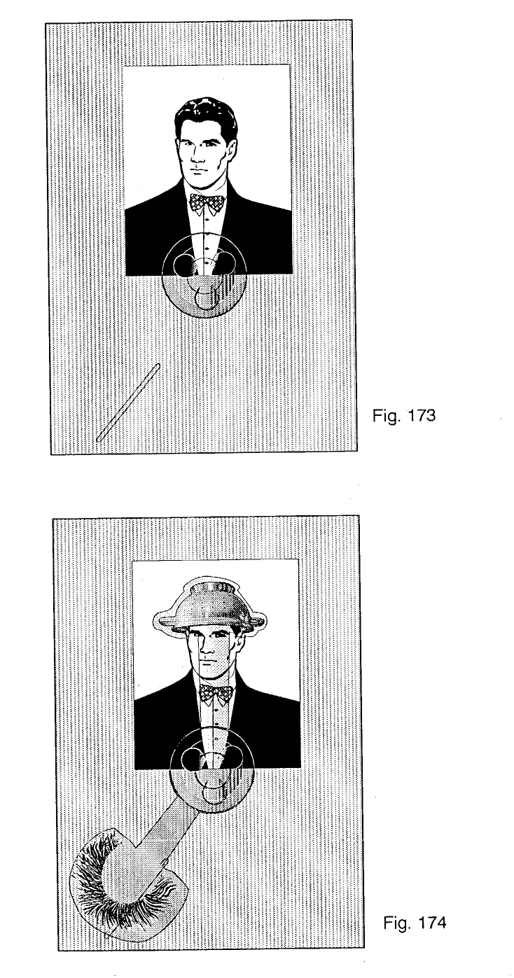

FIGS. 169 to 174 show three different kinds of temporary repository device whereby arms may be secured when not in use. These devices respectively comprise a corner pocket, a clip and a slot. The first two devices can be applied direct to the page on which the target image is mounted whereas the latter is most likely to require a separate transparent overlay.

Although an exemplary embodiment of the present invention has been shown and described with reference to particular embodiments and applications thereof, it will be apparent to those having ordinary skill in the art that a number of changes, modifications, or alterations to the invention as described herein may be made, none of which depart from the spirit or scope of the present invention. All such changes, modifications, and alterations should therefore be seen as being within the scope of the present invention.

What is claimed is:

1. An item of material bearing a representation of an image (“applied image”) adapted to be applied to and overlie an image depicting at least in part a human or other animal, humanoid or animal-like head (“target image”), which target image is reproduced upon another, separate item of material;
wherein the applied image is a modification, embellishment, or replacement for the head in the target image, and is adapted to be secured in position on or over the target image, and is cut-round or otherwise delimited, so that when applied to the target image the applied image cooperates with those parts of the target image not thereby obscured to form a composite image in a manner that is dimensionally appropriate;
wherein the applied image is:
a. one of a plurality of the same image differing in shape, as attributable to the degree of rotation of a head, and/or size; or
b. dedicated and appropriate to a specific target image, wherein the target image is found on an item that is produced and/or disseminated independently and without reference to the applied image.

2. An item of material as defined in claim 1, wherein an applied image is cross-referenced to a target image by means of a notation applied either to the item and proximate to the applied image or to a separate item of material on which a representation of the applied image is reproduced in a schematic or other form for purposes of its identification wherein the notation enables identification of the target image.

3. An item of material as defined in claim 1, wherein alternative applied images are provided for use with a specific target image.

4. An item of material as defined in claim 1, wherein an applied image is adapted for use with alternative target images.

5. An item of material bearing a representation of an image (“applied image”) adapted to be applied to and overlie a target image, which target image is reproduced upon another separate item of material which wholly or mainly depicts a landscape or other outdoor vista, interior, or external architecture, furnishings, decor, or inanimate objects;
wherein the applied image is adapted to be secured in position on or over the target image, and is cut-round or otherwise delimited, so that when applied to the target image, the applied image cooperates with those parts of the target image not thereby obscured to form a composite image in a manner that is dimensionally appropriate;
wherein the target image is found on an item which is produced and/or disseminated independently and without reference to the applied image.

6. A device for generating a set of coordinates for a point on a plane comprised of a flat substrate, the device being generally rectangular in shape and at least partially transparent, the device incorporating at least one pair of intersecting lines forming axes having an origin at or proximate to a corner of the device, no two pairs of axes having an origin at or proximate to the same corner, each corner of the device distinguished by a discrete identifier.

7. A device as defined in claim 6, wherein the pair of intersecting lines comprises a horizontal axis and a vertical axis.

8. A device as defined in claim 7, wherein a grid comprised of horizontal and vertical lines is marked on the device, the lines of the grid being parallel with and spaced apart from the respective horizontal and vertical axes and from each other.

9. A device as defined in claim 8, wherein either the lines of the grid or the spaces between the lines of the grid correspond to some or all of the horizontal and vertical graduations.

10. A device as defined in claim 8, wherein the lines of the grid are spaced apart between 5 mm and 10 mm.

11. A device as defined in claim 10, wherein apertures are provide at the point of intersection of the lines of a grid or spaces between lines of a grid to facilitate marking of the underlying substrate, the dimensions of an aperture being sufficient to allow the passage of a ballpoint pen, pencil, pin, or like article.

12. A device as defined in claim 11, wherein four pairs of axes are provided, the aggregate length of those axes comprising vertical axes being between 170 mm and 220 mm and of those axes comprising horizontal axes being between 150 mm and 190 mm.

13. A device as defined in claim 6, wherein the discrete identifier is an alphabetic letter, symbol, picture, number, unmarked space, or edges of the device forming an exact or approximate right angle.

14. A device as defined in claim 6, wherein alphabetic letters and/or numerals are used as labels for graduations along the intersecting lines forming axes.

15. A device as defined in claim 6, wherein four pairs of axes each pair comprising a horizontal axis and a vertical axis are provided.

16. A device as defined in claim 15, wherein the graduations corresponding to a horizontal axis (if more than one) make use of the same labels as another horizontal axis.

17. A device as defined in claim 16, wherein the graduations corresponding to a vertical axis (if more than one) make use of the same labels as another vertical axis.

18. A device as defined in claim 17, wherein the graduations corresponding to a horizontal axis are labeled with letters of the alphabet and the graduations corresponding to a vertical axis are denominated by numbers, or vice versa.

19. A device as defined in claim 18, wherein the horizontal graduations extend along substantially the entire length of a horizontal side of the device.

20. A device as defined in claim 19, wherein the vertical graduations extend along substantially the entire length of a vertical side of the device.

21. A device as defined in claim 6, wherein a letter, symbol, picture, number, or other form of indicia is incorporated into an arrow or other pointer in a manner that associates it with the proximate corner.

22. A combination of a device as defined in claim 6 and a flat substrate on which is reproduced an image depicting a human, humanoid, or animal-like head or a part thereof, and/or a landscape or other outdoor vista, interior or external architecture, furnishings, decor, or an inanimate or animate object.

23. A combination as defined in claim 22, wherein the flat substrate is a page from a magazine, book, or newspaper or a rectangular portion of a page which portion may comprise a photograph.

24. A method of determining the coordinates of a point on a flat rectangular substrate comprising the steps of:
a. placing a device on the substrate, the device being generally rectangular in shape and at least partially transparent, the device incorporating at least one pair of intersecting lines forming graduated axes having an origin at or proximate to a corner of the device, no two pairs of axes having an origin at or proximate to the same corner, each corner of the device distinguished by a discrete identifier, such that at least one corner of the device is aligned with one corner of the substrate;
b. reading the coordinates of the point by reference to:
i. the graduations on the axes represented by lines intersecting at or proximate to the said corner of the device; and
ii. the discrete identifier appertaining to the said corner of the device, to provide a set of coordinates comprising at least three reference points.

25. A method of applying an image (“applied image”) to another image (“target image”), which target image is reproduced on a flat rectangular substrate the method comprising the steps of:
a. determining a set of coordinates for a target image comprising at least three reference points, the coordinates being determined by placing a device on the substrate, the device being generally rectangular in shape and at least partially transparent, the device incorporating at least one pair of intersecting lines forming graduated axes having an origin at or proximate to a corner of the device, no two pairs of axes having an origin at or proximate to the same corner, each corner of the device distinguished by a discrete identifier, such that at least one corner of the device is aligned with one corner of the substrate, and reading the coordinates of the target image by reference to:
i. the graduations on the axes represented by lines intersecting at or proximate to the said corner of the device; and
ii. the discrete identifier appertaining to the said corner of the device;
b. identifying the target image by reference to its coordinates as defined above, using the device in the manner described in step 1; and
c. placing the applied image on the identified target image.

26. A method as defined in claim 25, wherein the length of one of the axes of the device is less than the length of at least one of the sides of the flat substrate, so that when the device is placed on the substrate with one corner of the device aligned with one corner of the substrate, the device does not cover the entire area of the substrate.

27. A method as defined in claim 25, wherein the length of at least one of the axes is less than, but is equal to or more than half of, the length of at least one of the sides of the flat substrate.

28. A method as defined in claim 25, wherein the alignment of one corner of the device with one corner of the substrate results in one or more of the other three corners of the device being positioned on or off the substrate but not aligned with any of the other corners of the substrate.

29. A method as defined in claim 25, wherein are determined the coordinates of a single reference point on the target image.

30. A method as defined in claim 29, wherein the applied image is provided with a discrete identifier, and the applied image is placed on the target image so that the discrete identifier on the applied image is on or near the coordinates of the single reference point on the target image.

31. A method as defined in claim 25, wherein a crosshair, bulls eye, or triangle or similar symbol is added to or incorporated into an applied image so as to indicate the precise location for the applied image.

32. A method as defined in claim 31, wherein the crosshair, bulls eye, or triangle or similar symbol does not fall within the die-cut outline of the applied image or is removable therefrom prior to the applied image being positioned on the target image.

33. A method as defined in claim 31, wherein the nature of the symbol is such as to indicate the vertical or horizontal alignment of the applied image.

34. A method of applying an image (“applied image”) to an image of a human or other animal, humanoid, or animal-like head (“target image”), wherein the applied image is a modification, embellishment, or replacement for the head in the applied image, the method comprising the steps of:
a. providing or receiving directions for placing the applied image to the target image; and
b. placing the applied image on or over the target image in accordance with the directions; wherein the target image is produced and/or disseminated independently of, and with no reference to, the applied image.

35. A method as defined in claim 34, wherein an applied image that is adapted for use with a specific target image but not in the event so employed is subsequently adapted for use with an image in a second publication, other than one produced and/or disseminated independently of, and with no reference to, the applied image.

36. A method as defined in claim 35, wherein the second publication is in a digital form able to be downloaded from a site on the World Wide Web.

37. A method as defined in claim 36, wherein the second publication provides a user with means to identify the appropriate applied image.

38. A method as defined in claim 34, wherein the applied image is cross-referenced to a target image to which it is dedicated by means, firstly, of a notation applied proximate to the applied image or to a separate item of material on which a representation of the applied image is reproduced in a schematic or other form for purposes of its identification and, secondly, of a reference to an issue date and/or page number and/or outline plan of an individual page or picture indicating the location proposed for the applied image.

39. A method as defined in claim 34, wherein the applied image is cross-referenced to a target image to which it is dedicated by means of coordinates generated by a device that is generally rectangular in shape and at least partially transparent, the device incorporating at least one pair of intersecting lines forming axes having an origin at or proximate to a corner of the device, no two pairs of axes having an origin at or proximate to the same corner, each corner of the device distinguished by a discrete identifier.
